(19) United States
(12) Patent Application Publication
(10) Pub. No.: US 2025/0136060 A1
(43) Pub. Date: May 1, 2025

(54) SERVERS AND SYSTEMS FOR AN INTELLIGENT ANTI-COLLISION VEHICLE WASH

(71) Applicant: SONNY'S ENTERPRISES, LLC, Tamarac, FL (US)

(72) Inventors: Paul Fazio, Tamarac, FL (US); Anthony Analetto, Tamarac, FL (US); Reginald Flanagan, Tamarac, FL (US)

(21) Appl. No.: 18/928,903

(22) Filed: Oct. 28, 2024

Related U.S. Application Data
(60) Provisional application No. 63/593,384, filed on Oct. 26, 2023.

(51) Int. Cl. B60S 3/00; G05B 13/02; G06T 7/00; G06T 7/73

(52) U.S. Cl. CPC B60S 3/004; G05B 13/028; G06T 7/0002; G06T 7/73; G06T 2207/20081

(57) ABSTRACT

The disclosure is directed to a system for identifying anomalies within a vehicle wash location such as within a car wash tunnel. In some embodiments, the system utilized artificial intelligent models such as computer vision to determine position, velocity, proximity, and/or dangerous conditions of vehicles and/or wash equipment at the vehicle wash location. In some embodiments, the system is configured to control a vehicle conveying path based on abnormal conditions. In some embodiments, the system is configured to identify if a vehicle has deviated from an expected orientation, where the system can control the wash equipment in order to avoid a collision. In some embodiments, the system is configured to create a model of the vehicle wash location from a vehicle wash diagram. In some embodiments, the vehicle wash diagram enables a user to enter wash equipment and can output a camera location map based on the diagram.

### CROSS-REFERENCE TO RELATED APPLICATION

This application claims priority and the benefit of U.S. Provisional Application No. 63/593,384 filed Oct. 26, 2023, the entire contents of which are incorporated herein by reference.

### BACKGROUND

Vehicle wash tunnels move vehicles through a series of washing and drying steps. Currently, many vehicle wash tunnels operate on a conveyor system (e.g., conveyor belt, conveyor chain), pulling the vehicle through the tunnel and commencing a washing and drying routine. Some vehicle wash tunnels are subject to in-tunnel collisions caused by human errors or equipment misalignments across the length of the covered tunnel area.

Accordingly, a need exists to reduce the likelihood of in-tunnel collisions, caused by human errors or equipment misalignments, across the length of the covered tunnel area.

### SUMMARY

In some embodiments, the disclosure is directed to a system that comprises one or more computers and one or more non-transitory computer readable media, the one or more non-transitory computer readable media including program instructions stored thereon that when executed cause the one or more computers to execute one or more program steps. Some embodiments include a step to receive, by one or more processors, one or more images from one or more cameras within a vehicle wash location. Some embodiments include a step to execute, by the one or more processors, an anomaly detection platform that includes one or more artificial intelligence (AI) models. Some embodiments include a step to detect, by the anomaly detection platform, if one or more anomalies exist within the one or more images using the one or more AI models. Some embodiments include a step to execute, by the one or more processors, a control command configured to control one or more equipment components and/or one or more vehicles within the vehicle wash location based on the one or more anomalies detected within the one or more images by the one or more AI models.

In some embodiments, the one or more non-transitory computer readable media include program instructions stored thereon that when executed cause the anomaly detection platform to detect, by the anomaly detection platform, a first vehicle and a second vehicle within a conveying area of a vehicle wash location. Some embodiments include a step to determine, by the anomaly detection platform, a first vehicle position within the conveying area. Some embodiments include a step to determine, by the anomaly detection platform, a second vehicle position within the conveying area. Some embodiments include a step to compare, by the anomaly detection platform, the first vehicle position and the second vehicle position. Some embodiments include a step to execute, by the one or more processors, the control command if the first vehicle position is within a predetermined distance of the second vehicle position.

In some embodiments, the control command includes stopping one of the first vehicle and the second vehicle. In some embodiments, the control command includes changing a speed of the first vehicle and/or the second vehicle. In some embodiments, the control command includes controlling functions of one or more wash equipment.

In some embodiments, one or more non-transitory computer readable media include program instructions stored thereon that when executed cause the anomaly detection platform to receive, by the one or more processors, a vehicle wash diagram of a vehicle wash location. Some embodiments include a step to generate, by the one or more processors, a vehicle wash model based on the vehicle wash diagram. In some embodiments, the system is configured to enable the vehicle wash diagram to enable a user to enter the approximate location and/or name of wash equipment within a conveying path of the vehicle wash location. In some embodiments, the wash equipment includes one or more of windows, entrances, exits, and/or cameras along the length of the conveying path. In some embodiments, the vehicle wash diagram is configured enable a user to input conveying path measurements. In some embodiments, conveying path measurements include one or more of a length measurement, a width measurement, a height measurement, a side walls to conveyor measurement, a floor to windows measurement, and/or an obstacle distance measurement.

In some embodiments, the one or more non-transitory computer readable media include program instructions stored thereon that when executed cause the anomaly detection platform to output, by the one or more processors, a camera map based on the vehicle wash diagram. In some embodiments, the camera map is configured to identify a camera location and/or a camera angle for a user to set up cameras based on the location of the wash equipment and/or conveying path.

In some embodiments, the anomaly detection platform is configured to determine a first position of a first vehicle at least partially by identifying a first vehicle headlight and/or a first vehicle taillight. In some embodiments, the anomaly detection platform is configured to determine a first position of a first vehicle at least partially by identifying a first vehicle headlight. In some embodiments, the anomaly detection platform is configured to determine a second position of a second vehicle at least partially by identifying a second vehicle taillight. In some embodiments, the anomaly detection platform is configured to control one or more wash equipment and/or conveying of the first vehicle and/or second vehicle based on a relative location between the first vehicle headlight and the second vehicle taillight in the one or more images.

In some embodiments, the system includes one or more cameras. In some embodiments, the one or more cameras are not positioned directly above the vehicle conveying path. In some embodiments, the system includes the vehicle wash location. In some embodiments, the one or more cameras capturing the one or more images for analysis by the one or more AI models are each configured to capture at least a portion of a side of a vehicle traveling along the conveying path.

### BRIEF DESCRIPTION OF DRAWINGS

FIG. 1 shows an ioLogik E1200 Series and a list of features and benefits according to some embodiments.

FIG. 2 demonstrates a high-level design of an anti-collision project solution according to some embodiments.

FIG. 3 portrays illustrates a flow chart of an on-site solution according to some embodiments.

FIG. 4 depicts a HikVision DS-2CD2342WD-I specifications sheet according to some embodiments.

FIG. 5 exhibits a Nvidia Jetson NX Xavier according to some embodiments.

FIG. 6 displays a SIMATIC IPC520A as a non-limiting example of a InterProcess Communication (IPC) platform configured for AI-based applications according to some embodiments.

FIG. 7 illustrates a Raspberry Pi 4 model as a non-limiting example of a computing device for implementing one or more aspects of the system according to some embodiments.

FIG. 8 shows a flow chart of an E2E Process according to some embodiments.

FIG. 9 demonstrates a vehicle wash tunnel interior image with a machine learning model for vehicle edge detection implemented according to some embodiments.

FIG. 10 portrays a vehicle wash tunnel interior image with a machine learning model for vehicle front/back light detection implemented according to some embodiments.

FIG. 11 depicts a vehicle wash tunnel interior image with a machine learning model for vehicle edge detection and added business rules implemented according to some embodiments.

FIG. 12 exhibits an example vehicle wash location blueprint according to some embodiments.

FIG. 13 displays an empty tunnel diagram form according to some embodiments.

FIG. 14 illustrates an example testing location's camera installation change IP setting according to some embodiments.

FIG. 15 shows an example testing location's camera installation change port setting according to some embodiments.

FIG. 16 demonstrates an example testing location's camera installation change user setting according to some embodiments.

FIG. 17 portrays an example testing location's camera installation change time setting according to some embodiments.

FIG. 18 depicts an example testing location's camera installation change device name setting according to some embodiments.

FIG. 19 exhibits an example testing location's camera installation change display setting according to some embodiments.

FIG. 20 displays an example testing location tunnel diagram form according to some embodiments.

FIG. 21 illustrates a simulated view of a camera 1 from FIG. 20 according to some embodiments.

FIG. 22 shows a simulated view of a camera 2 from FIG. 20 according to some embodiments.

FIG. 23 demonstrates a simulated view of a camera 3 from FIG. 20 according to some embodiments.

FIG. 24 portrays a simulated view of a camera 4 from FIG. 20 according to some embodiments.

FIG. 25 depicts a simulated view of a camera 6 from FIG. 20 according to some embodiments.

FIG. 26 exhibits a table of one or more of a camera and their accesses from the testing location from FIG. 20 according to some embodiments.

FIG. 27 displays a functional diagram of a computer vision system according to some embodiments.

FIG. 28 illustrates a Modbus hardware simulator wiring diagram according to some embodiments.

FIG. 29 shows a FastAPI Swagger UI for a Modbus according to some embodiments.

FIG. 30 demonstrates a MOXA Web Interface for a Modbus according to some embodiments.

FIG. 31 portrays a camera configuration file (cameras.yml) at the testing location of FIG. 20 according to some embodiments.

FIG. 32 depicts a vehicle wash configuration file (vehiclewash.yml) at the testing location of FIG. 20 according to some embodiments.

FIG. 33 exhibits a system configuration file (system.yml) at the testing location of FIG. 20 according to some embodiments.

FIG. 34 displays a camsys configuration file (camsys.yml) at the testing location of FIG. 20 according to some embodiments.

FIG. 35 illustrates a reference point matrix for a camsys configuration file in FIG. 34 according to some embodiments.

FIG. 36 shows a vehicle wash tunnel interior broken up into a LEFT_THRESHOLD, a CENTER_THRESHOLD, and a RIGHT_THRESHOLD for a reference point matrix of FIG. 35 according to some embodiments.

FIG. 37 demonstrates step 1 of creating a new Greengrass group according to some embodiments.

FIG. 38 portrays step 2 of creating a new Greengrass group according to some embodiments.

FIG. 39 depicts step 3 of creating a new Greengrass group according to some embodiments.

FIG. 40 exhibits step 4 of creating a new Greengrass group according to some embodiments.

FIG. 41 displays step 1 Greengrass deployment via a web interface according to some embodiments.

FIG. 42 illustrates step 2 Greengrass deployment via a web interface according to some embodiments.

FIG. 43 shows step 3 Greengrass deployment via a web interface according to some embodiments.

FIG. 44 demonstrates step 4 Greengrass deployment via a web interface according to some embodiments.

FIG. 45 portrays the deployments page in a Greengrass docker and the starting point for revising a Greengrass deployment according to some embodiments

FIG. 46 depicts step 1 of revising a Greengrass deployment according to some embodiments.

FIG. 47 exhibits step 2 of revising a Greengrass deployment according to some embodiments.

FIG. 48 displays step 3 of revising a Greengrass deployment according to some embodiments.

FIG. 49 illustrates step 4 of revising a Greengrass deployment according to some embodiments.

FIG. 50 shows a General Usage data and a System Control data within a FastAPI and Swagger UI according to some embodiments.

FIG. 51 demonstrates a Vehicle Wash Interface data and a Camera Events data within a FastAPI and Swagger UI according to some embodiments.

FIG. 52 portrays a Cameras Information data and a Configuration data within a FastAPI and Swagger UI according to some embodiments.

FIG. 53 depicts a non-limiting example docker status according to some embodiments.

FIG. 54 exhibits a non-limiting example edge manager log according to some embodiments.

FIG. 55 displays a non-limiting example edge camsys log according to some embodiments.

FIG. 56 illustrates a non-limiting example docker watchdog according to some embodiments.

FIG. 57 shows a non-limiting example Fast API Live log according to some embodiments.

FIG. 58 demonstrates a non-limiting example logrotate config in Lauderhill (daily rotation) according to some embodiments.

FIG. 59 portrays a non-limiting example of a log within Cloudwatch according to some embodiments.

FIG. 60 depicts a non-limiting example screen for stopping a conveyor according to some embodiments.

FIG. 61 exhibits a non-limiting example screen for starting a conveyor according to some embodiments.

FIG. 62 displays a non-limiting example screen for checking a conveyor state according to some embodiments.

FIG. 63 illustrates a non-limiting example screen for stopping an alarm according to some embodiments.

FIG. 64 shows a non-limiting example screen for starting an alarm according to some embodiments.

FIG. 65 demonstrates a non-limiting example screen for checking an alarm state according to some embodiments.

FIG. 66 portrays a non-limiting example screen for enabling a dry-run according to some embodiments.

FIG. 67 depicts a non-limiting example screen for disabling a dry-run according to some embodiments.

FIG. 68 exhibits a non-limiting example screen for check a dry-run status according to some embodiments.

FIG. 69 displays an Amazon SageMaker Domain page according to some embodiments.

FIG. 70 illustrates one or more modules within a Jupyter Lab according to some embodiments.

FIG. 71 shows inside a SageMaker Training Job according to some embodiments.

FIG. 72 demonstrates a job settings page for the first job listed in FIG. 71 according to some embodiments.

FIG. 73 portrays user details for a SageMaker domain according to some embodiments.

FIG. 74 depicts a GitHub repository download page according to some embodiments.

FIG. 75 exhibits step 1 of downloading a video for labelling according to some embodiments.

FIG. 76 displays step 2 of downloading a video for labelling according to some embodiments.

FIG. 77 illustrates step 3 of downloading a video for labelling according to some embodiments.

FIG. 78 shows step 4 of downloading a video for labelling according to some embodiments.

FIG. 79 demonstrates a video properties page from a video selected in FIG. 78 according to some embodiments.

FIG. 80 portrays a folder of one or more of a frame from a video downloaded in FIG. 79 according to some embodiments.

FIG. 81 depicts a selected vehicle from a frame from the folder in FIG. 80 according to some embodiments.

FIG. 82 exhibits a selected frontlight from a frame from the folder in FIG. 80 according to some embodiments.

FIG. 83 displays a selected frontlight from FIG. 82 and a selected vehicle according to some embodiments.

FIG. 84 illustrates one or more of a selected vehicle from a frame from the folder in FIG. 80 according to some embodiments.

FIG. 85 shows one or more of a selected vehicle and a selected backlight from a frame from the folder in FIG. 80 according to some embodiments.

FIG. 86 demonstrates the data provided by opening a labelled photo with TextEdit according to some embodiments.

FIG. 87 portrays step 1 of uploading one or more of a labelled photo according to some embodiments.

FIG. 88 depicts step 2 of uploading one or more of a labelled photo according to some embodiments.

FIG. 89 exhibits step 3 of uploading one or more of a labelled photo according to some embodiments.

FIG. 90 displays step 4 of uploading one or more of a labelled photo according to some embodiments.

FIG. 91 illustrates step 5 of uploading one or more of a labelled photo according to some embodiments.

FIG. 92 shows step 6 of uploading one or more of a labelled photo according to some embodiments.

FIG. 93 demonstrates step 3 of training a model using one or more of an uploaded image according to some embodiments.

FIG. 94 portrays step 5 of training a model using one or more of an uploaded image according to some embodiments.

FIG. 95 depicts step 6 of training a model using one or more of an uploaded image according to some embodiments.

FIG. 96 illustrates non-limiting detection results according to some embodiments.

FIG. 97 shows a computing system compatible with the systems and methods described herein according to some embodiments.

### DETAILED DESCRIPTION

Some embodiments described herein are directed to a system configured to detect one or more vehicles passing through and/or or within at least a portion of the length of a vehicle conveying area, such as the entrance to and/or within a covered tunnel area. In some embodiments, the system is configured to detect a distance between one or more vehicles within the length of the vehicle conveying area, predict impending collisions/threats with the highest accuracy and lowest latency, and/or send signals to a vehicle wash tunnel controller to stop at least a portion of a conveying process, or other specified action when a threat is identified. Other actions include changing a speed (e.g., faster, slower) of at least a portion of the conveying process (e.g., a conveyor section), starting, stopping, and/or moving one or more washing equipment components (e.g., arms, brushes, nozzles, etc.).

Throughout this disclosure, various components that form the vehicle wash system are described. In some embodiments, the system includes a specialized object detection platform (also referred to herein as a “vehicle detector” and/or “anomaly detector”) designed to identify and locate vehicles and/or anomalies associated with vehicles within a vehicle (e.g., car) wash environment. In some embodiments, the system includes a detection algorithm that provides an improvement over conventional system by enhancing accuracy, efficiency, and speed in identifying and localizing multiple objects with an image and/or class. In some embodiments, a class includes a category or label that an object or image belongs to within image classification and object detection.

In some embodiments, the system is configured to execute a deep learning technique (Quantization) used in to reduce the computational and memory requirements of neural network models by converting weights and activations from higher to lower precision. In some embodiments, the system includes a toolkit (e.g., OpenVINO) that enables developers to optimize and deploy deep learning models across various platforms, configured to accelerate high-performance computer vision and deep learning applications. In some embodiments, the system includes a high-performance deep learning inference library (e.g., TensorRT) developed configured to optimize and accelerate the deployment of deep learning models on graphics processing units (GPUs). In some embodiments, the system includes a software development kit (SDK; e.g., NVIDIA JetPack) for developing AI and computer vision applications on an AI appliance (e.g., NVIDIA Jetson platform), offering tools, libraries, and APIs optimized for deep learning, GPU computing, and multimedia on Jetson embedded hardware. A non-limiting example of such an SDK is Nvidia JetPack. In some embodiments, the system executes a format (e.g., ONNX) that is configured to facilitate the interchange of deep learning models between different frameworks, providing a standardized representation for machine learning models.

In some embodiments, the system is configured to execute commands for safety-related conditions that arise during the vehicle wash process, requiring the wash to be halted immediately. In some embodiments, the system is configured to minimize a proportion of non-object instances incorrectly identified as objects by the model (i.e., the False Positive Rate), measuring how often the model incorrectly detects objects not actually present in the image. In some embodiments, the system is configured to minimize the number of valid vehicles that were missed or ignored by the Object Detector (i.e., Missed Vehicle Rate).

In some embodiments, the system uses YOLOv9 as an object detector. In some embodiments, the object detector includes MobileNetSSDv1, as a non-limiting example. While the system may include either or both object detectors, YOLOv9 has been found to be suitable due to enhanced accuracy and improved bounding box detection, allows for introduction of new classes to the object (vehicle) detector for additional stop conditions, and has been found to boost model efficiency and accelerate inference speed. In some embodiments, YOLOv9 allows for scalability by reducing software and hardware requirements and/or upgrading hardware components. In some embodiments, YOLOv9 can replace the Nvidia Jetson TX2 and perform all inferencing on a single device using Intel OpenVINO.

In some embodiments, the computer collecting the video stream can include a Siemens IPC 427E and/or Siemens BX39: however, upgrading from a 6th generation Intel i5 to an 11th generation equivalent (e.g., Tiger Lake) will provide a significant performance boost, allowing for vehicle detection on a single computing device and/or AI appliance. In some embodiments, the Nvidia Jetson Orin Nano with Jetpack 6 is employed in at least part of the system. While the system may be described in relation to specific hardware and software to aid those to make and use the system, any reference to a specific hardware and/or software component in this non-limiting example description can be replaced with its broader platform description and/or functional description when defining the metes and bounds of the system. While YOLOv9t and MobleNetSSDv1 models both performed well on the test set, YOLOv9T significantly outperformed MobileNetSSDv1 in terms of False Positive Rate (0.33% vs 1.33%, respectively), Vehicle Missed Rate (0.32% vs 1.95%, respectively), and Inference Speed (150 FPS vs 102 FPS, respectively). YOLOv9T, the smallest YOLOv9 model at the time of this disclosure, has only 2.9 million parameters and is approximately 4 MB in size. Meanwhile MobileNetSSDv1 has 28 million parameters and is around 28 MB in size. This demonstrates that YOLOv9 not only generalizes better but is also more efficient in accordance with some embodiments. Additionally, the bounding boxes from YoloV9t appeared better than those of MobileNetSSDv1, being tighter and more accurate.

In some embodiments, vehicle detector pre and post processing code for YOLOv9T is executed in a Camsys platform. In some embodiments, YOLOv9t is configured to leverage TensorRT on the Nvidia Jetson, which MobileNetSSDv1 model is not capable of doing as it utilizes the ONNX model format. In some embodiments, Jetpack 5.1 is used to leverage dynamic batchinn in YOLOv9. In some embodiments, the system includes a plurality of ONNX files with a batch size ranging from 1-12 to support varying camera deployment in system various configurations.

Different vehicle wash locations have different hardware and software configurations, so portions of different component descriptions presented herein may be used in combination of other component descriptions to accomplish the functionality the system provides according to some embodiments. In some embodiments, the system is configured to execute all vehicle wash functionality from a single computing device. The vehicle wash location can include areas inside and/or outside a wash tunnel, and further includes any area where a vehicle motions is at least partially controlled by the system.

In some embodiments, the vehicle wash location includes wash equipment that includes wash arches for applying water, soap, or wax; high-pressure sprayers to remove dirt and debris; brushes or soft cloth rollers that physically scrub the vehicle surface; and underbody wash systems to target hard-to-reach areas underneath. In some embodiments, wash equipment includes chemical applicators to dispense detergents, pre-soaks, and other cleaning agents, as well as rinse arches for removing residual soap. In some embodiments, wash equipment includes drying mechanisms like blowers and/or air knives help dry the vehicle after washing. In some embodiments, wash equipment includes conveyor belts and/or tire guides to transport vehicles through the wash process, pumps and water filtration systems to manage water flow and recycling, and/or control panels or programmable logic controllers (PLCs) for system automation and monitoring. In some embodiments, wash equipment includes payment stations or point-of-sale systems and entry gates or signal lights to regulate vehicle entry. Other wash equipment systems are described herein, such as computer systems implementing the system in accordance with some embodiments, where the system can include any combination of wash equipment and respective functionality.

In some embodiments, the system includes anomaly detection models. In some embodiments, anomaly detection includes the process of identifying data points, patterns, or events that deviate significantly from the norm or expected behavior within a dataset. These anomalies can indicate critical incidents, such as fraud, network intrusions, or equipment failures.

In some embodiments, the system is configured to identify stop conditions. In some embodiments, stop conditions includes conditions configured to stop the vehicle in the conveying are upon collision detection and/or stalled vehicle detection. While some non-limiting examples include a physical conveyor (e.g., chain conveyor), in some the conveying area includes an area where autonomous vehicle movement is controlled by the system via a network connection. In some embodiments, the system is configured to send a command to one or more autonomous vehicles (e.g., 3 vehicles simultaneously) to adjust spacing between the vehicles and/or stop one or more vehicles when a stop condition is identified. Systems and methods described herein can use local vehicle sensor data for analysis, but in some embodiments initial conveying commands are based only on object detection, where conventional sensors are used as a back-up.

In some embodiments, the vehicle detector is configured to support detection of multiple classes. Additional objects labels including both people and equipment can be added without loss or accuracy or increase in computational complexity in accordance with some embodiments. In some embodiments, exclusion zones can be configured to ignore detections behind conveying area (e.g., tunnel) windows or operator stations.

In some embodiments, the system is configured to determine how a vehicle is moving. In some embodiments, implementation of stalled vehicle (stop) detection uses the tracking logic described herein to determine if a vehicle has stopping moving. In some embodiments, tracking logic includes a step to determine if a vehicle is moving backwards (car in reverse) and/or a step to determine if a vehicle is moving at an unsafe velocity (e.g., car in drive on a conveyor).

In some embodiments, the system is configured to determine if a vehicle is skewed in the conveying area. In some embodiments, skew detection includes one or more AI models executing one or more of pose estimation, 3D object detection, and oriented object detection to determine the orientation of a vehicle with respect to the conveyor (area) and/or other wash equipment within a camera view. Pose estimation identifies vehicle key points, such as mirrors, wheels, lights, etc. that would be useful for damage detection; the use of front and/or rear lights for pose estimation is described below in relation to some embodiments. 3D object detection localizes the object as a cuboid that would also be useful for evaluating clearance between equipment and the vehicle, where oriented object detection is the least computationally complex approach, which detects the rotation angle of an object in addition to the bounding box.

In some embodiments, the system is configured to identify obstacles and/or anomalies within the camera view as a stop condition, which serves as a catch-all for unexpected events. In some embodiments, the system is configured to detect an unusable camera as a stop condition. In some embodiments, the system includes logic to automatically flag cameras that need manual intervention (e.g., cleaning).

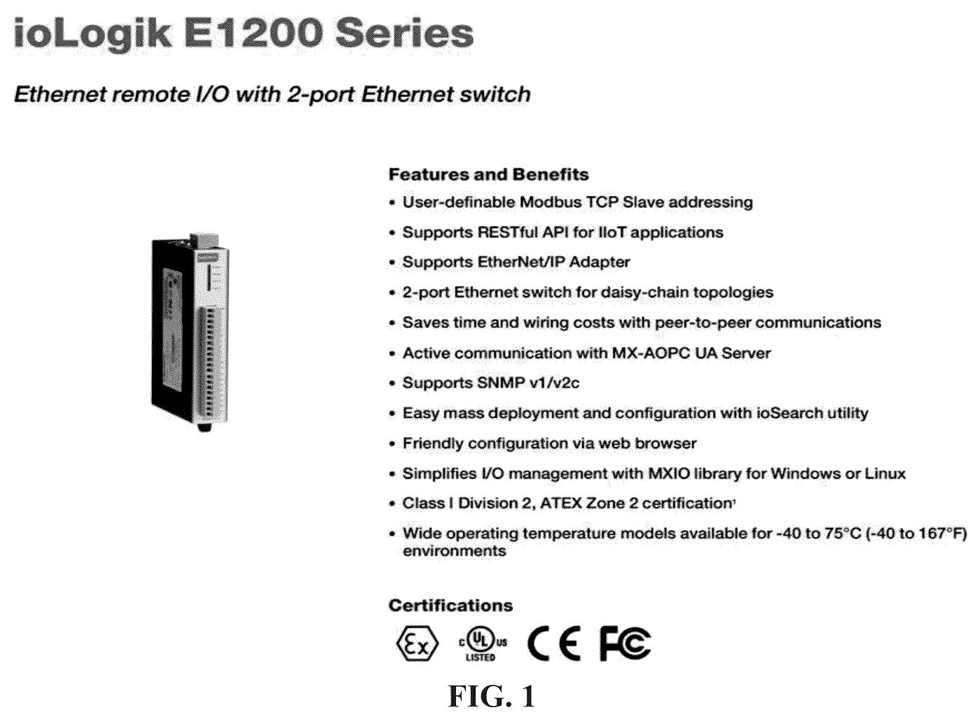

FIG. 1 shows an ioLogik E1200 Series as a non-limiting example of a component suitable for supporting communication protocols for retrieving I/O data as well as a list of features and benefits according to some embodiments. In some embodiments, the communication protocols include Modbus. In some embodiments, the ioLogik E1200 Series includes Modus.

In some embodiments, the system includes one or more artificial intelligence (AI) models. In some embodiments, the one or more AI models are executed by one or more AI appliances. In some embodiments, the one or more AI appliances include hardware specifically configured to execute AI tasks. In some embodiments, the one or more AI appliances include one or more computers and/or computer components built for machine learning, deep learning, and/or other AI processes. In some embodiments, the one or more AI appliances include an AI workstation or ML workstation, which includes a high-performance system designed for individual or small-team use in developing, training, and deploying AI models locally. In some embodiments, the one or more AI appliances include an edge AI device or edge computing appliance, configured to perform AI processing at the edge of the network, close to data sources, to enable low-latency, real-time data analysis. In some embodiments, the one or more AI appliances include an AI accelerator, such as a GPU, TPU, or FPGA, integrated into the system to boost computational power and enhance the speed and efficiency of AI tasks. In some embodiments, the one or more AI appliances include an AI or ML server, which includes an enterprise-grade system optimized for large-scale AI workloads and capable of supporting multi-user environments with extensive model training and inference capabilities. In some embodiments, the one or more AI appliances include a deep learning appliance or system specifically tuned for deep learning tasks involving neural networks for applications like image recognition, natural language processing, and other data-intensive AI operations. Any reference to an AI model described herein can be replaced and/or described as executed on or including an AI appliance executing one or more AI models locally when defining the metes and bounds of the system.

In some embodiments, the system includes an AI model (e.g., Machine Learning Appliance) executing one or more AI algorithms “on-site” (e.g., locally; within the same property boundaries as the carwash) configured to send one or more signals to one or more relays via a controller. In some embodiments, the controller includes an Ethernet based Modbus Relay controller component such as the ioLogik E1200 Series controller shown in FIG. 1. In some embodiments, one or more relays are used to control a tunnel conveyor (e.g. one of the relays to stop the conveyor, one of the relays to sound an alarm, and one of the relays to restart the conveyor).

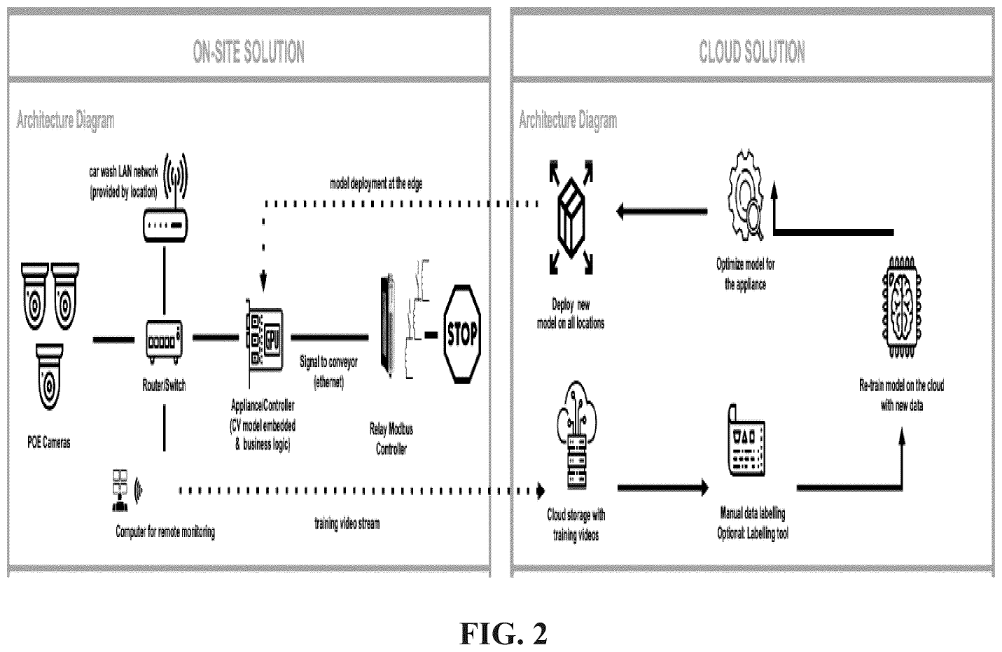

FIG. 2 demonstrates a high-level system configuration of the anti-collision system described herein according to some embodiments. In some embodiments, the anti-collision system includes different components including an on-site solution and/or a cloud-based system (e.g., E2E Cloud solution).

In some embodiments, the cloud-based platform provides scalable data storage and management services, enabling secure and accessible storage for both structured and unstructured data. In some embodiments, the platform includes advanced analytics tools configured to derive insights from data through visualization, reporting, and predictive analytics capabilities. In some embodiments, the cloud-based platform offers seamless integration with various data sources and applications, such as the AI appliances described herein. In some embodiments, the platform includes collaboration tools configured to promote shared access to data and analytical resources, streamlining workflows and improving decision-making processes.

In some embodiments, the on-site solution includes one or more of a POE camera, a vehicle wash LAN network, a router or a switch, a computer, an AI appliance, and/or controller (e.g., computer vision (CV) model imbedded with business rule and/or criteria logic), a signal to a conveyor control system (an ethernet), and a controller (e.g., relay Modbus controller).

In some embodiments the on-site solution includes one or more PoE cameras installed on a vehicle wash location, covering the entire length of a tunnel and/or automated conveying path, and connected to the AI appliance and/or internet. In some embodiments, the Power over Ethernet (PoE) camera is configured to receive both power and data through a single Ethernet cable (e.g., Cat5 or Cat6 cable). This setup simplifies installation by eliminating the need for a separate power source or adapter, allowing the camera to receive power directly from a compatible PoE network switch or injector.

In some embodiments, the one or more AI models include a pre-trained computer vision model configured to infer vehicle distances and/or send a signal to a vehicle wash controller to stop the conveyor when a threat is identified. In some embodiments, the computer vision model includes machine learning techniques that enable it to recognize and analyze patterns in visual data, such as images and videos. In some embodiments, the computer vision model utilizes deep learning architectures, including convolutional neural networks (CNNs), specifically configured to process and interpret pixel-based data. In some embodiments, the computer vision model performs tasks such as object detection, image segmentation, facial recognition, and video analysis obtained from one or more cameras. In some embodiments, videos from one or more cameras may be streamed from one or more locations and stored in the cloud, which are later used for training the computer vision model.

In some embodiments, the amount of video needed varies with the vehicle volume and/or shape, and/or if there are any particular configurations or conditions that need to be captured. In some embodiments, one or more AI models are trained to recognize specific vehicles, where the system in configured to estimate the position of various parts in of the vehicle within the conveying area (e.g., tunnel) that are outside of a camera view. In some embodiments, the system includes at least one computer for remote monitoring configured to enable a support team to stop the conveyor remotely as a backup solution. In some embodiments, the cloud-based platform (e.g., E2E Cloud solution) includes a Machine Learning Operations (MLOps) process (or method) that includes gathering new videos from the vehicle wash locations, labeling them for training purposes, and/or using the labeled data to re-train the one or more AI models. In some embodiments, after a model has been trained, the model is optimized for a specific vehicle wash (e.g., car wash) configuration (e.g., conveyor, washing equipment, sensors, etc.) and/or AI appliance and deployed to the respective vehicle wash locations.

Referring further to FIG. 2, the on-site portion of the system diagram shows a localized architecture for managing car wash operations using cameras and controllers integrated into an AI platform according to some embodiments. The system starts with the PoE cameras that capture video data, which, in some embodiments, is sent through a router or switch within the local area network (LAN) of the vehicle wash. In some embodiments, the data is processed by the AI appliance (controller), which hosts a computer vision (CV) model and supporting instructions to analyze the video feed. Based on the analysis, in some embodiments, the controller sends signals to the conveyor system (which includes all wash components in some embodiments) via a Relay Modbus Controller to control the electrical and mechanical operations of the vehicle wash. In some embodiments, remote monitoring of the process is executed through a connected computer that can view the video stream.

In some embodiments, a cloud-based platform is used in conjunction with the on-site configuration to enable more advanced processing and optimization. In some embodiments, the cloud-based platform is configured deploy updated machine learning models to a plurality of vehicle wash locations from a central cloud server and/or network of servers. In some embodiments, the system is configured to store historic and/or trained videos in the cloud. In some embodiments, the cloud-based platform is configured to retrain models and optimize the AI models for deployment on an on-site AI appliance controller, ensuring that all locations have the latest machine learning capabilities.

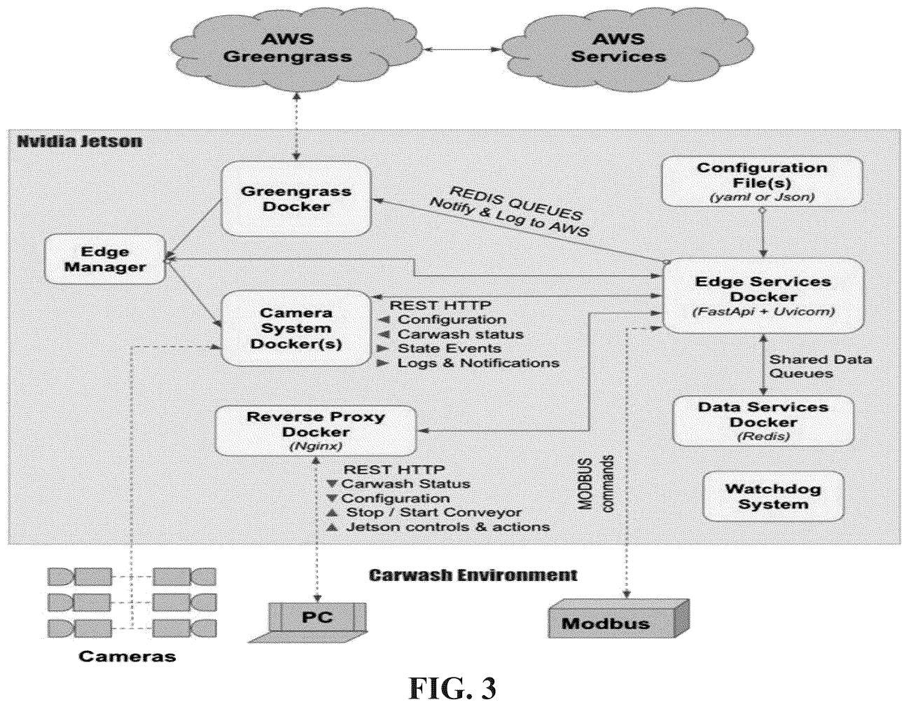

FIG. 3 illustrates a flow chart of non-limiting system architecture for the on-site solution according to some embodiments. In some embodiments, instead of sending all data to the cloud, the system includes a local platform (e.g., Greengrass) that enables connected devices to process, filter, and act on information locally. In some embodiments, the local platform allows these devices to run certain functions, like analyzing data and triggering alerts, without needing to communicate with a remote server. This helps reduce the time taken to act on data (latency) and also keeps operations running smoothly when network connections are limited.

In some embodiments, the system includes one or more applications packaged into containers (e.g., Docker), where a container include the application and everything it needs to run. By using a container platform, the system is configured enable a user to create an application on one computer and then run it on any other computer without worrying about compatibility issues. Docker helps ensure that software runs the same way regardless of where it's deployed.

In some embodiments, the system includes a combination of the local platform and the container platform to create an edge computing network configured to process data locally and/or at the device level. In some embodiments, Amazon Web Services (AWS) IoT Greengrass can manage Docker containers, deploying them on devices at the network's edge, such as IoT (Internet of Things) devices within the vehicle wash system. Docker® makes it easy to run applications in these containers, and Greengrass manages these containers in accordance with some embodiments.

In some embodiments, the flow chart shown in FIG. 3 comprises a Greengrass Docker, an Edge Manager, a Camera System Docker, one or more Configuration Files, an Edge Services Docker, a Data Services Docker, a Reverse Proxy Docker, a control PC, a Modbus, one or more cameras, AWS Greengrass, AWS Services, and/or a Watchdog System. In some embodiments the Greengrass Docker includes a module configured to register the device within Amazon® Greengrass group in order to perform at-the-edge deployments and updates. In some embodiments, the Edge Manager includes a module configured to get notifications sent by the Greengrass Docker Lambda function and perform one or more corresponding deployments and restarts. In some embodiments, the Camera System Docker includes a module configured to process the video streaming from the cameras, determine if a confirmed event occurred, and report the configured event to the Edge Services Docker to take corresponding actions.

In some embodiments, one or more configuration files are configured to store system configuration parameters. In some embodiments, the configuration file cameras.yml (IP address and name of the camera), camys.yml (cameras' configuration/reference points/system parameters), vehiclewash.yml (location information and the Modbus IP address), and/or system.yml (dry run mode) are located on svc/config. In some embodiments, the Edge Services Docker includes a service based on FastApi+Uvicorn that provides a REST API configured to interact with the Modbus, to send logs and notification the AWS, to share data between the different processes, and/or to provide access to the configuration data. In some embodiments, Uvicorn (only) listens on localhost for security reasons. In some embodiments, the Reverse Proxy Docker is implemented via Nginx to serve external services such as the control PC. In some embodiments, the Data Services Docker includes a buffer between the FastApi and the AWS Greengrass service configured to store the messages the solution sends to the AWS Services such as Cloudwatch via AWS Greengrass service.

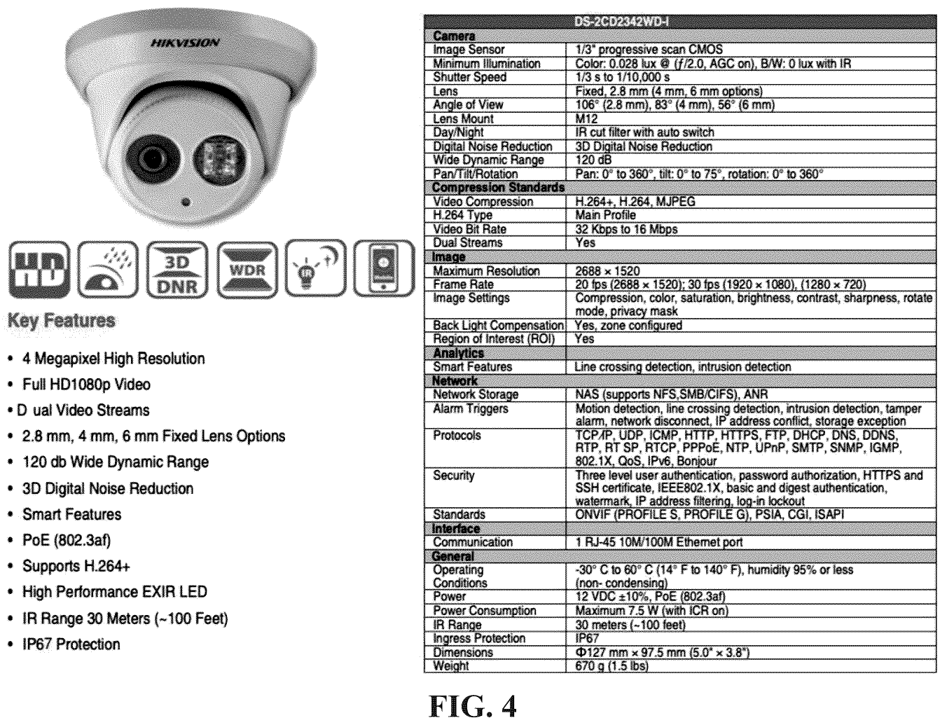

FIG. 4 depicts a HikVision DS-2CD2342WD-I specifications sheet as a non-limiting example of a camera suitable for a vehicle wash environment. according to some embodiments. In some embodiments, the camera is a suitable model for one or more cameras in the flow chart of FIG. 3 as it meets certain specifications, which include being IP-based, powered over Ethernet (POE), supporting H.264+ compression protocol (advance video coding), supporting RTSP, having Wide Dynamic Range (WDR), having an angle view between 90 and 110 degrees, having minimum speeds of 20 frames per second, and/or having IP Code Protection (IP66 or IP67). In some embodiments, the on-site platform (solution) alerts operators that camera maintenance is needed if the quality of images is not good enough to make inferences. In some embodiments, locations with one or more cameras (with similar specifications) previously installed are capable of use; however, one or more cameras may need to be repositioned. In some embodiments, where repositioning is not possible and one or more cameras are not blocked by some obstacle, a Machine Learning model (appliance) is retrained using images from the one or more cameras to train the ML model for the specific location. In some embodiments, a method includes ensuring the same camera setup in a plurality of vehicle wash locations to ensure the AI model(s) process the images the same.

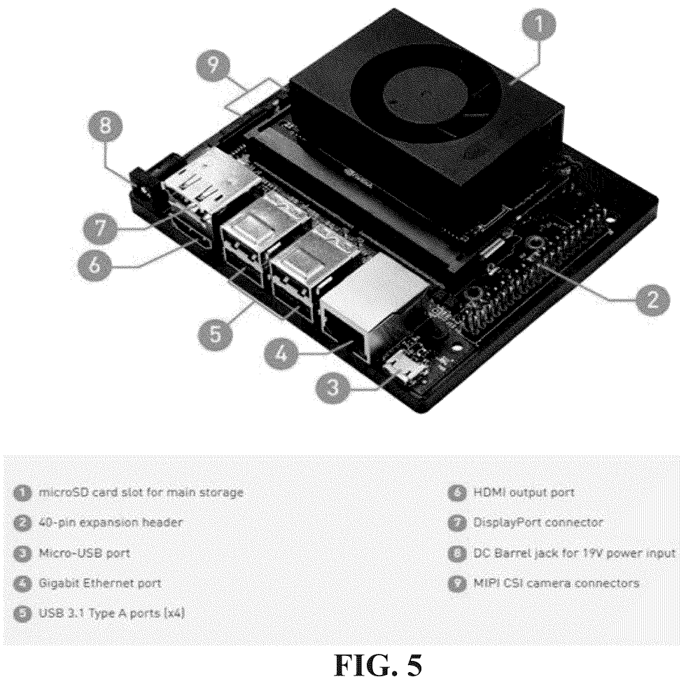

FIG. 5 exhibits an Nvidia Jetson NX Xavier according to some embodiments. In some embodiments, an on-site solution from FIG. 2 works with a Machine Learning appliance that meets the specifications of the Nvidia Jetson NX Xavier.

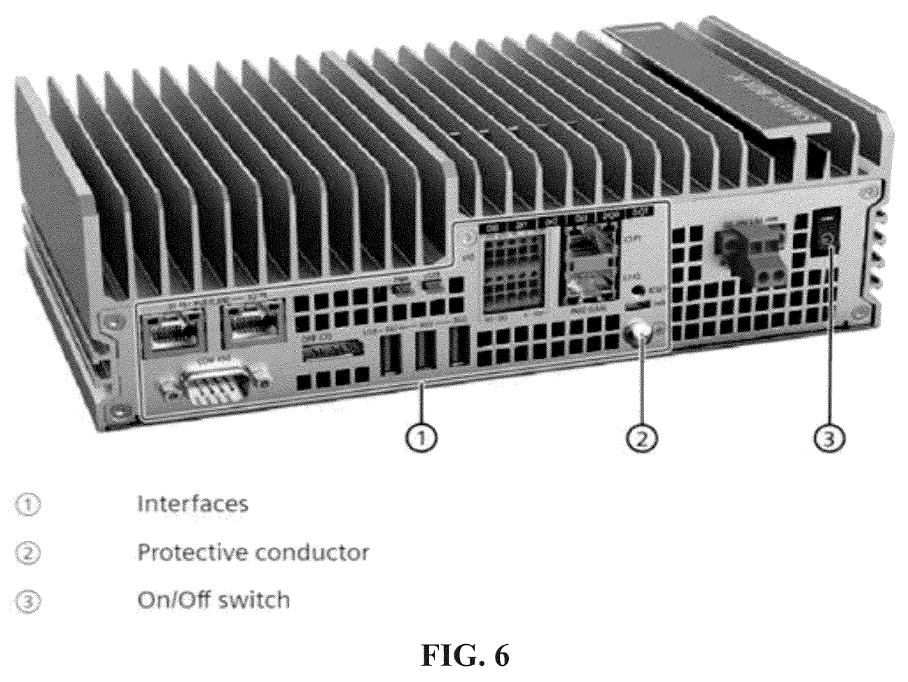

FIG. 6 displays a SIMATIC IPC520A according to some embodiments. In some embodiments, an on-site solution from FIG. 2 works with a Machine Learning appliance that meets the specifications of the SIMATIC IPC520A.

In some embodiments, a router or a switch is included to connect one or more cameras, the machine learning appliance, and/or the computer of FIG. 3 for remote learning. In some embodiments, the router or the switch includes one or more POE ports to connect one or more cameras. In some embodiments, recommended models include a MikroTik router/switch and/or a Cisco router/switch.

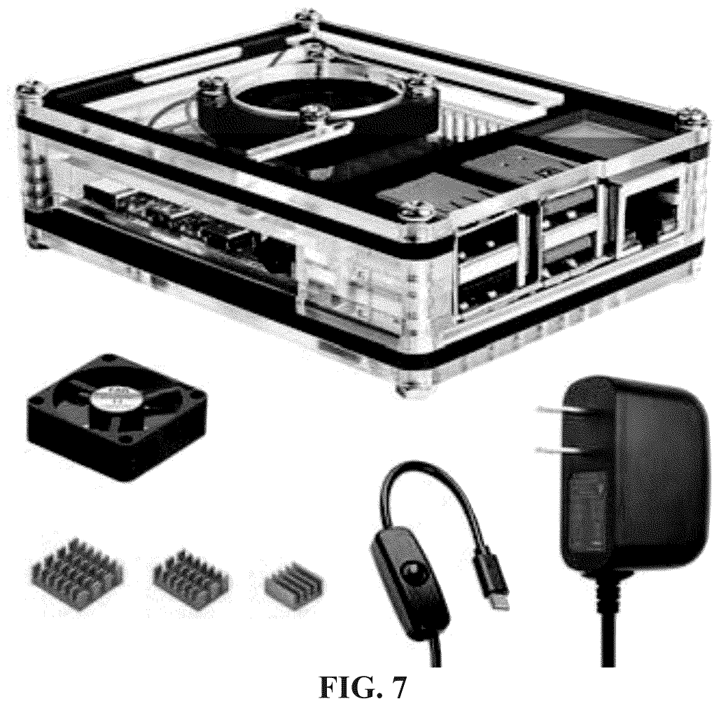

FIG. 7 illustrates a Raspberry Pi 4 model according to some embodiments. In some embodiments, the computer from FIG. 2 includes an operating system (e.g., Linux) to host a web application for remote monitoring. In some embodiments, models suitable for the system described herein include the Raspberry Pi 4 and/or a mini-PC.

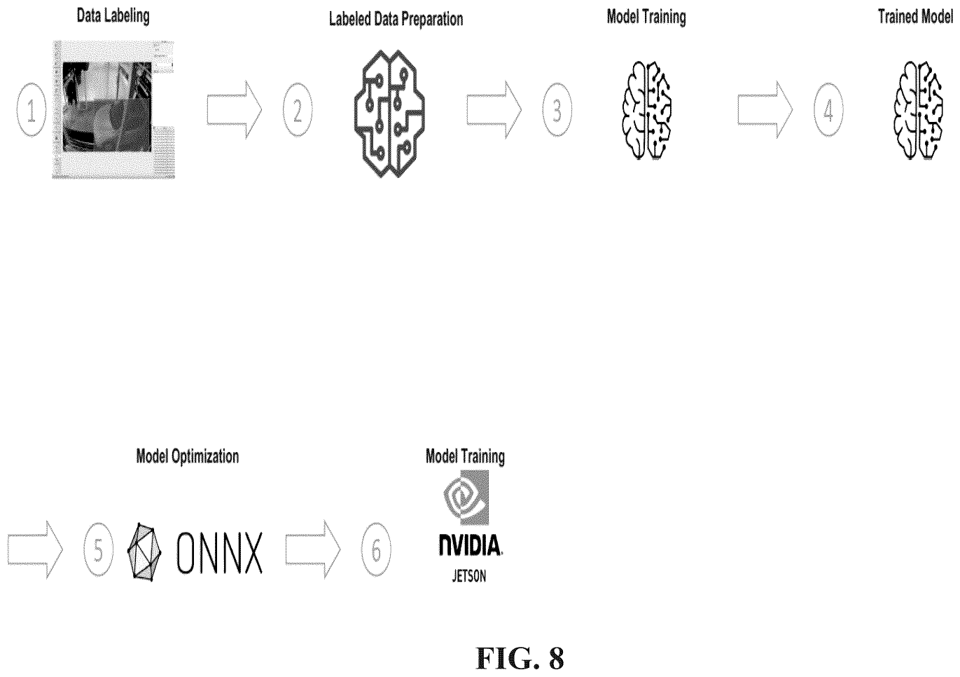

FIG. 8 shows a flow chart of an End-to-End E2E Process according to some embodiments. In some embodiments, an E2E Cloud Solution gathers real data, improving a machine learning model and re-deploying it on all locations. In some embodiments recommended software is represented in the flow chart steps.

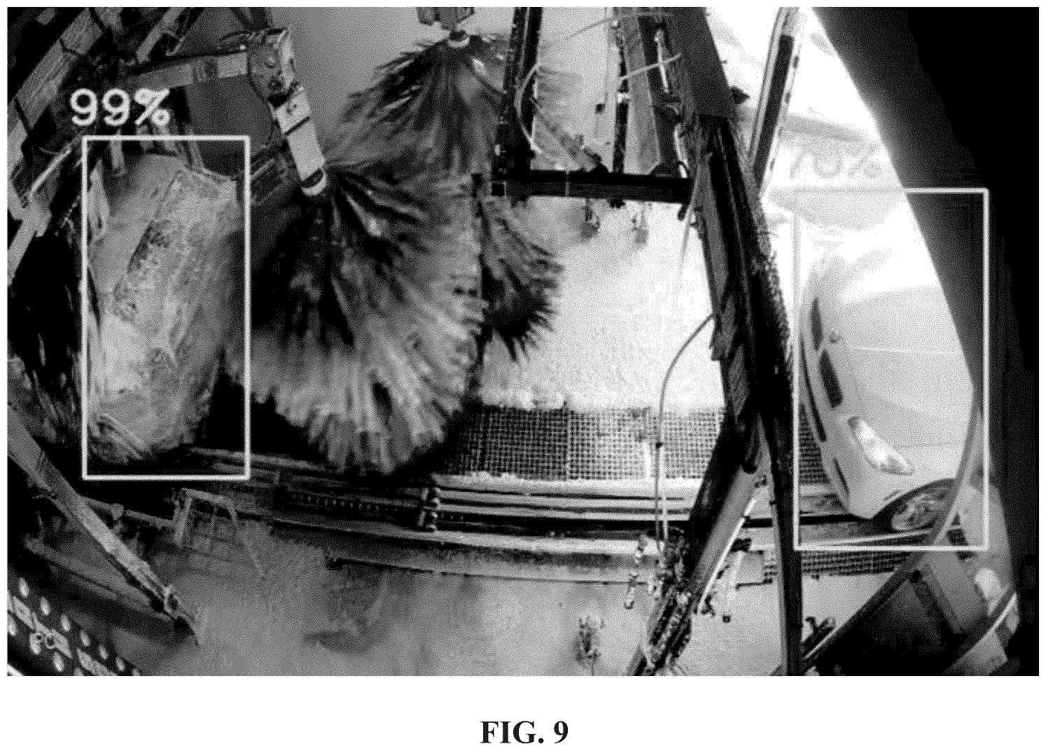

FIG. 9 shows a vehicle wash tunnel interior image being analyzed by a machine learning model for vehicle edge detection implemented according to some embodiments. In some embodiments, the machine learning model is configured to detect one or more vehicle edges. In some embodiments, the ML models are trained using historical images from one or more vehicle washing systems. In some embodiments, pre-trained computer vision models are used.

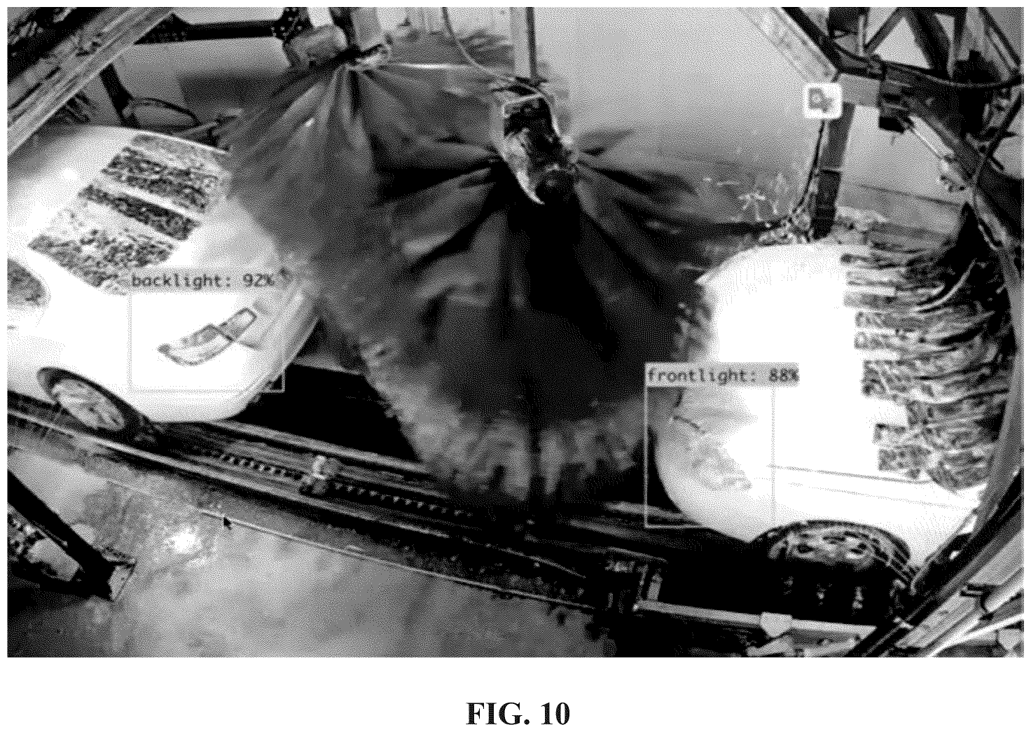

FIG. 10 portrays a vehicle wash tunnel interior image being analyzed by a machine learning model for vehicle front/back light detection implemented according to some embodiments. In some embodiments, the machine learning model detects vehicle front and back lights. In some embodiments, the front and/or back lights are used by the system to identify a front and/or back portion of a vehicle. In some embodiments, the front and/or back lights are used in a vehicle type and/or dimension analysis, aiding the system to determine a type of vehicle. In some embodiments pre-trained computer vision models were used for headlight and/or taillight identification. In some embodiments, other vehicle features (e.g., grill, emblem) are detected instead of, or in addition to, front and back lights.

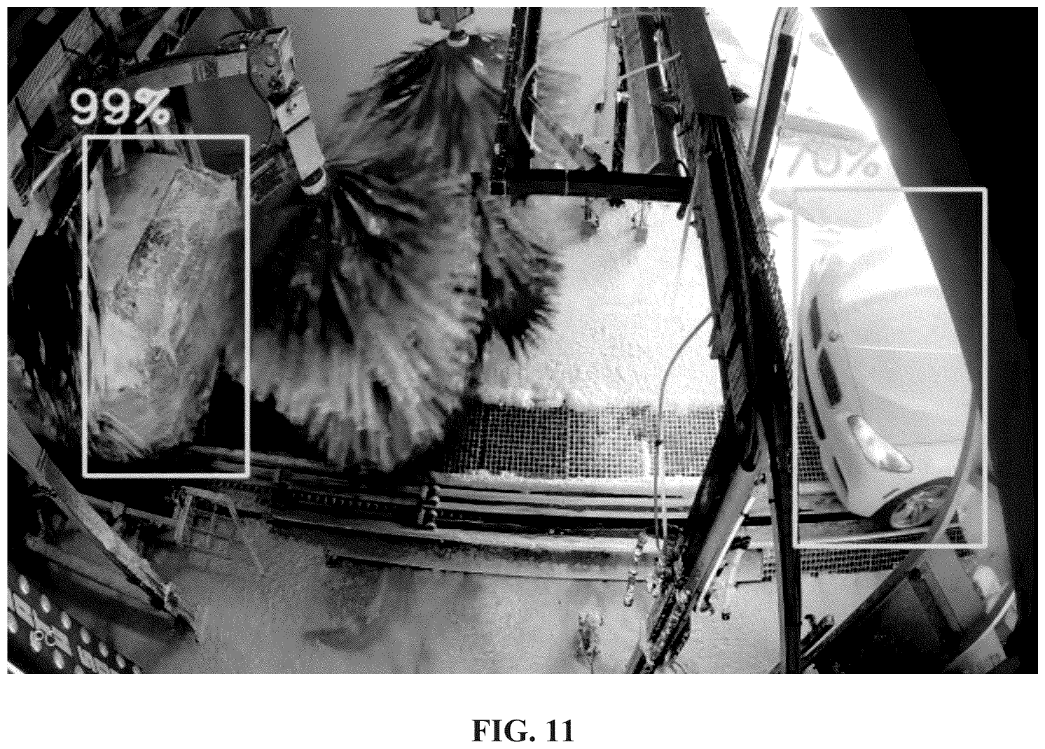

FIG. 11 depicts a vehicle wash tunnel interior image with a machine learning model for vehicle edge detection and added business rule steps implemented by a user and/or the system according to some embodiments. In some embodiments, a step includes, for each sliding window of 15-25 frames (e.g., 20 frames) captured by the camera, calculating the distance between the vehicles in each frame. In some embodiments, a step includes applying a distortion factor for lens-induced visual distortions based on the leftmost vehicle's coordinate, as it is closer to the frame's edge. In some embodiments, a step includes removing status values (A-Alarm, C-Collision, N-Normal) greater than 1 second. In some embodiments, a step includes removing status values (e.g., a brief alarm) that last less than one second. In some embodiments, a step includes providing larger weights based on sequences to the remaining status values after filtering status values less than 1 second from the analysis. In some embodiments, a step includes selecting the highest weight for determining the final status value. In some embodiments, a step includes repeating the above steps for all cameras.

In some embodiments, the system is configured to enable a vehicle wash owner or operator to provide vehicle wash configurations. In some embodiments, these vehicle wash configurations comprise one or more of a blueprint or a diagram with obstacles, a three-dimensional (3D) vehicle wash model, and a tunnel controller specification. In some embodiments, the system includes a LAN with internet access and/or a minimum upload speed of 2 Mbps per camera.

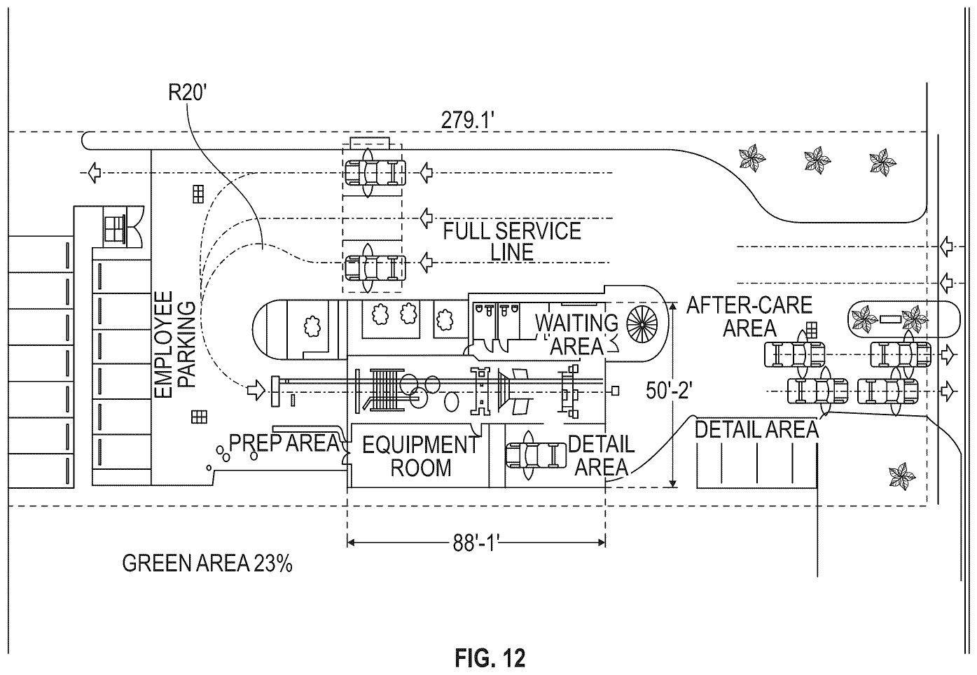

FIG. 12 exhibits an example vehicle wash location blueprint according to some embodiments. In some embodiments, the vehicle wash location blueprint includes a length measurement, a width measurement, a height measurement, a side walls to conveyor measurement, a floor to windows measurement, and/or an obstacle distance measurement. In some embodiments, one or more AI models are configured to convert the blueprint image to a form readable (e.g., written description of measurements and location) by one or more other portions of the system in accordance with some embodiments. In some embodiments, the system is configured to enable to user to input locations and dimensions manually.

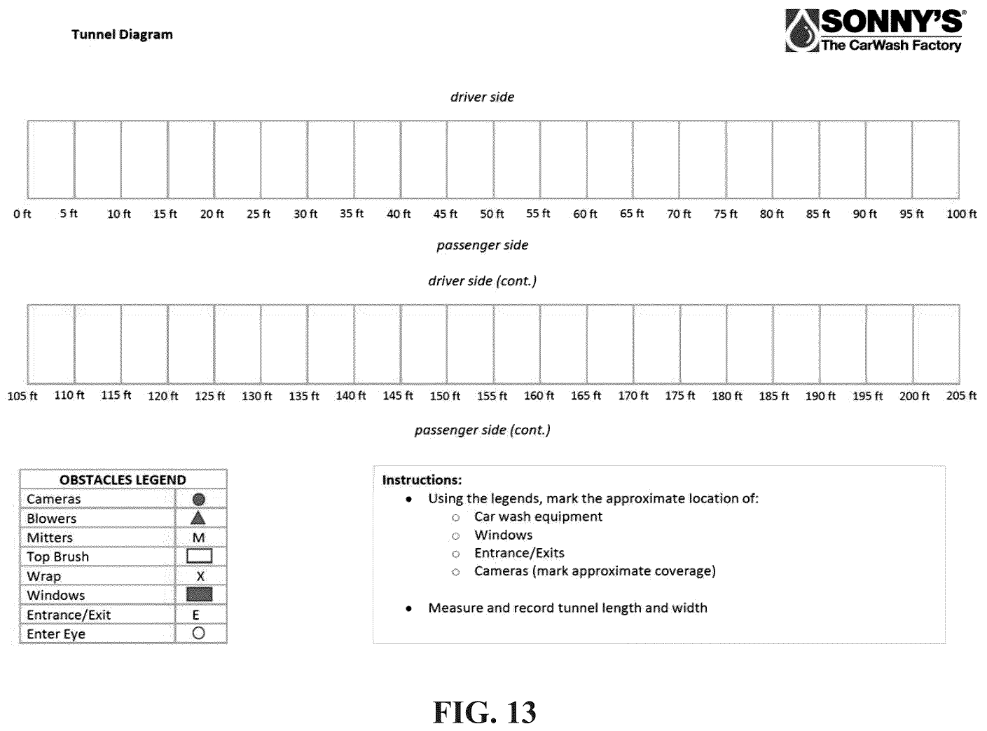

FIG. 13 displays an empty tunnel diagram form according to some embodiments. In some embodiments, the tunnel diagram, also referred to as a vehicle wash diagram herein, includes a form is configured to be filled with information provided by the vehicle wash owner. In some embodiments, this information includes the approximate location of vehicle wash equipment, windows, entrances/exits, and/or cameras along the length of the vehicle wash location (e.g., tunnel). In some embodiments, the diagram form is configured to request measurements of the tunnel including a length measurement, a width measurement, a height measurement, a side walls to conveyor measurement, a floor to windows measurement, and/or an obstacle distance measurement. In some embodiments, the system is configured to use at least part of a tunnel diagram to build a model of a vehicle washing location.

In some embodiments, the system includes a router or a switch is connected to a local LAN. In some embodiments, the router or the switch includes enough POE ports to connect all the cameras. In some embodiments, the switch includes certain requirements including being connected to the internet, having the DHCP enabled, and/or having HTTPS [443] /RSTP ports not blocked. In some embodiments, locations with additional configurations including Firewall, NAT, and/or Port forwarding, may require configuring rules to get internet access.

In some embodiments, one or more cameras may need to be repositioned. In some embodiments, the details of a tunnel and the obstacles need to be known from the tunnel diagram form in FIG. 13. In some embodiments, once these details are entered, a HikVision Mounting Tool can be used as a non-limiting example of a mounting tool for defining the best angle for one or more of the cameras. In some embodiments, the HikVision Mounting Tool is configured to simulate the camera's angle of vision. In some embodiments, the HikVision Mounting Tool is used to input one or more camera models and simulate different scenarios (change mounting height and angle) to see one or more cameras' coverage.

In some embodiments, the coverage area includes a color such as blue (indicating Detection) while the gray areas (blurry areas) should be skipped as they can impact the vehicle recognition. In some embodiments, one or more cameras should be installed above a wet line and every 15-25 ft (e.g., 18-20) feet in the tunnel, starting from the enter eye and ending at the exit of the tunnel. In some embodiments one or more cameras should be installed on the side walls of the tunnel (either side), and the ceiling should be avoided for installation locations. In some embodiments, one or more of the cameras should easily see the complete side of passing vehicles for executing one or more operations described herein. In some embodiments, a user should make sure the whole surface of the vehicle wash is covered, avoiding blind spots. In some embodiments, after the best location(s) are decided, a user can proceed to permanently mount cameras.

In some embodiments, a suitable camera includes a HikVision DS-2CD2342WD-I as a non-limiting example of a Power over Ethernet (PoE) camera or ethernet connected camera. In some embodiments, the camera is installed and configured through a series of steps. In some embodiments, these steps include one or more of steps 1-8. In some embodiments, step 1 includes connecting the camera to a switch. In some embodiments, step 2 includes opening a web browser (e.g., compatible with Internet Explorer/Mozilla Firefox/Safari; it should be compatible with Google Chrome if security configurations are changed) or alternatively downloading a Hik-Connect app on a mobile device. In some embodiments, step 3 includes typing in the default IP assigned to the camera. In some embodiments, step 4 includes accessing the web console through a username and password (e.g., “admin” and “12345”). In some embodiments, step 5 includes navigating through Configuration to Network to Basic Settings to assign a IPv4 address and a default gateway (on TCP/IP tab), and, when installing one or more of the cameras, changing RTSP/HTPPS ports (a prefix can be assigned before 554/443; example cam 1: 10554|10443). In some embodiments, step 6 includes navigating through Configuration to System to User Management to change the admin password to a secure password and to create different types of users to control one or more of the cameras. In some embodiments, step 7 includes making sure the time zone of the camera is correct and if preferred and setting up a name for the device and a display name. In some embodiments, step 8 includes saving the changes. In some embodiments, the camera should then be accessible. In some embodiments, this process needs to be repeated for every camera, assigning a different IP address and port to each.

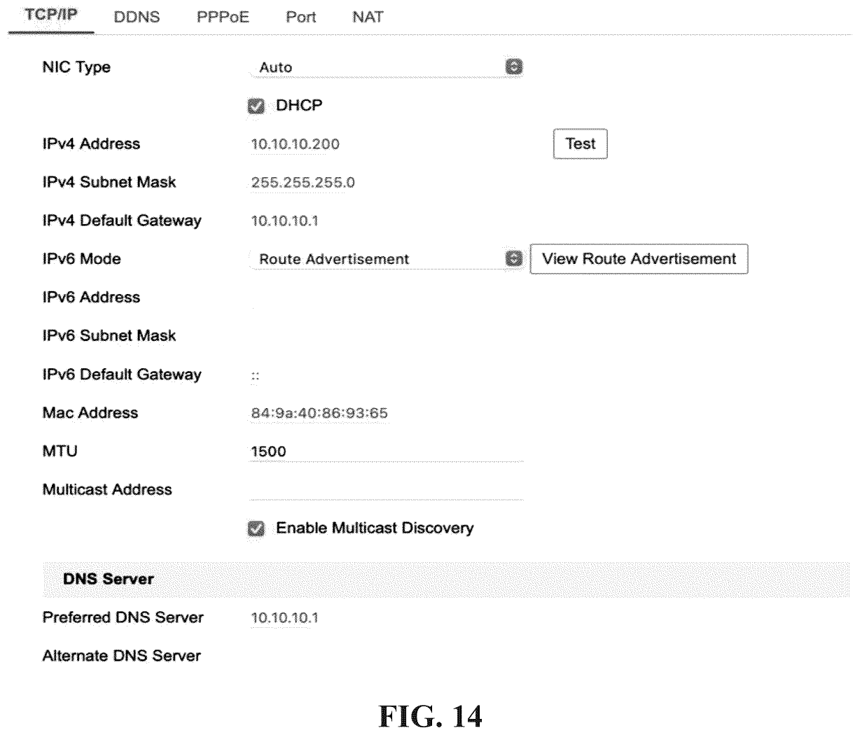

FIG. 14 illustrates a non-limiting example GUI for a testing location's camera installation change IP setting according to some embodiments. In some embodiments, this matches the screen of the change IP setting in step 5 of a Hik-Vision DS-2CD2342WD-I's installation and configuration.

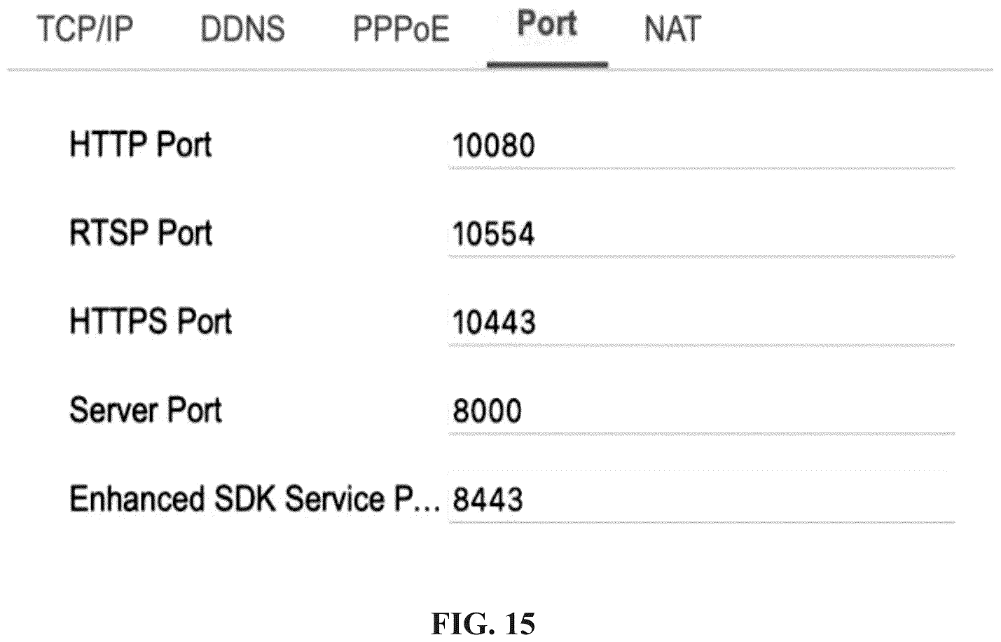

FIG. 15 shows a non-limiting example GUI for a testing location's camera installation change port setting according to some embodiments. In some embodiments, this matches the screen of the change port setting in step 5 of a Hik-Vision DS-2CD2342WD-I's installation and configuration.

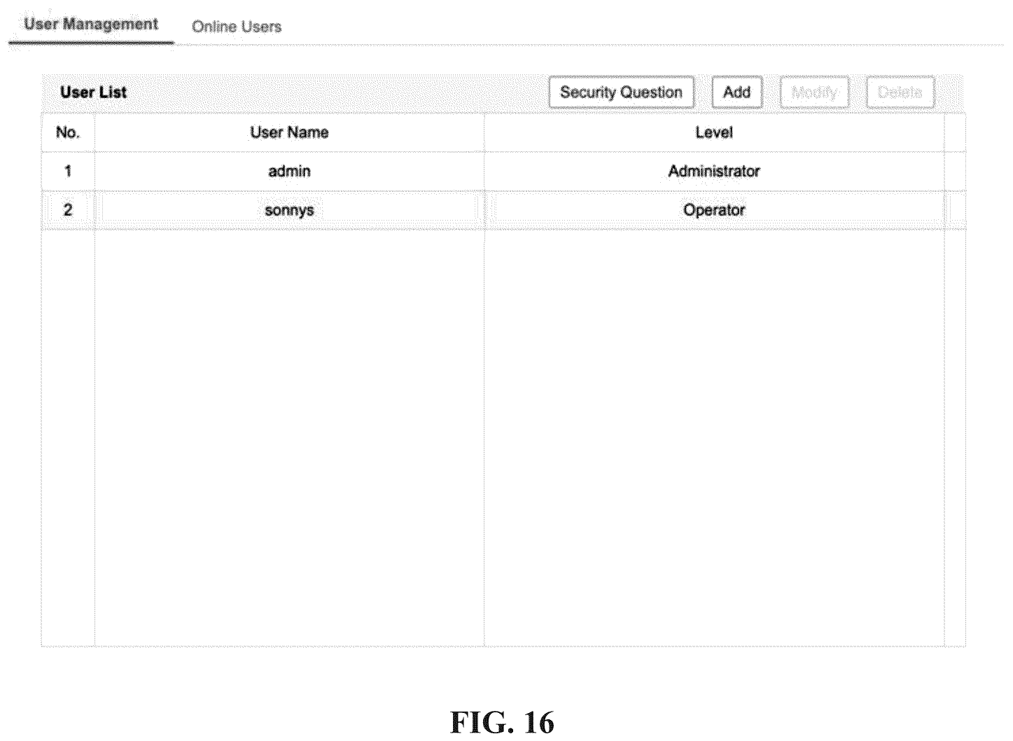

FIG. 16 demonstrates a non-limiting example GUI for a testing location's camera installation change user setting according to some embodiments. In some embodiments, this matches the screen of the change user setting in step 6 of a Hik-Vision DS-2CD2342WD-I's installation and configuration.

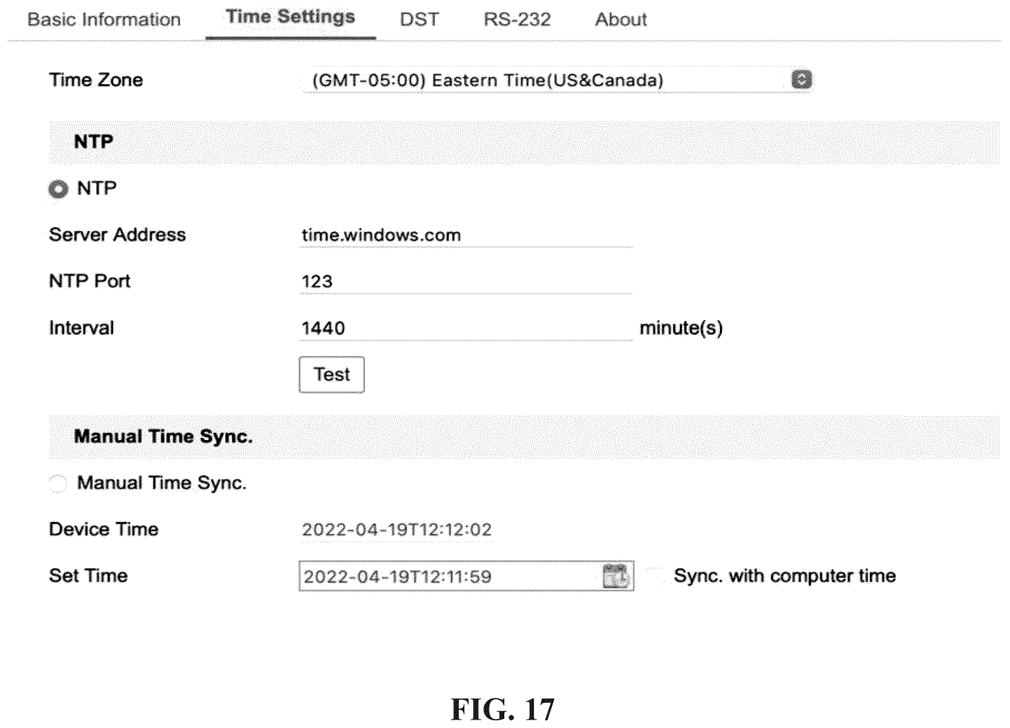

FIG. 17 portrays a non-limiting example GUI for a testing location's camera installation change time setting according to some embodiments. In some embodiments, this matches the screen of the change time setting in step 7 of a Hik-Vision DS-2CD2342WD-I's installation and configuration.

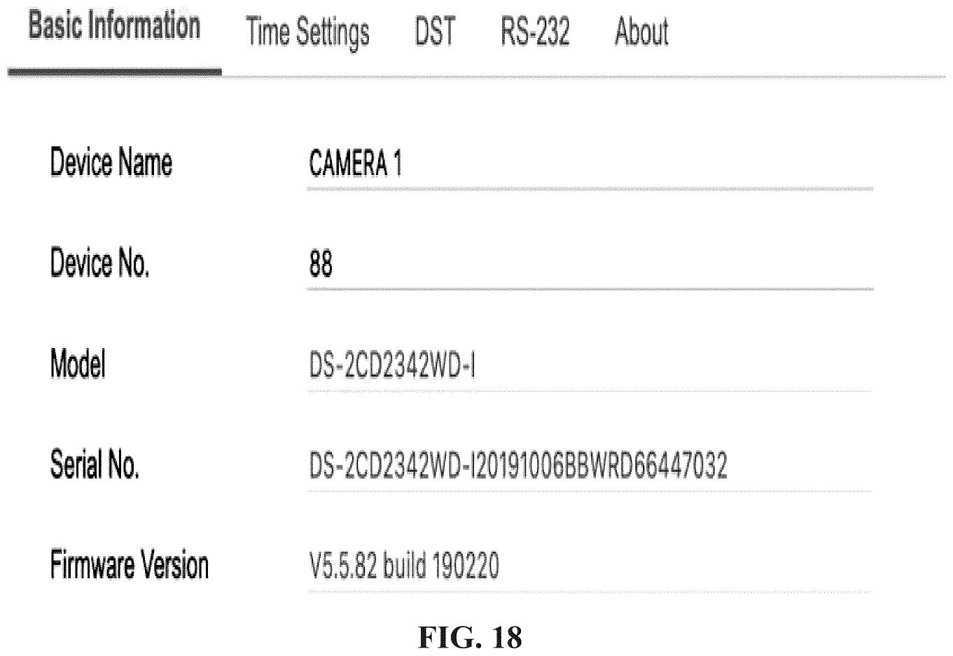

FIG. 18 depicts a non-limiting example GUI for a testing location's camera installation change device name setting according to some embodiments. In some embodiments, this matches the screen of the change device name setting in step 7 of a Hik-Vision DS-2CD2342WD-I's installation and configuration.

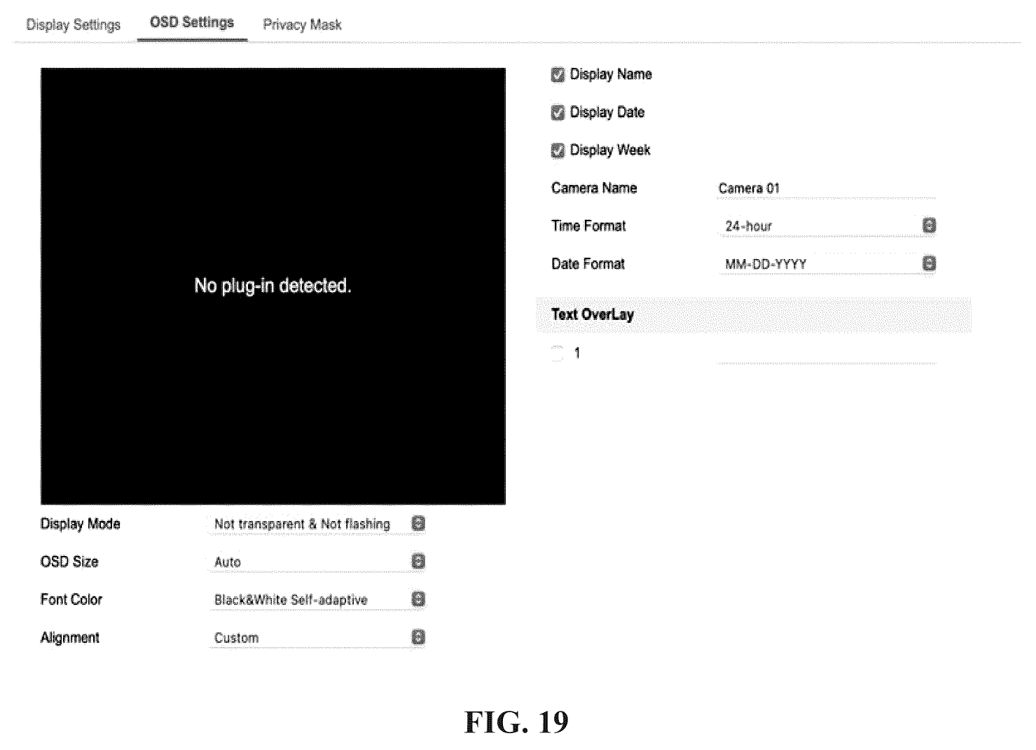

FIG. 19 exhibits a non-limiting example GUI for a testing location's camera installation change display setting according to some embodiments. In some embodiments, this matches the screen of the change display name setting in step 7 of a Hik-Vision DS-2CD2342WD-I's installation and configuration.

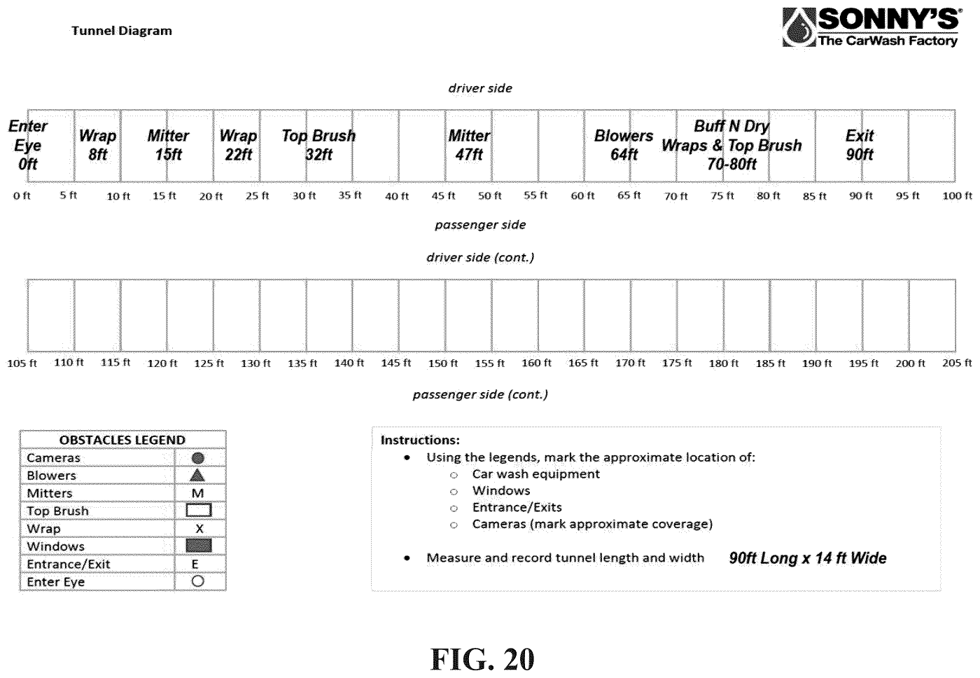

FIG. 20 displays an example testing location tunnel diagram form according to some embodiments. In some embodiments one or more of a vehicle wash's equipment, an entrance, an exit, and one or more cameras is indicated on the diagram along with their approximate locations. In some embodiments, one or more of the cameras are represented by a filled circle where a gray filled circle represents one or more of the camera installed for anti-collision solution and a blue filled circle represents one or more of the camera already installed. In some embodiments, the measurements include a length of a tunnel (e.g., 90 feet), a width of the tunnel (e.g., 14 feet), a height of the tunnel (e.g., 12.5 feet), a side wall to conveyor measurement (e.g., 2.66 feet), and a floor to windows measurement (e.g., 10 feet).

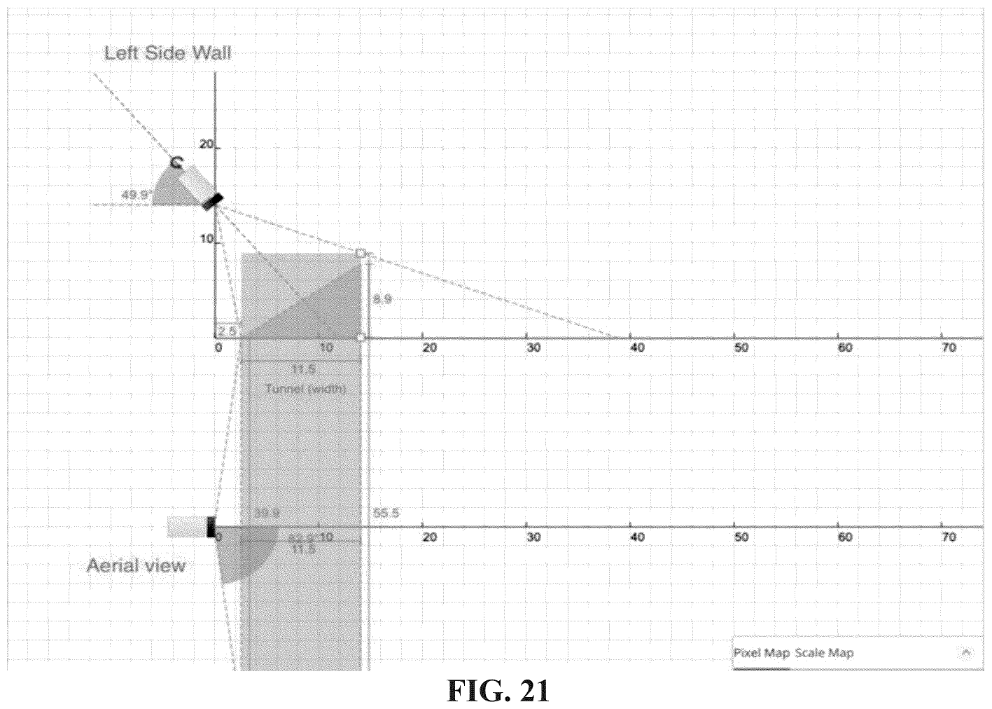

FIG. 21 illustrates a camera location map derived for camera 1 from the tunnel diagram of FIG. 20 according to some embodiments. In some embodiments, the system is configured to output a camera location map to avoid obstructions and/or obtain a complete visual coverage of the vehicle wash area. In some embodiments, the final location of one or more cameras includes one or more distances. In some embodiments, non-limiting example distances for camera 1 include 4 feet from an enter eye (in between the enter eye and a wrap) with a height at the ceiling line (estimated 14 feet) and an angle of 50 degrees tilted downwards.

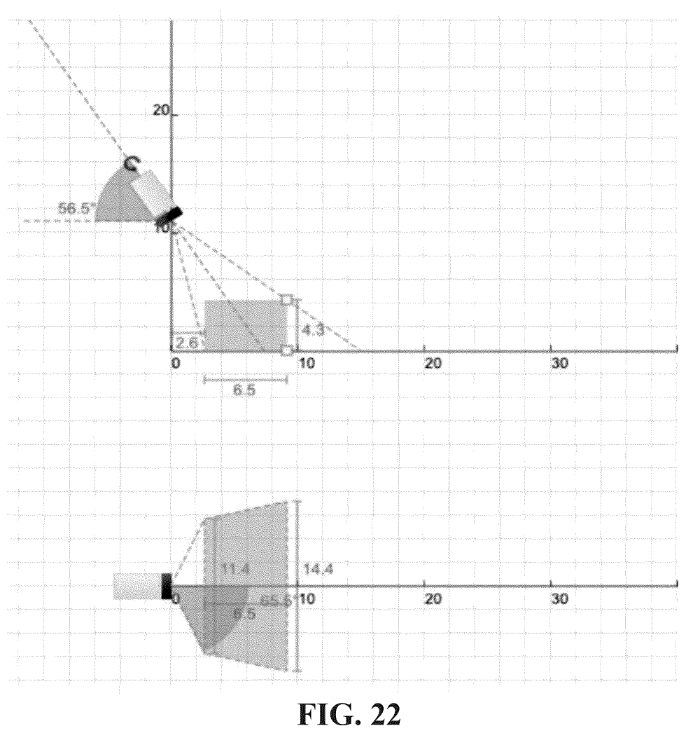

FIG. 22 shows camera location map derived for camera 2 from the tunnel diagram of FIG. 20 according to some embodiments. In some embodiments, a non-limiting example of the final location of camera 2 is 20 feet from an enter eye (in between the enter eye and a wrap) with a height at 11 feet and an angle of 57 degrees tilted downwards.

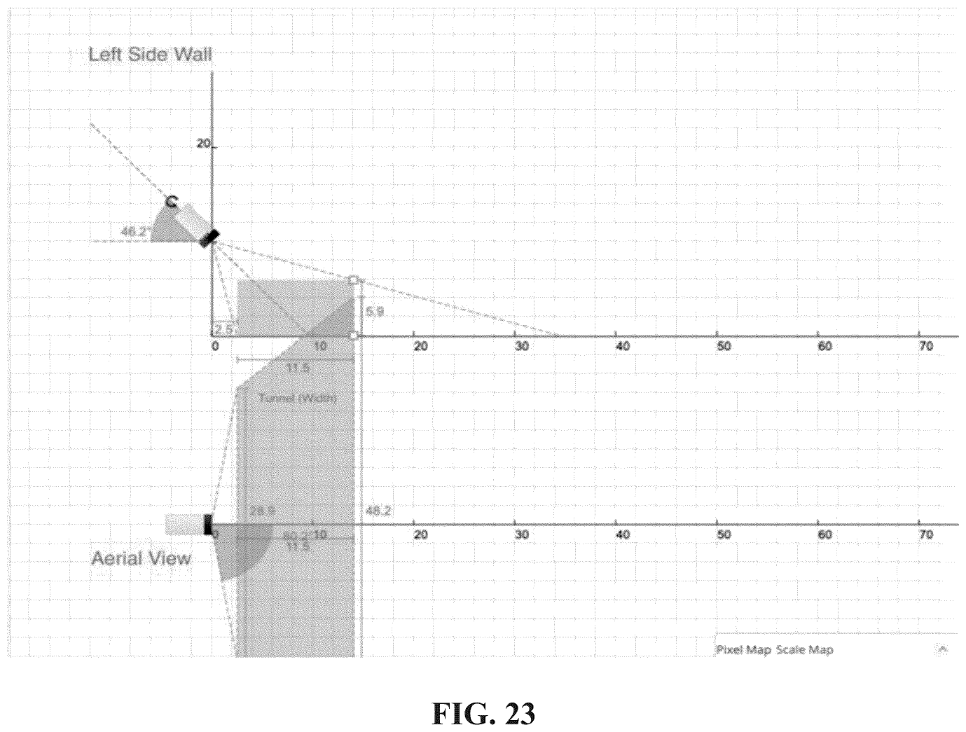

FIG. 23 demonstrates a camera location map derived for camera 3 from FIG. 20 according to some embodiments. In some embodiments, a non-limiting example of the final location of camera 3 is 40 feet from an enter eye (in between the enter eye and a wrap) with a height of 1 foot above the window (estimated 10 feet) and an angle of 54 degrees tilted downwards.

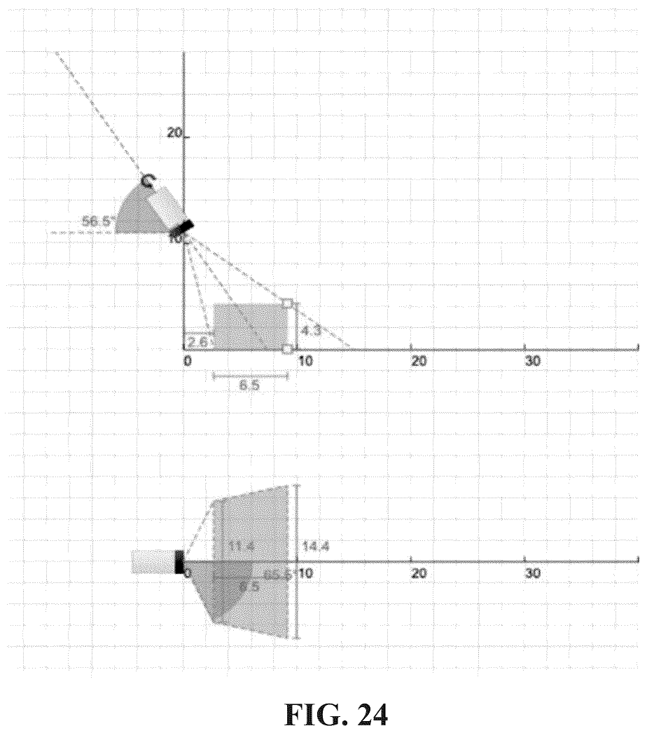

FIG. 24 portrays a camera location map derived for camera 4 from FIG. 20 according to some embodiments. In some embodiments, a non-limiting example of the final location of the camera 4 is 57 feet from an enter eye (in between the enter eye and a wrap) with a height of 11 feet and an angle of 51 degrees tilted downwards.

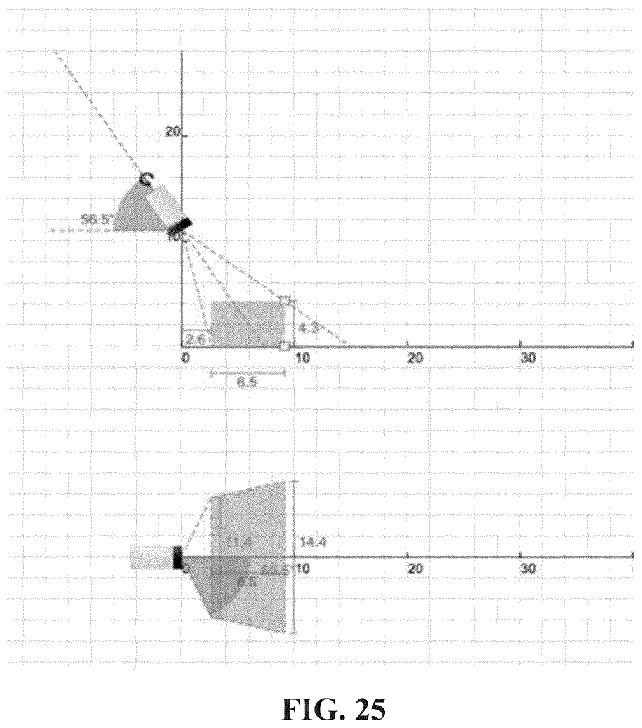

FIG. 25 depicts a camera location map derived for camera 6 from FIG. 20 according to some embodiments. In some embodiments, a non-limiting example of the final location of camera 6 is the same location as a security camera at approximately 85 feet from an enter eye (in between the enter eye and a wrap) with a height at the ceiling line (estimated 14 feet) and an angle of 59 degrees tilted downwards.

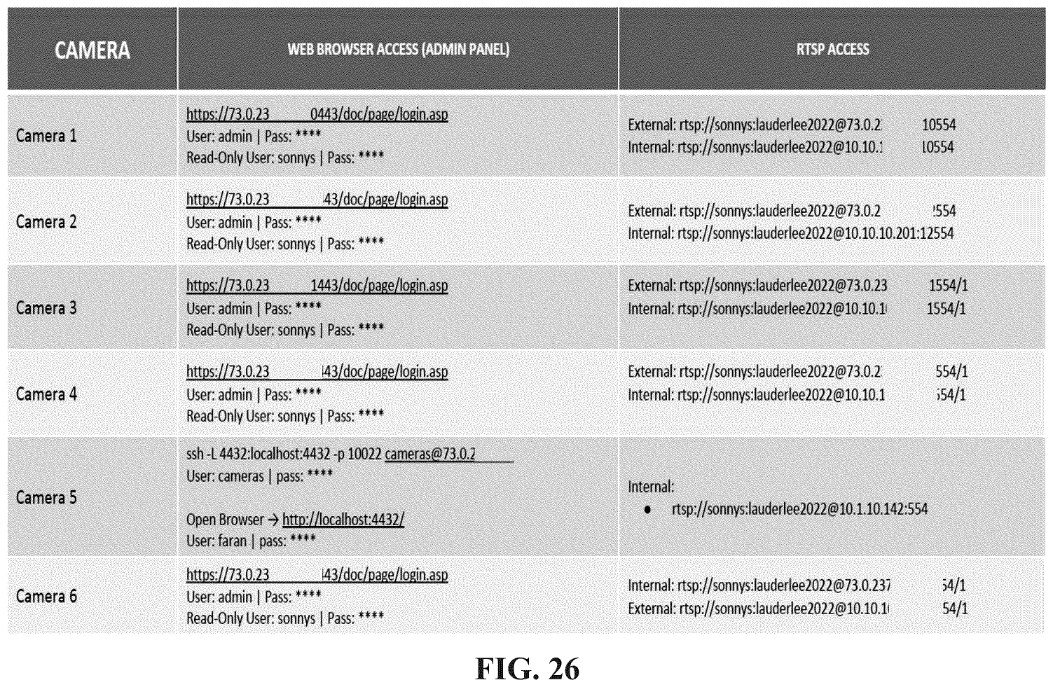

FIG. 26 exhibits a table of one or more of a camera and their web browser access and RTSP access from the testing location from FIG. 20 according to some embodiments. In some embodiments, the web browser access for one or more of the cameras installed for anti-collision solution includes a link, a username, a password, a read-only username, and a read-only user password. In some embodiments, the web browser access for one or more of the cameras already installed includes a link, a username, a password, an open browser link, an open browser username, and an open browser password. In some embodiments, the RTSP access for one or more of the cameras installed for anti-collision solution includes an external link and an internal link. In some embodiments, the RTSP access for one or more of the cameras already installed includes the internal link.

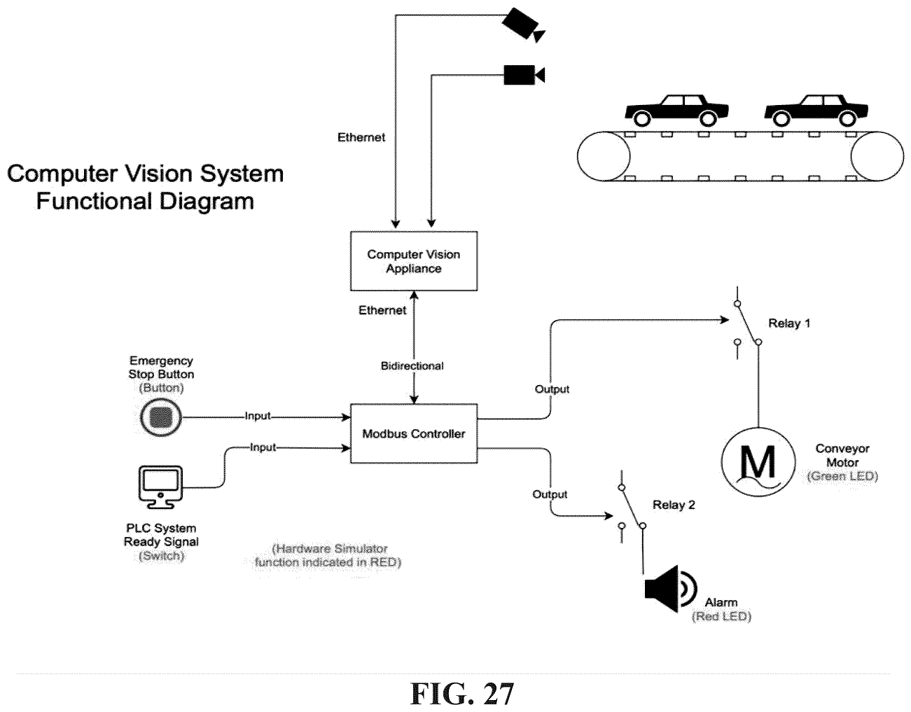

FIG. 27 displays a functional diagram of a computer vision model according to some embodiments. In some embodiments, an edge manager services module installed in an at-the edge solution is configured to send signals to a relay via an Ethernet to a Modbus Relay controller. In some embodiments, the Modbus should be connected to a switch and be a part of the same local network as the AI appliance (e.g., Nvidia Jetson).

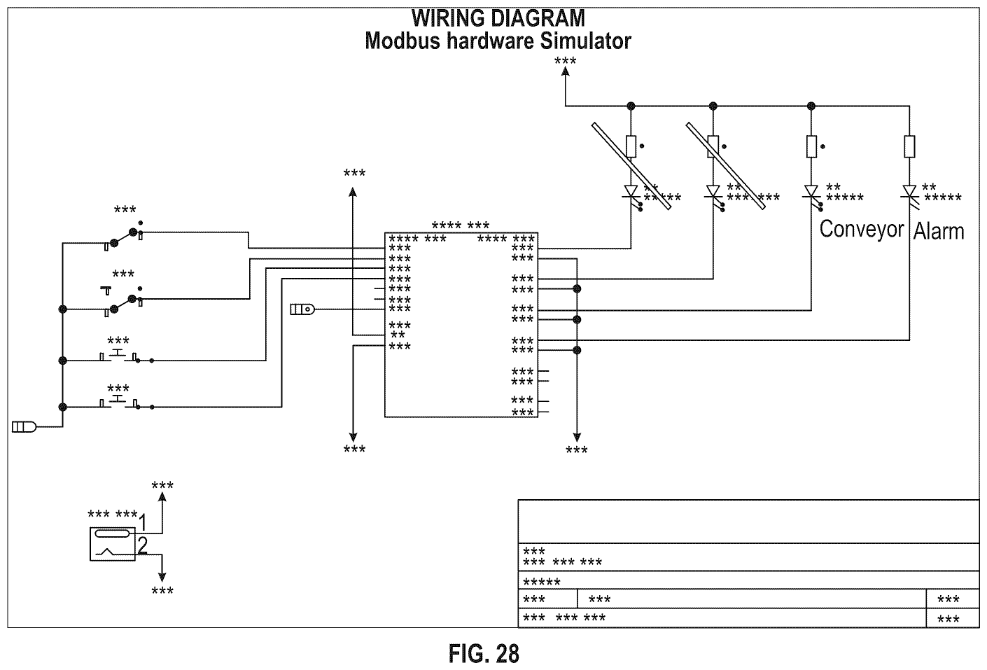

FIG. 28 illustrates a Modbus hardware simulator wiring diagram according to some embodiments. In some embodiments, an R2 Digital Output should be wired to a conveyor and a R3 Digital Output should be wired to an alarm. In some embodiments, for testing purposes, one or more LEDs are wired on a R0 (replica of the R2) and on a R1 (replica of the R3).

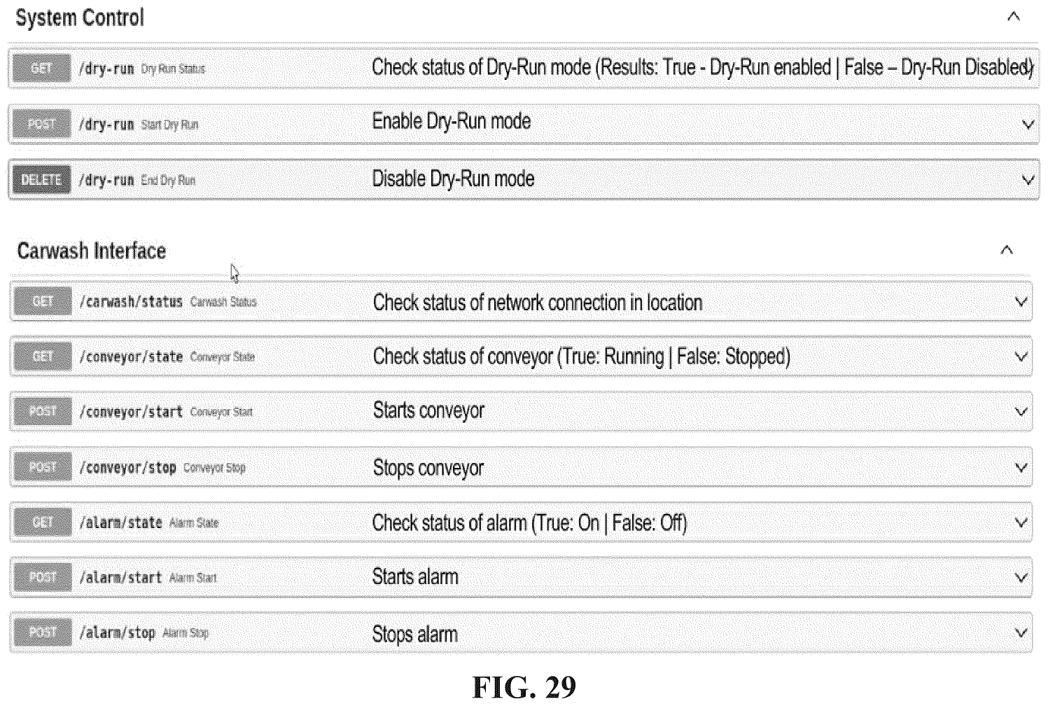

FIG. 29 shows a FastAPI Swagger user interface (UI) for a communication protocol (Modbus) according to some embodiments. In some embodiments, the API UI is configured to manually control and send signals to the Modbus, in case an operator wants to send a signal to start/stop a conveyor, and/or in case they want to operate the system in Dry-Run mode. In some embodiments, to access the UI a browser needs to be opened inside a Nvidia Jetson. In some embodiments, Dry-Run mode is where the system won't send signals to the Modbus, but it will continue logging information. In some embodiments, the Dry-Run mode is used for testing purposes, or in case of any failure that affects normal usage.

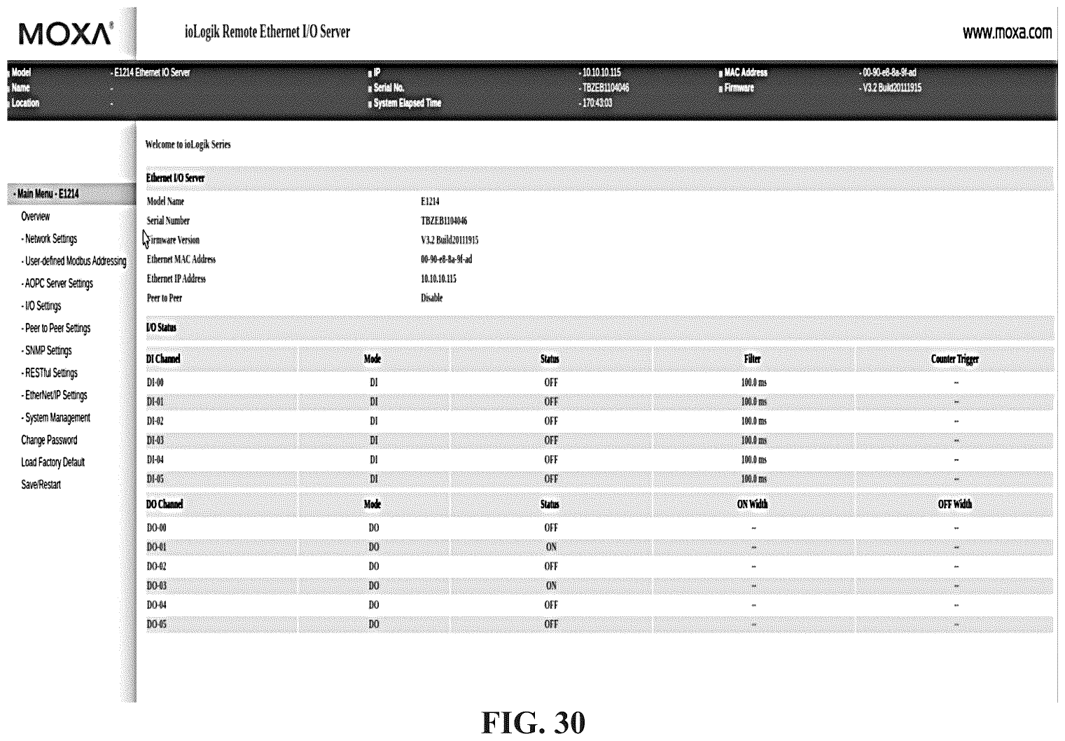

FIG. 30 demonstrates a MOXA Web Interface for a Modbus according to some embodiments. In some embodiments, the Modbus comes with the web interface configured for testing and debugging. In some embodiments, to access the UI (GUI) a browser needs to be opened inside a LAN (e.g., Nvidia Jetson) by typing the Modbus IP address on the browser to access the web interface. In some embodiments, a DO-02 (Digital Output 02) is a conveyor and a DO-03 (Digital Output 03) is an alarm.

In some embodiments, a Nvidia Jetson NJX includes a series of installation steps performed by a user and/or the system. In some embodiments these steps include one or more of steps 1-5. In some embodiments, step 1 includes connecting the Nvidia Jetson NJX to the local switch. In some embodiments, step 2 includes creating a copy of a master SD in a new SD (that has a minimum of 128 GB). In some embodiments step 3 includes inserting the copied SD in a Nvidia Jetson NJX SD memory slot. In some embodiments, step 4 includes plugging in the Nvidia Jetson to a power source. In some embodiments, step 5 includes turning on the Nvidia Jetson.

In some embodiments, the system includes four configuration files that are used to configure specific parameters of each location. In some embodiments, one or more configuration files are part of an edge service and are stored.

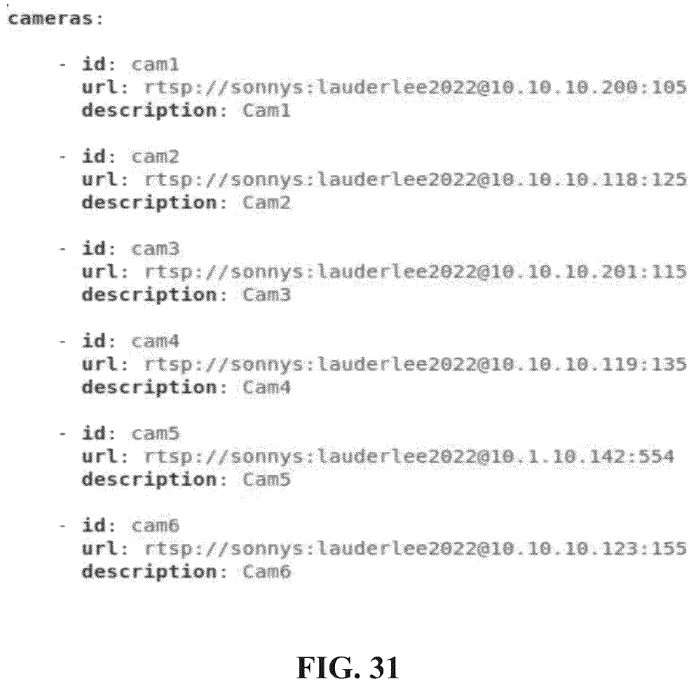

FIG. 31 portrays a camera configuration file (cameras.yml) at the testing location of FIG. 20 according to some embodiments. In some embodiments, the cameras.yml includes all the information about one of more cameras installed at the location. In some embodiments, there are individual parameters for one or more of the cameras including an id, a URL, and a description. In some embodiments, the id includes the given name to the camera, the URL includes the internal rtsp address of the camera (an external rtsp shouldn't be used as it will cause delays), and the description includes a description of the camera (optional). In some embodiments, the configuration file should be updated every time an anti-collision system is deployed in a new location. In some embodiments, the file should be updated in a development environment, before executing a Greengrass deployment.

It is not recommended to update the file in production, but if small changes need to be made, there are a series of steps to do so. In some embodiments, the series of steps includes step 1-8. In some embodiments, step 1 includes opening a terminal inside a Nvidia. In some embodiments, step 2 includes changing to root | $ sudo -i. In some embodiments, step 3 includes navigating to a services folder | $ cd . . . /home/edge/apps/svc/config. In some embodiments, step 4 includes opening the file with a text editor | gedit cameras.yml. In some embodiments, step 5 includes making changes. In some embodiments, step 6 includes saving the file. In some embodiments, step 7 includes reloading the configuration file using/config/reload FastAPI. In some embodiments, step 8 includes closing the video tile and wait for the application to restart automatically, however, if the application does not automatically restart, a step includes manually restarting it.

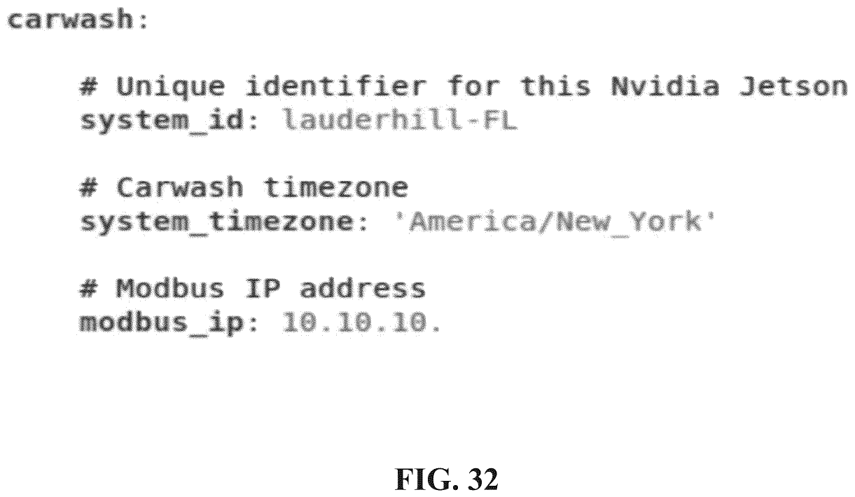

FIG. 32 depicts a vehicle wash configuration file (vehiclewash.yml) at the testing location of FIG. 20 according to some embodiments. In some embodiments, the vehiclewash.yml includes information about the vehicle wash location and time zone. In some embodiments, there are a set of parameters including a system_id, a system_timezone, and a modbus_ip. In some embodiments, the system_id includes the location name (should be a unique ID), which will be used by Greengrass. In some embodiments, the system_timezone includes the vehicle wash time zone (TZ Database name). In some embodiments, the modbus_ip includes the IP where a Modbus is connected. In some embodiments, the configuration file must be updated every time an anti- collision system is deployed in a new location. In some embodiments, the file should be updated in a development environment, before executing a Greengrass deployment.

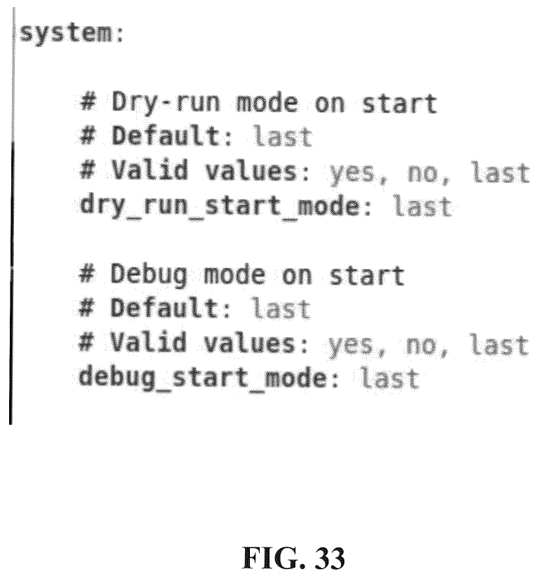

FIG. 33 exhibits a system configuration file (system.yml) at the testing location of FIG. 20 according to some embodiments. In some embodiments, the system.yml includes information about a Dry-Run mode and a Debug mode. In some embodiments, the file should not be edited unless it is desired to change the initial values of the Dry-Run/Debug mode. In some embodiments, there are a set of parameters including a dry_run_start_mode and a debug_start_mode. In some embodiments, the dry_run_start_mode includes valid values including a yes, a no, and/or a last. In some embodiments, the yes value indicates the system will always start on DRY RUN mode, the no value indicates the system won't start on DRY RUN mode, and the last value indicates the system will used the last value stored. In some embodiments, the dry_run_start_mode has valid values including the yes, the no, and the last. In some embodiments, the yes value indicates the system will always start on DRY_RUN mode, the no value indicates the system won't start on DRY_RUN mode, and the last value indicates the system will used the last value stored. In some embodiments, the file should be updated in a development environment, before executing a Greengrass deployment.

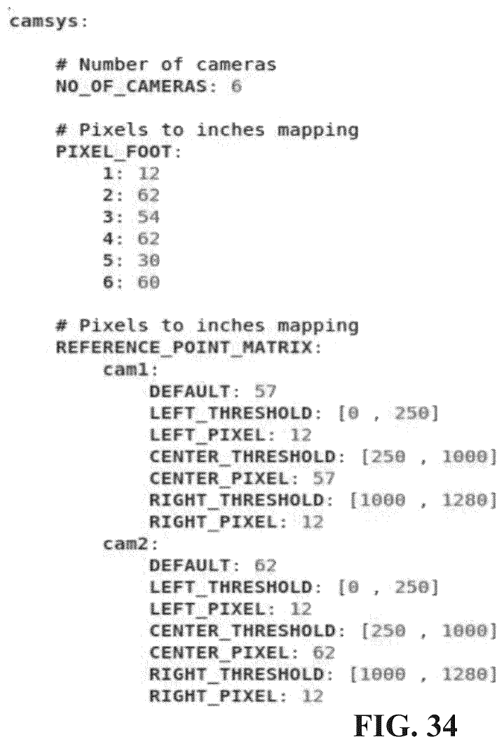

FIG. 34 displays a camsys configuration file (camsys.yml) at the testing location of FIG. 20 according to some embodiments. In some embodiments, the camsys.yml includes information about the reference points for each camera and the distance for alert and collision. In some embodiments, there are a set of parameters including one or more of a NO_OF_CAMERAS, a REFERENCE_POINT_MATRIX, a valid_camera_states, a D_min_distance, a C_min_distance, a NO_OF_DETECTION_FRAMES, a NO_OF_DETECTION_FRAMES_COUNT, a keepalive_interval, and a MIN_WEIGHT_SCORE. In some embodiments, the NO_OF_CAMERAS is the number of cameras used in the location (maximum of 6). In some embodiments, the valid_camera_states include a list of valid states allowed in the system. In some embodiments, the D_min_distance includes the minimum distance to trigger A state and the C_min_distance includes the minimum distance to trigger C state. In some embodiments, the NO_OF_DETECTION_FRAMES includes the sliding window number of frames and the NO_OF_DETECTION_FRAMES_COUNT includes the number of frames to check with no detection before sending an N status. In some embodiments, the keepalive_interval includes the system keep alive interval in seconds. In some embodiments, the MIN_WEIGHT_SCORE includes the business logic weight score. In some embodiments, the configuration file should be updated every time an anti-collision system is deployed in a new location. In some embodiments the file should be updated in a development environment, before executing a Greengrass deployment.

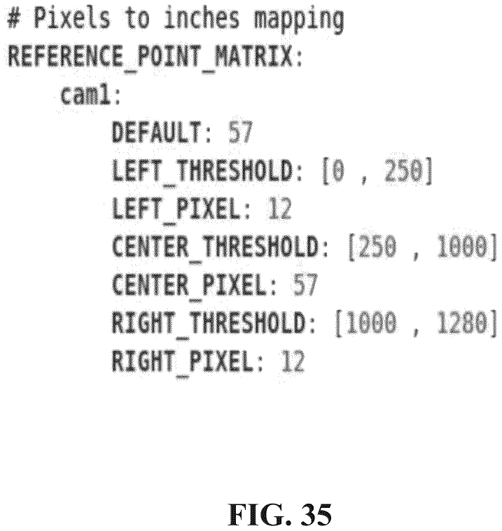

FIG. 35 illustrates a reference point matrix for a camsys configuration file in FIG. 34 according to some embodiments. In some embodiments, the reference point matrix is configured to account for camera distortion (e.g., from wide angular cameras). In some embodiment, the matrix should be updated based on one or more of the location and the changes saved, and then the system restarted. In some embodiments, a LEFT_THRESHOLD includes a lengthwise range of pixels starting at the left of the image and ending where a CENTER_THRESHOLD begins, and a LEFT_PIXEL includes the number of pixels in a foot from the LEFT_THRESHOLD range. In some embodiments, the CENTER_THRESHOLD includes a lengthwise range of pixels starting where the LEFT_THRESHOLD ends and ending where the RIGHT_THRESHOLD begins, and a CENTER_PIXEL includes the number of pixels in a foot from the CENTER_THRESHOLD range. In some embodiments, the RIGHT_THRESHOLD includes a lengthwise range of pixels starting where the CENTER_THRESHOLD (on the right) ends and ending at the right of the image, and a RIGHT_PIXEL includes the number of pixels in a foot from the RIGHT_THRESHOLD range.

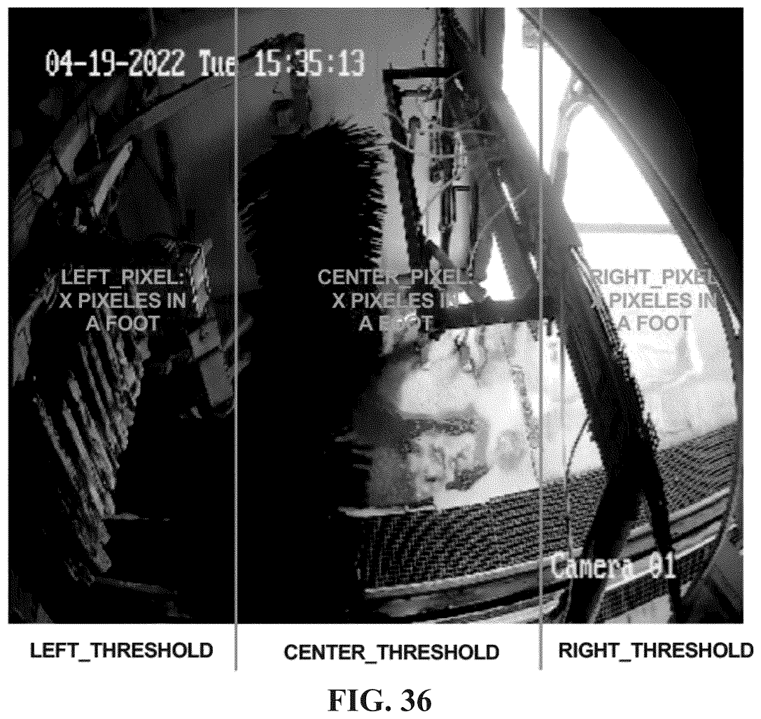

FIG. 36 shows a vehicle wash tunnel interior broken up into a LEFT_THRESHOLD, a CENTER_THRESHOLD, and a RIGHT_THRESHOLD for a reference point matrix of FIG. 35 according to some embodiments. In some embodiments a LEFT_PIXEL is the number of pixels within the LEFT_THRESHOLD that make up a foot. In some embodiments a CENTER_PIXEL is the number of pixels within the CENTER_THRESHOLD that make up a foot. In some embodiments a RIGHT_PIXEL is the number of pixels within the RIGHT_THRESHOLD that make up a foot.

In some embodiments, after an SD memory card is copied to the system and a Jetson is booted for the first time, all dockers in the system, except a Greengrass docker, are already built and will start automatically. In some embodiments, a need to generate a Greengrass certificate for the new location exists, and the Greengrass docker will need to be manually built and started.

In some embodiments, after a new ‘Thing’ is created in the AWS Greengrass, an individual group needs to be created in the Greengrass on an AWS Management Console, then the user adds the new thing inside the group or adds the thing to an existing group. In some embodiments, there are a series of steps to create a new group and add the thing to a group, which includes one or more steps 1-4. In some embodiments, step 1 includes to going to Things Group and select Create Thing Group. In some embodiments, step 2 includes selecting static group. In some embodiments, step 3 includes inserting the name of the new group and click “Create thing group”. In some embodiments, step 4 includes accessing the group, selecting “Things”, and adding the new think inside the group (should appear on the list under the name assigned while building a Greengrass docker). Some embodiments include a series of steps to add the thing to an existing group including selecting the group, going to things and selecting “add things”, choose the thing from the list, and/or clicking add thing.

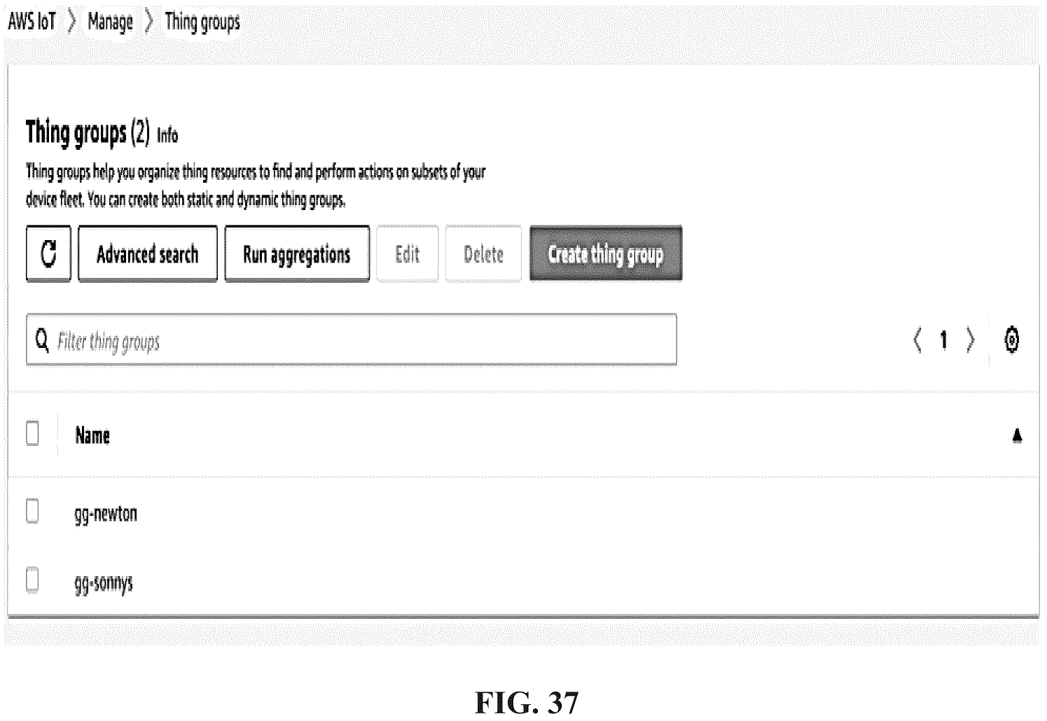

FIG. 37 demonstrates step 1 of creating a new Greengrass group according to some embodiments. In some embodiments, the first step includes to go to Things group and select Create Thing Group.

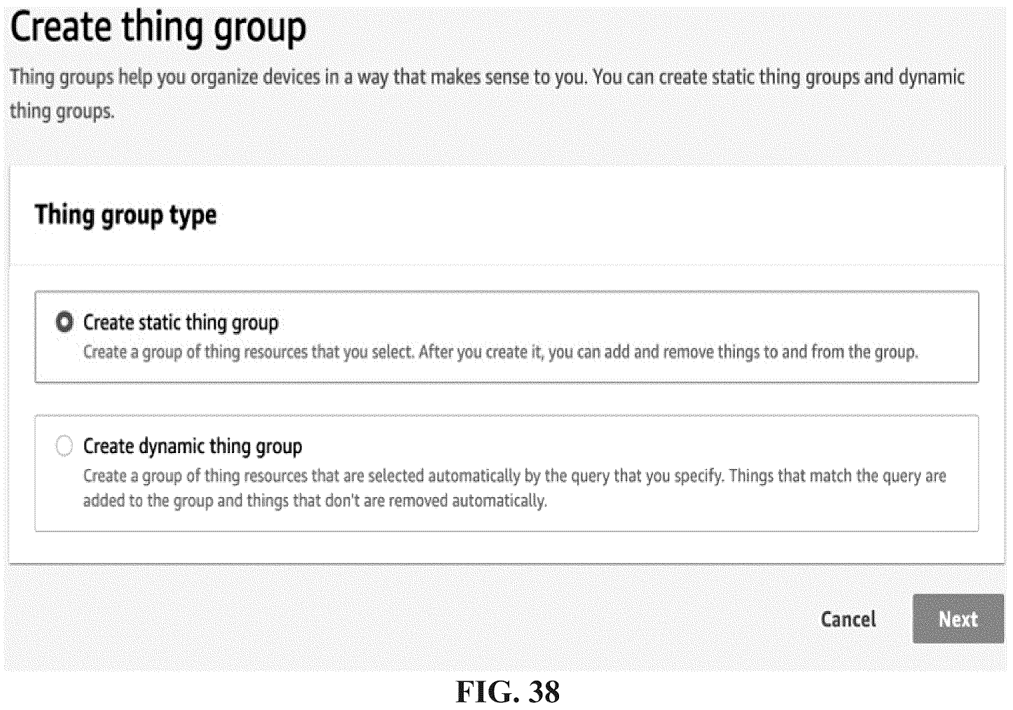

FIG. 38 portrays step 2 of creating a new Greengrass group according to some embodiments. In some embodiments, step 2 includes to select static group.

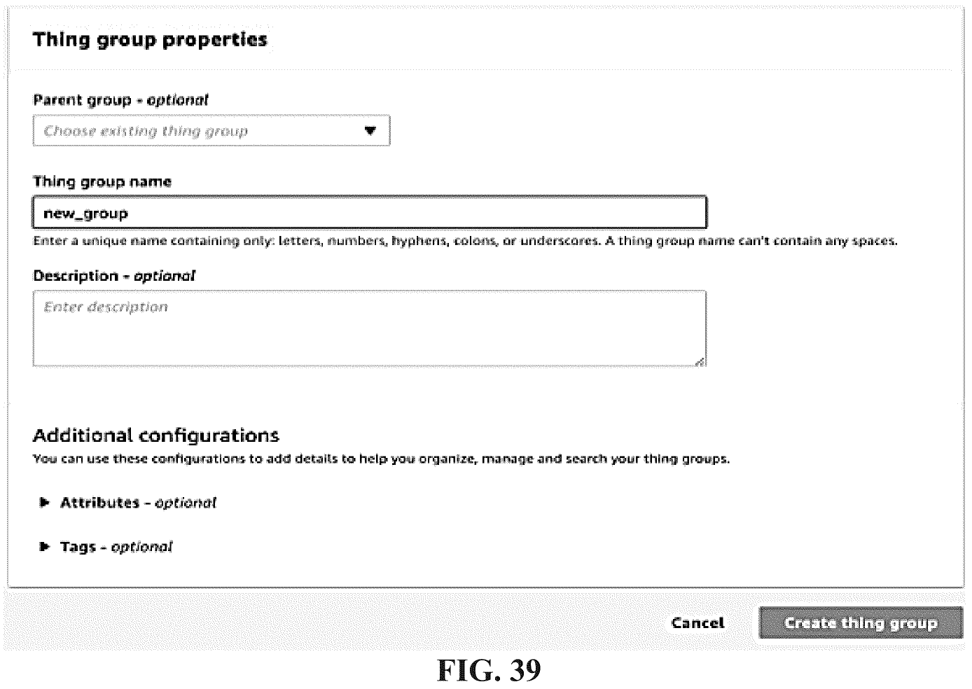

FIG. 39 depicts step 3 of creating a new Greengrass group according to some embodiments. In some embodiments, step 3 includes to insert name of the new group and click “Create thing group.”

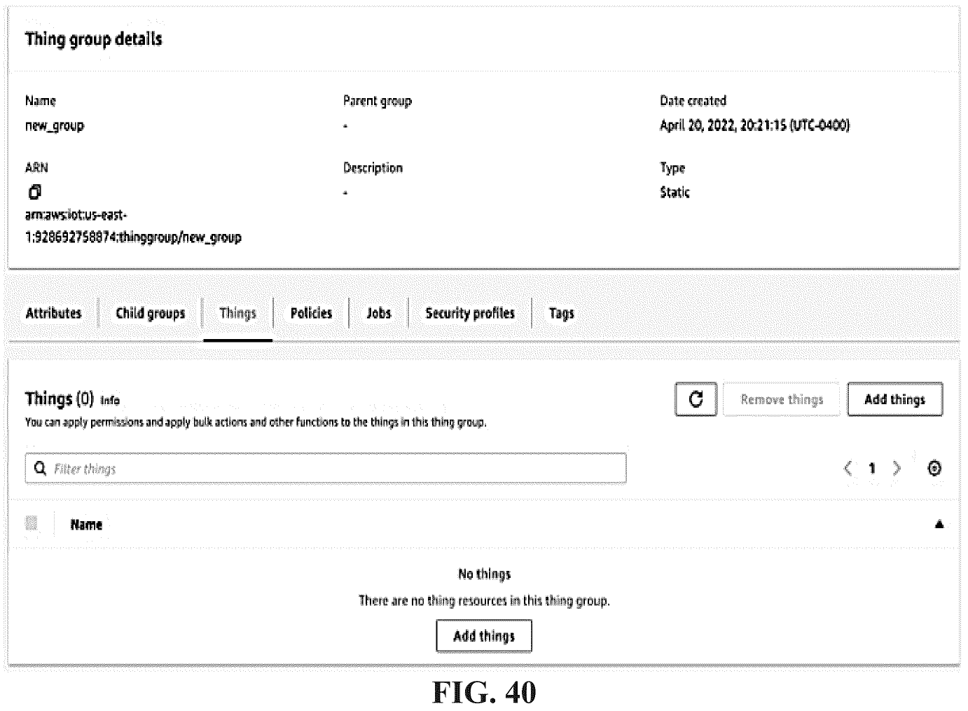

FIG. 40 exhibits step 4 of creating a new Greengrass group according to some embodiments. In some embodiments, step 4 includes to access the group, select “Things”, and add the new think inside the group (should appear on the list under the name assigned while building a Greengrass docker).

In some embodiments, after a group is created, a Greengrass deployment needs to be triggered. In some embodiments, a component that contains a Lamda function that deploys one or more of a CPIO file (including a edge-common.cpio.gz and a location-custom.cpio.gz) that should be stored in a cloud-based system such as Amazon Web Services (AWS) as a non-limiting example. In some embodiments, the edge-common.cpio.gz is a file containing the common production code of an anti-collision system. In some embodiments, the edge-common.cpio.gz is updated. In some embodiments, if any changes are made to the code of the development environment and are to be deployed, a new CPIO file will need to be created. In some embodiments, the location-custom.cpio.gz includes a file containing the configuration files for that specific location. In some embodiments, each new location that needs a new CPIO file with the name of the location should correspond with the location name specified in system.yml, and the file should be created in the development environment (it isn't recommended to uses previous CPIOs and modify the config files on production).

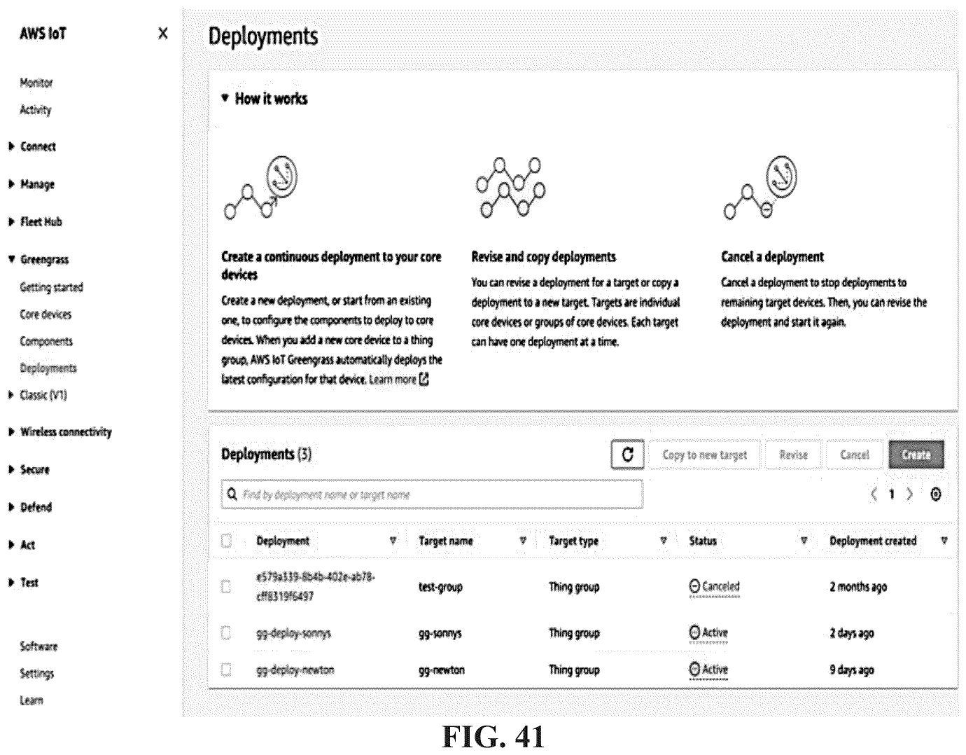

FIG. 41 displays a step 1 Greengrass deployment via a web interface according to some embodiments. In some embodiments, step 1 includes creating new deployment in the deployments page.

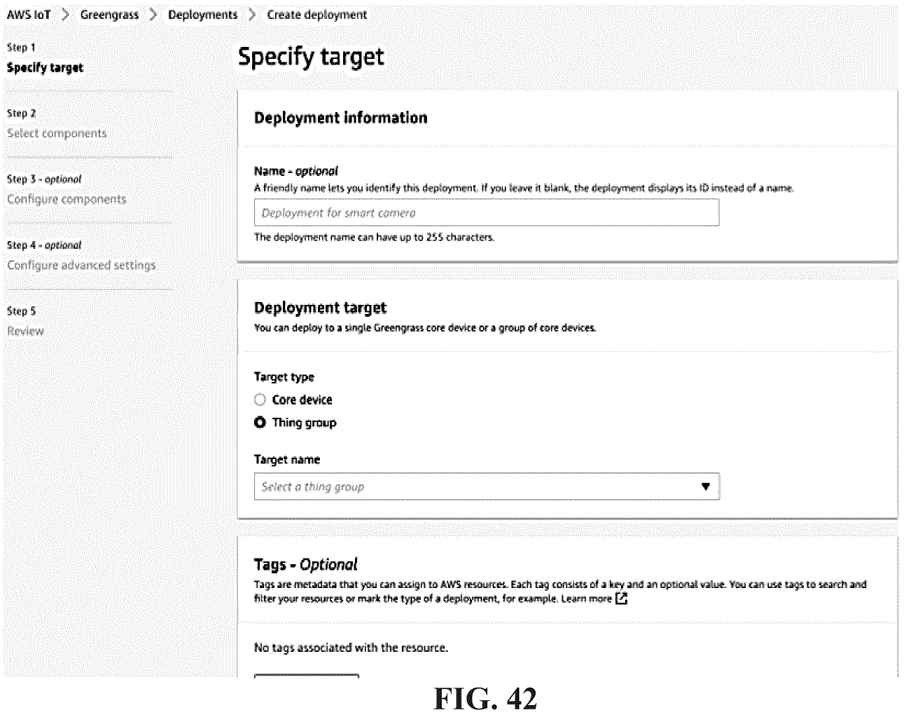

FIG. 42 illustrates a step 2 Greengrass deployment via a web interface according to some embodiments. In some embodiments, step 2 includes to specify a target group (select a group previously created).

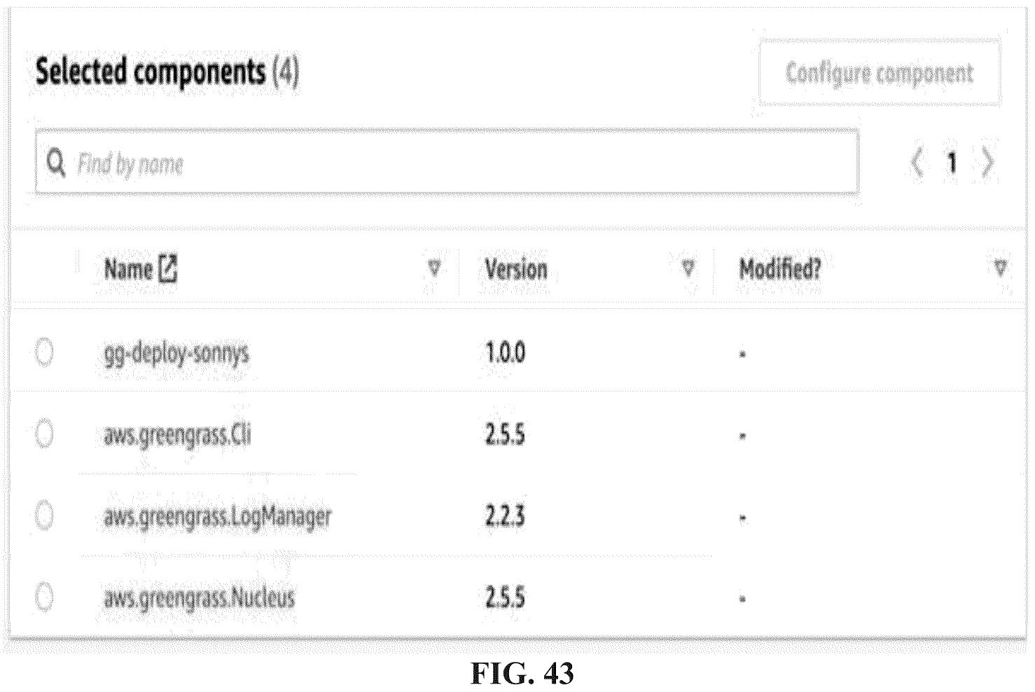

FIG. 43 shows step 3 Greengrass deployment via a web interface according to some embodiments. In some embodiments step 3 includes to select components such as those in the example including gg-deploy-sonnys, aws.greengras.Cli, aws.greengrass.LogManager, and aws.greengrass.Nucleus.

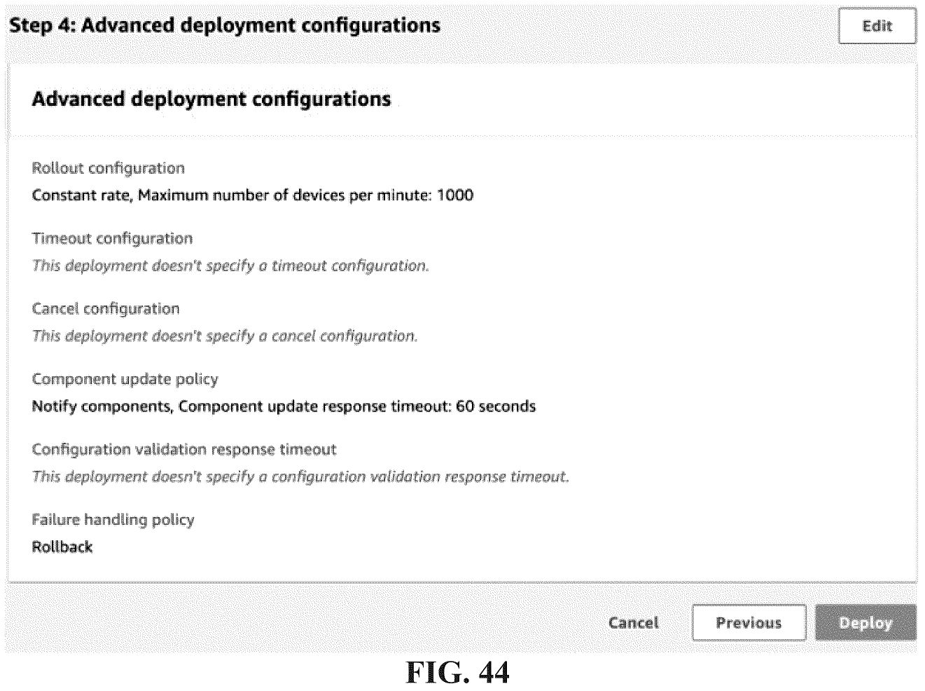

FIG. 44 demonstrates step 4 Greengrass deployment via a web interface according to some embodiments. In some embodiments step 4 includes going to the last step and click deploy.

FIG. 45 portrays the deployments page in a Greengrass docker and the starting point for revising a Greengrass deployment according to some embodiments.

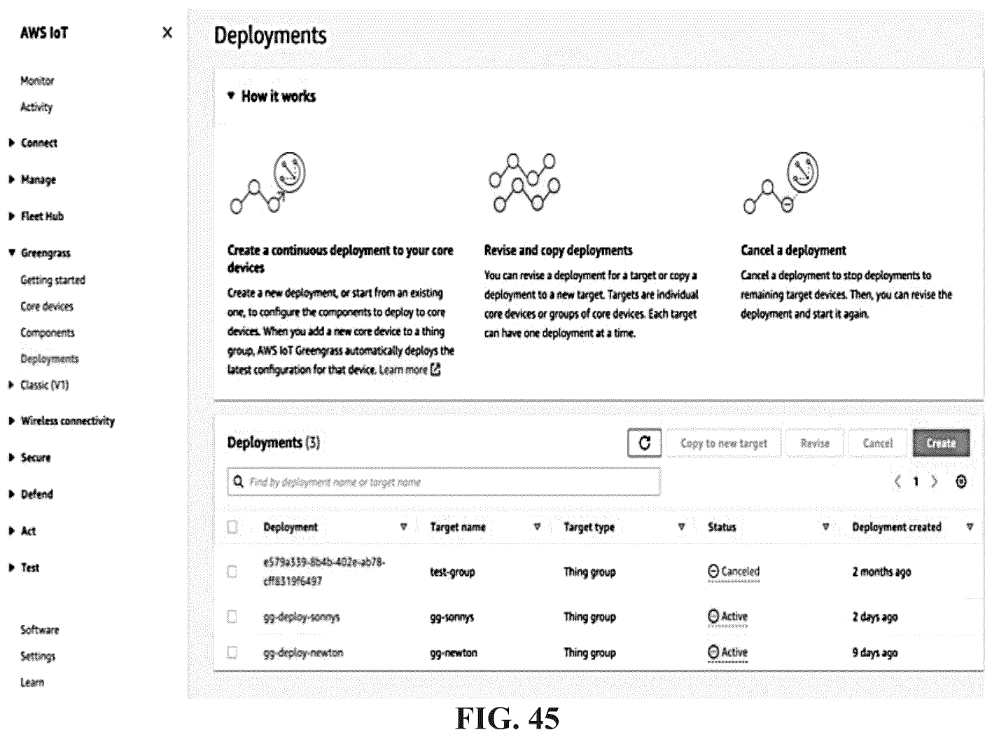

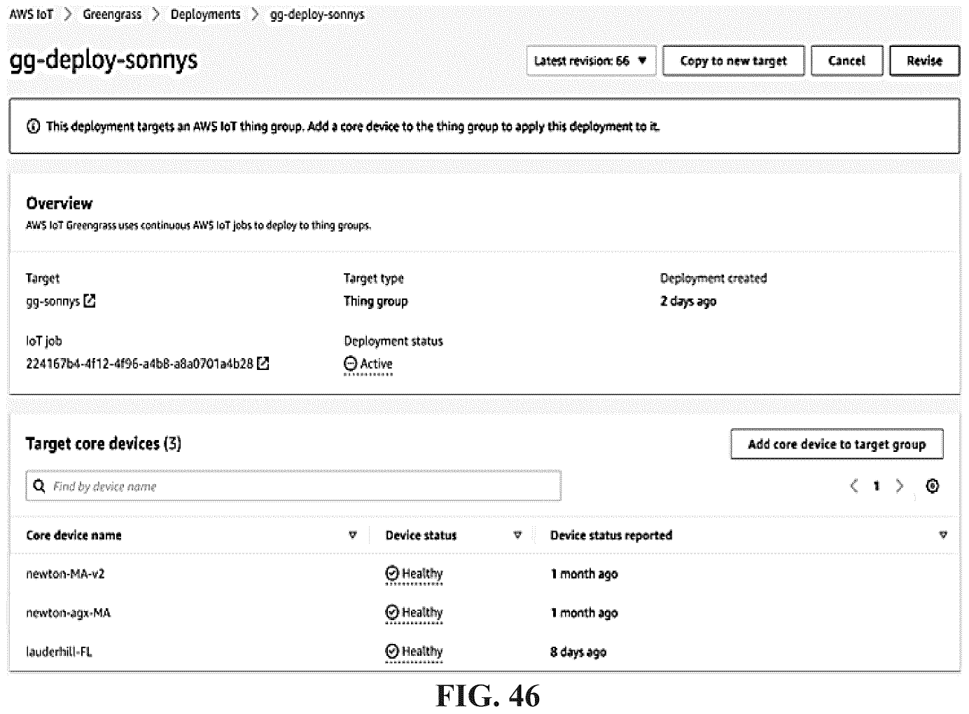

FIG. 46 depicts step 1 of revising a Greengrass deployment according to some embodiments. In some embodiments, after restarting a Greengrass docker, the Greengrass deployment needs to be revised to activate cloudwatch. In some embodiments, step 1 includes, within the deployments page, selecting from the list the last deployment done on the thing group and clicking revise.

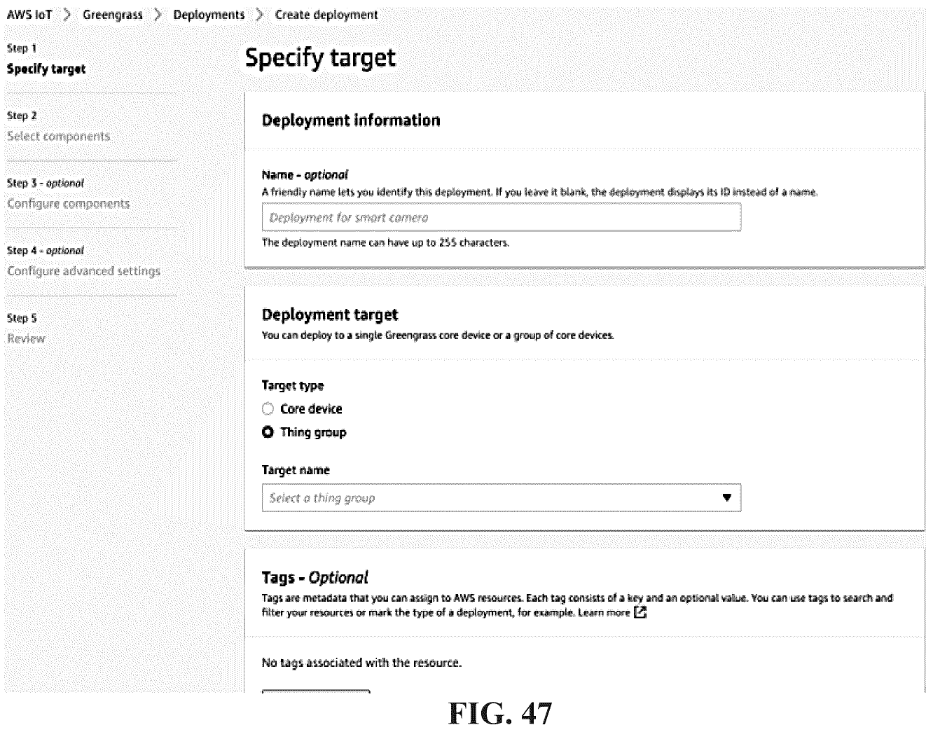

FIG. 47 exhibits step 2 of revising a Greengrass deployment according to some embodiments. In some embodiments, step 2 includes specifying a target group (select a group created previously).

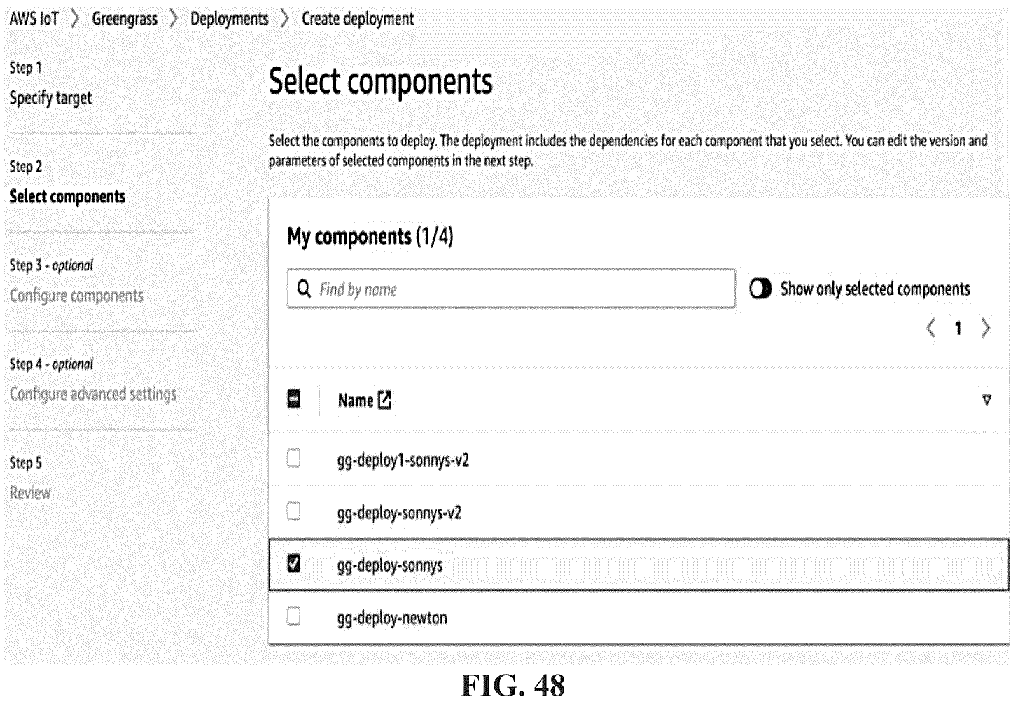

FIG. 48 displays step 3 of revising a Greengrass deployment according to some embodiments. In some embodiments, step 3 includes selecting the component, which in example testing location Lauderhill is gg-deploy-sonnys.

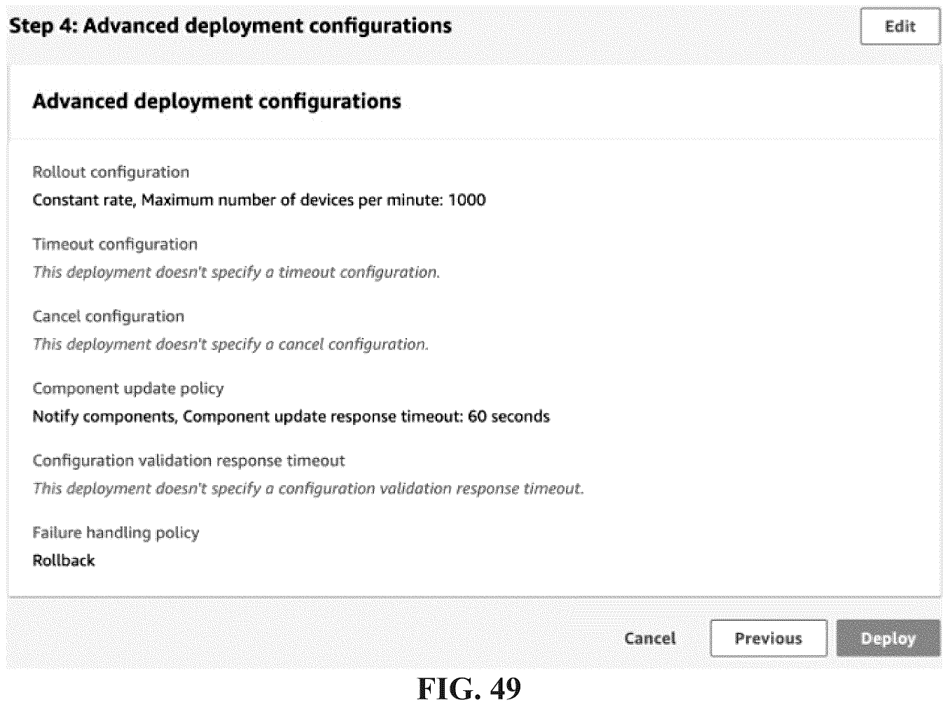

FIG. 49 illustrates step 4 of revising a Greengrass deployment according to some embodiments. In some embodiments step 4 is to go to the last step and click deploy.

In some embodiments, the application has built in error handling to restart automatically if any camera or environment issue happens, thus, it isn't necessary to manually restart the systems if there is a faulty camera or any other issue in the environment.

In some embodiments, to check one or more of a docker's status there are a series of steps including one or more of steps 1-2. In some embodiments, step 1 includes to open a terminal with sudo -i. In some embodiments, step 2 includes to execute docker ps (where 4 dockers should be should running along with edge manager service, if this is not the case, restart the dockers).

In some embodiments, to rebuild an edge-camsys docker there are a series of steps including one or more of steps 1-3. In some embodiments, step 1 of rebuilding the edge-camsys docker includes to open a terminal with sudo -i. In some embodiments, step 2 of rebuilding the edge-camsys docker includes to navigate to the build page. In some embodiments, step 3 of rebuilding the edge-camsys docker includes to run bash build.sh.

In some embodiments, to rebuild an edge-api docker there are a series of steps including one or more of steps 1-3. In some embodiments step 1 of rebuilding the edge-api docker includes to open a terminal with sudo -i. In some embodiments, step 2 of rebuilding the edge-api docker includes to navigate to the build page. In some embodiments, step 3 of rebuilding the edge-api docker includes to run bash build.sh.

In some embodiments, an edge-nginx docker and an edge-redis docker include “off the shelf” dockers so they don't need to be built or rebuilt.

In some embodiments, a modern, fast (high-performance), web framework for building APIs with Python 3.6 and later (e.g., FastAPI) is employed by the system. In some embodiments, the system includes an ASGI (Asynchronous Server Gateway Interface) server for Python web applications (e.g., Uvicorn). In some embodiments, Uvicorn serves as the web server that runs the FastAPI application. In some embodiments, a service based on FastApi+Uvicorn is included to one or more of provide a REST API to interact with a Modbus, to send logs and notifications to an AWS, to share data between different processes, and to give access to the general configuration data. In some embodiments, Uvicorn listens (only) on localhost for security reasons. In some embodiments, a high-performance web server, reverse proxy server, and load balancer (e.g., Nginx) is used to serve static content, manage traffic, and enhance the performance of web applications. In some embodiments, a reverse proxy is implemented via Nginx to serve external services such as a control PC.

In some embodiments, the system includes an interactive web interface (e.g., Swagger UI) for users to explore and test API endpoints. In some embodiments, a Swagger UI includes proper documentation to easily access the API. In some embodiments, to access the UI, a browser must be opened within a Nvidia Jetson. In some embodiments, the UI is configured to execute the function and send messages to the system. In some embodiments, the interface is configured for a vehicle wash operator to start/stop a conveyor and see the status of the system.

FIG. 50 shows a General Usage data and a System Control data within a FastAPI and Swagger UI according to some embodiments. In some embodiments, the system control is configured to activate and deactivate a Dry-Run mode.

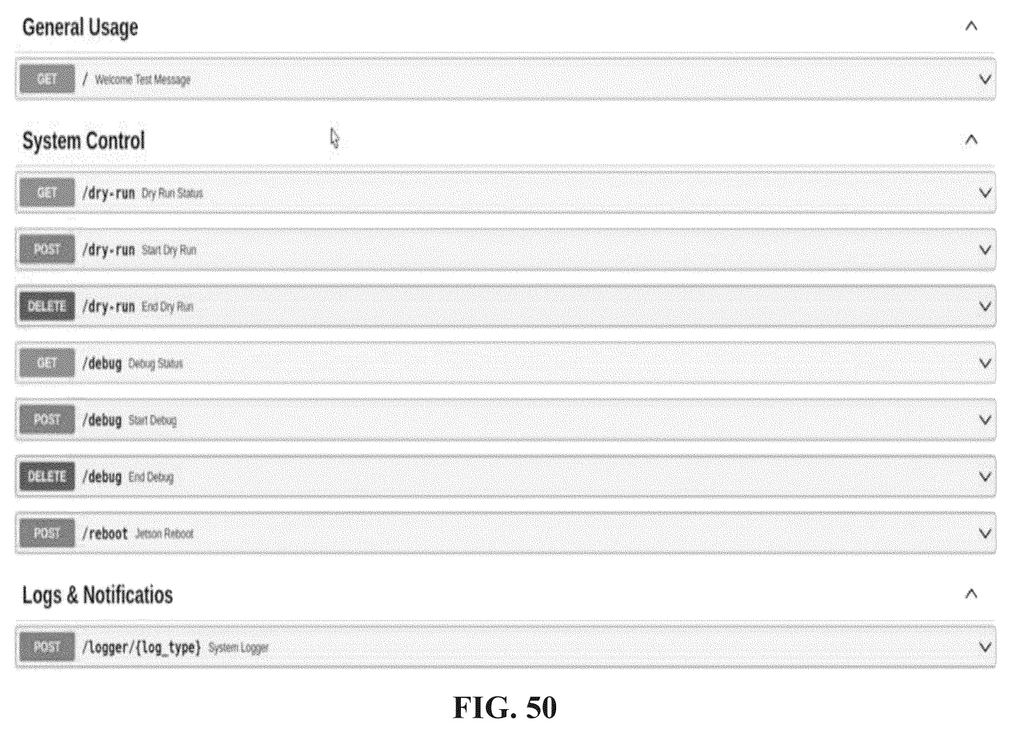

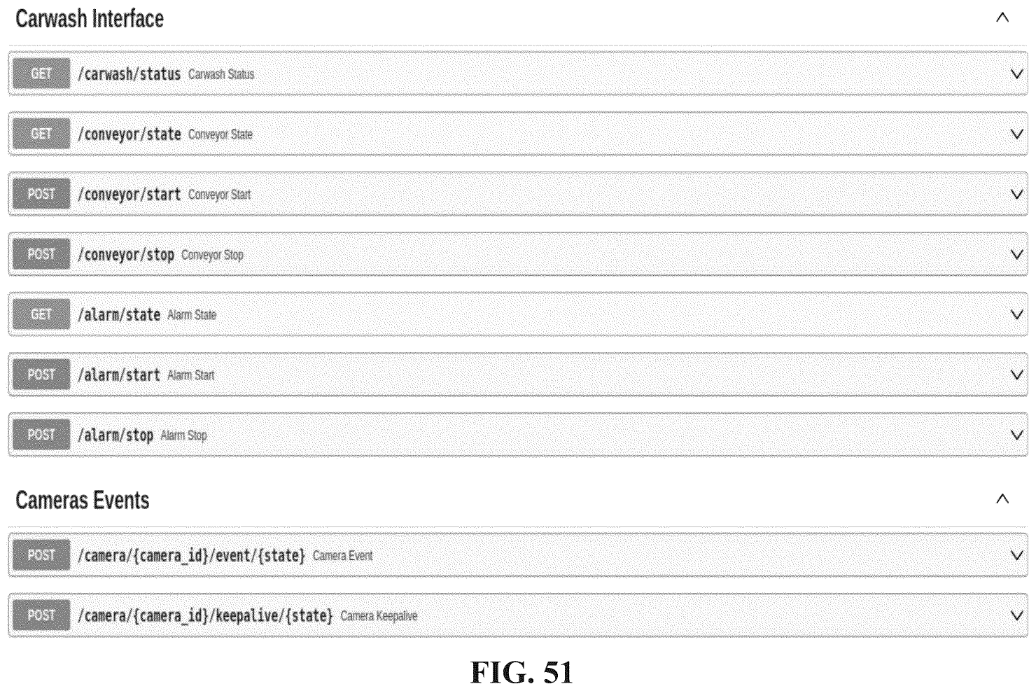

FIG. 51 demonstrates a Vehicle Wash Interface data and a Camera Events data within a FastAPI and Swagger UI according to some embodiments. In some embodiments, the vehicle wash interface is configured to manually control a conveyor and/or an alarm.

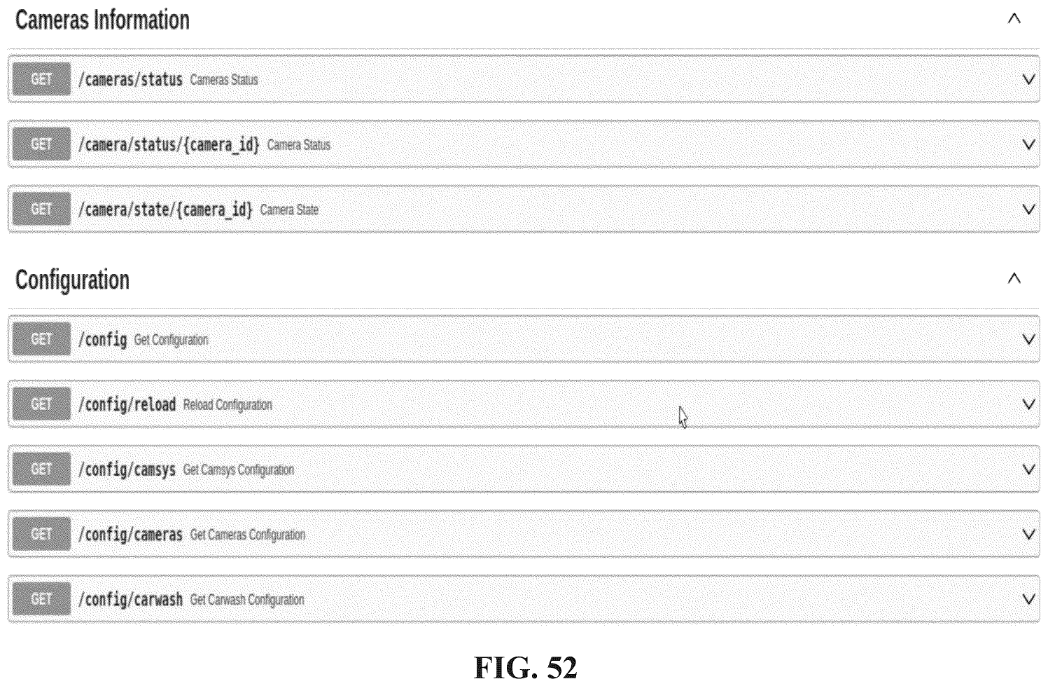

FIG. 52 portrays a Cameras Information data and a Configuration data within a FastAPI and Swagger UI according to some embodiments. In some embodiments, the configuration is configured to show config settings and/or reload configurations.

In some embodiments, the system includes a pre-built software package (image) that contains the operating system and essential software components required to run NVIDIA Jetson platforms, such as Jetson Nano, Jetson TX2, Jetson Xavier, and others (e.g., a Jetson image). This image is used to flash (install) the operating system and necessary libraries onto the Jetson device's storage. In some embodiments, to control a location remotely, a virtual network computer (VNC) tunnel is included inside a Jetson image. In some embodiments, the VNC server will need to be configured if a deployment of an Anti-Collision is done in a new location. In some embodiments, to access remotely, the system is configured to enable an install for VNC client and add the connection.

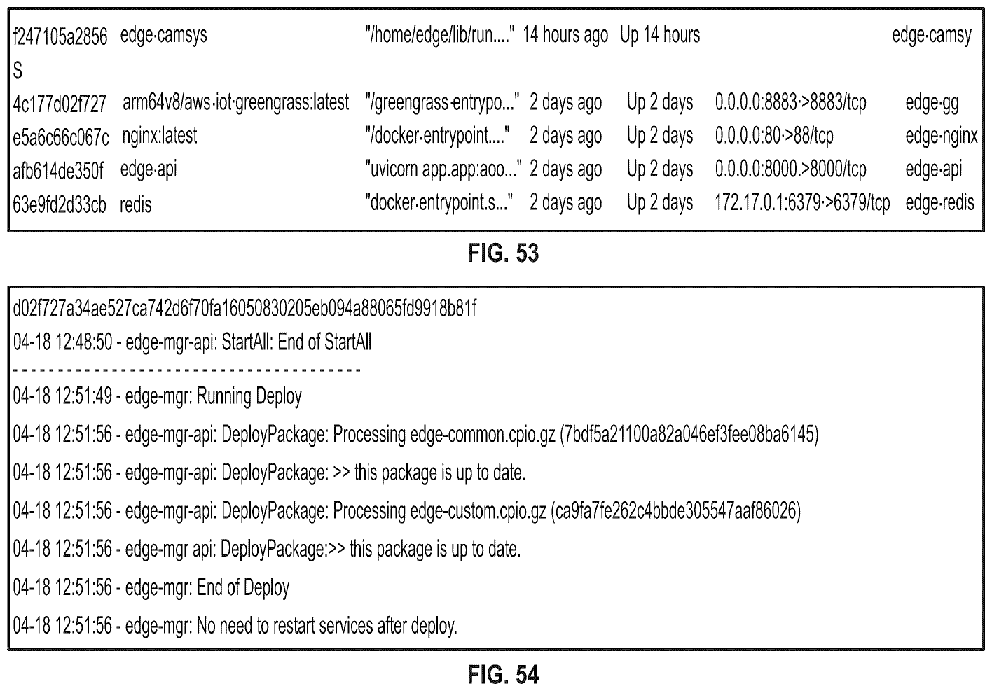

FIG. 53 depicts an example docker status according to some embodiments. In some embodiments, to check docker status there are a series of steps including one or more of steps 1-2. In some embodiments, step 1 includes to open a terminal with sudo -i. In some embodiments, step 2 includes to execute docker ps (where it should show 4 dockers running and an edge manager service). In some embodiments, the fifth column of the docker status represents the how long the docker has been active. In some embodiments, the last column of the docker status represents the docker name.

In some embodiments, there are one or more different log files to log the status of the different modules including edge-mgr, edge-camsys, and docker-watchdog, which are configured with logrotate, a tool designed to ease administration of systems that generate large numbers of log files.

FIG. 54 exhibits an example edge manager log according to some embodiments. In some embodiments the edge manager log contains information about Greengrass deployments. In some embodiments there are a series of steps to access the edge manager log including one or more of steps 1-3. In some embodiments, step 1 includes to open a new terminal with sudo -i. In some embodiments, step 2 includes to navigate to/home/edge/apps/mgr/log. In some embodiments, step 3 includes to tail -f edge-mgr.log.

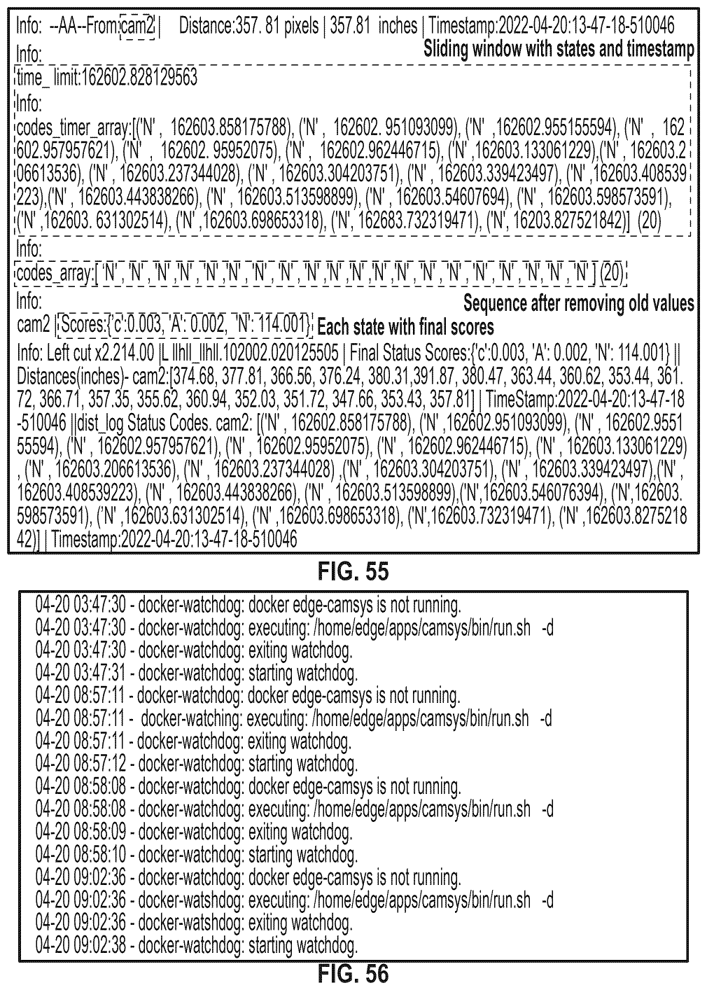

FIG. 55 displays a camera edge log (e.g., edge camsys log) according to some embodiments. In some embodiments the edge camsys log registers information related to the inference (distance, sliding window, states, etc.) every time a distance between two vehicles is measured. In some embodiments, the camera is identified along with a sliding window with states and timestamp, a sequence after old values are removed, and each state with final scores.

FIG. 56 illustrates an example docker watchdog according to some embodiments. In some embodiments, the docker watchdog contains information about docker status. In some embodiments to access the docker watchdog there are a series of steps including one or more of steps 1-3. In some embodiments, step 1 includes to open a terminal with sudo -i. In some embodiments, step 2 includes to navigate to/home/edge/apps/share/log. In some embodiments, step 3 includes to tail -f docker-watchdog.log.

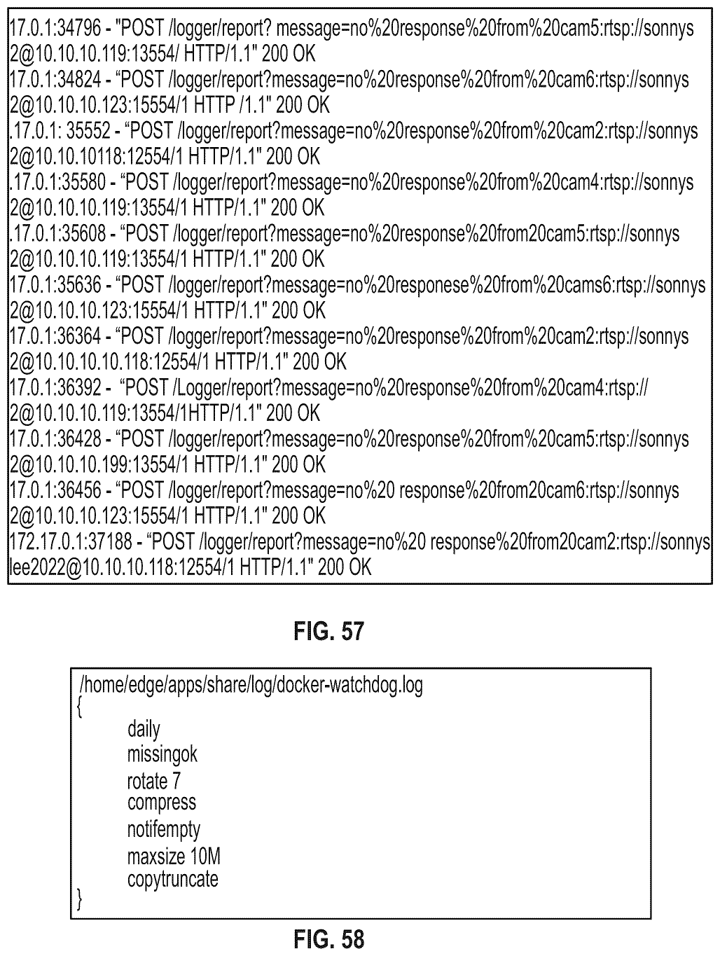

FIG. 57 shows an example Fast API Live log according to some embodiments. In some embodiments, the Fast API log contains information about all messages sent to an API. In some embodiments, the Fast API log is not stored on memory to avoid redundant logging (edge-camsys has the calls to a FastAPI too).

FIG. 58 demonstrates a non-limiting example rotation log (e.g., logrotate config) on a daily rotation according to some embodiments. In some embodiments, logrotate has been implemented for each file as a tool configured to ease administration of systems that generate large numbers of log files. In some embodiments, rotation log is configured for automatic rotation, compression, removal, and mailing of log files. In some embodiments, each log file is handled daily, weekly, monthly, and/or when it grows too large. In some embodiments, the system includes a monitoring and observability service (e.g., AWS Cloudwatch) that enables users to collect, analyze, and visualize operational data In some embodiments, AWS Cloudwatch is integrated to enable remote system monitoring. In some embodiments, every time the system has a change of state, a log is sent to Cloudwatch. In some embodiments, Cloudwatch is automatically enabled after a Greengrass deployment.

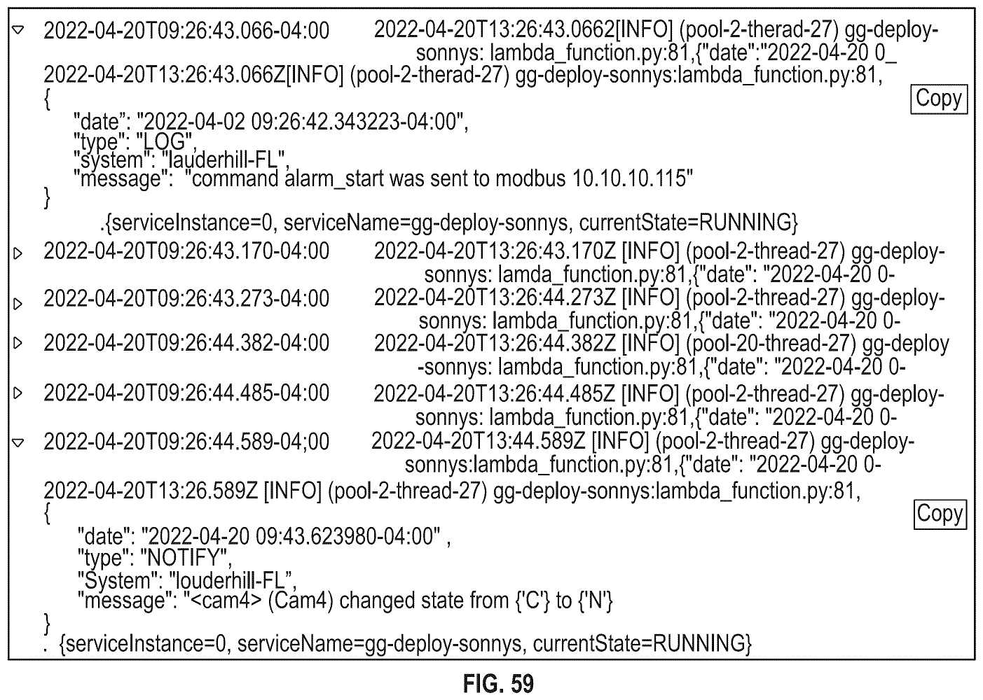

FIG. 59 portrays an example test log within Cloudwatch according to some embodiments. In some embodiments, to access Cloudwatch there are a series of steps including one or more of steps 1-3. In some embodiments, step 1 includes to access an AWS Management Console and search for the Cloudwatch service. In some embodiments, step 2 includes navigate through logs and then log group and look for the anti-collision-component. In some embodiments, step 3 includes to select the log stream to be analyzed (date and location). In some embodiments, one or more of the logs contains different information including change of status and messages sent to a Modbus. In some embodiments, see all notifications by typing “NOTIFY” on the search bar to filter.

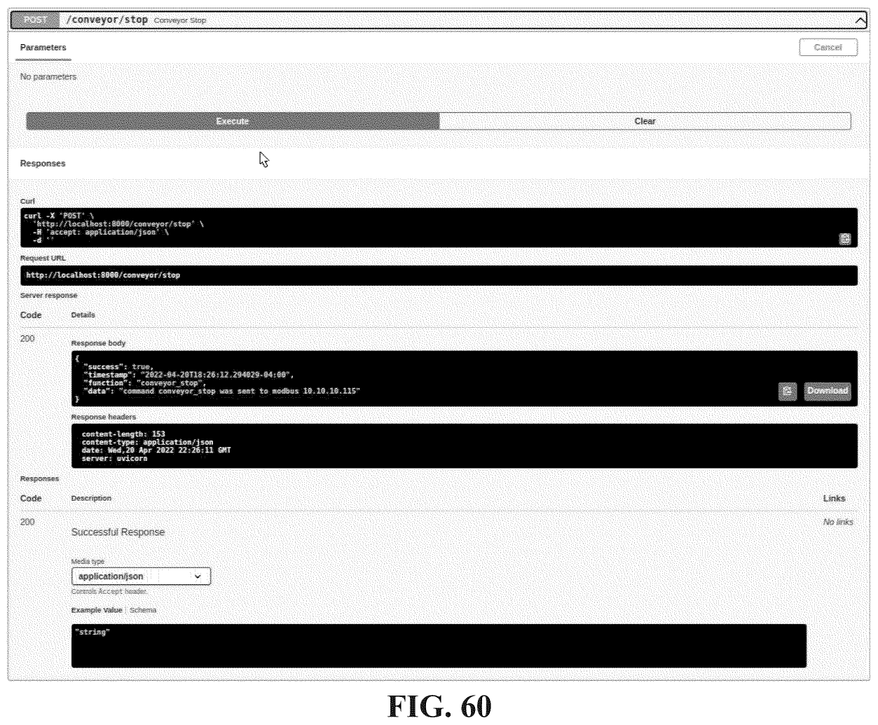

FIG. 60 depicts an example graphical user interface (GUI) display for stopping a conveyor according to some embodiments. In some embodiments, an execute button is configured to stop the conveyor. In some embodiments, a response body indicates whether the execution was successful.

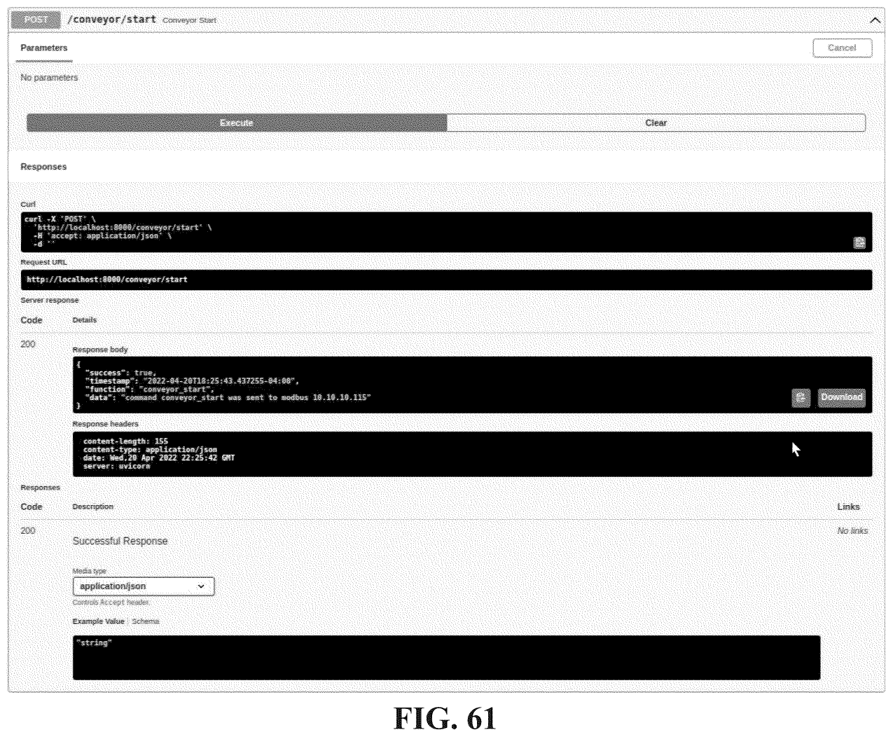

FIG. 61 exhibits an example GUI display for starting a conveyor according to some embodiments. In some embodiments, an execute button is configured to start the conveyor. In some embodiments, a response body indicates whether the execution was successful.

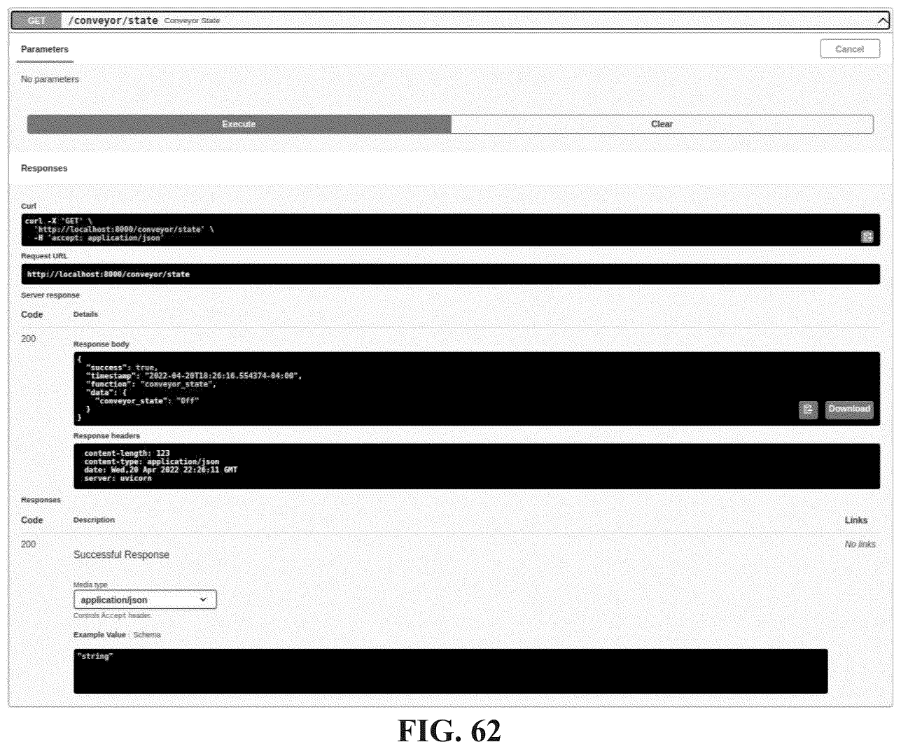

FIG. 62 displays an example GUI display for checking a conveyor state according to some embodiments. In some embodiments, an execute button is configured to check the conveyor state. In some embodiments, a response body indicates whether the execution was successful and the current conveyor state.

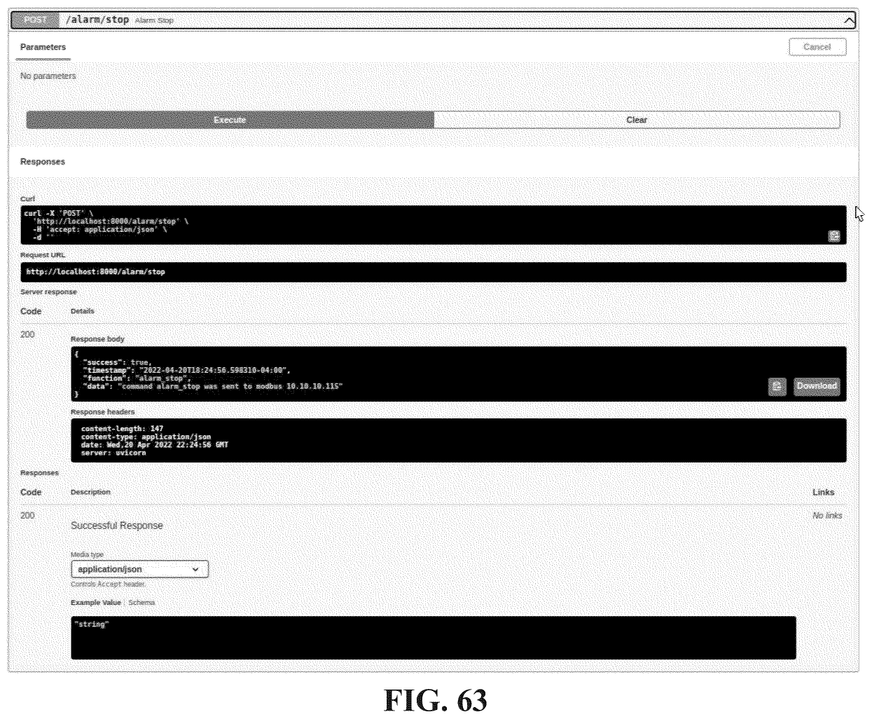

FIG. 63 illustrates an example GUI display for stopping an alarm according to some embodiments. In some embodiments, an execute button is configured to stop the alarm. In some embodiments, a response body indicates whether the execution was successful.

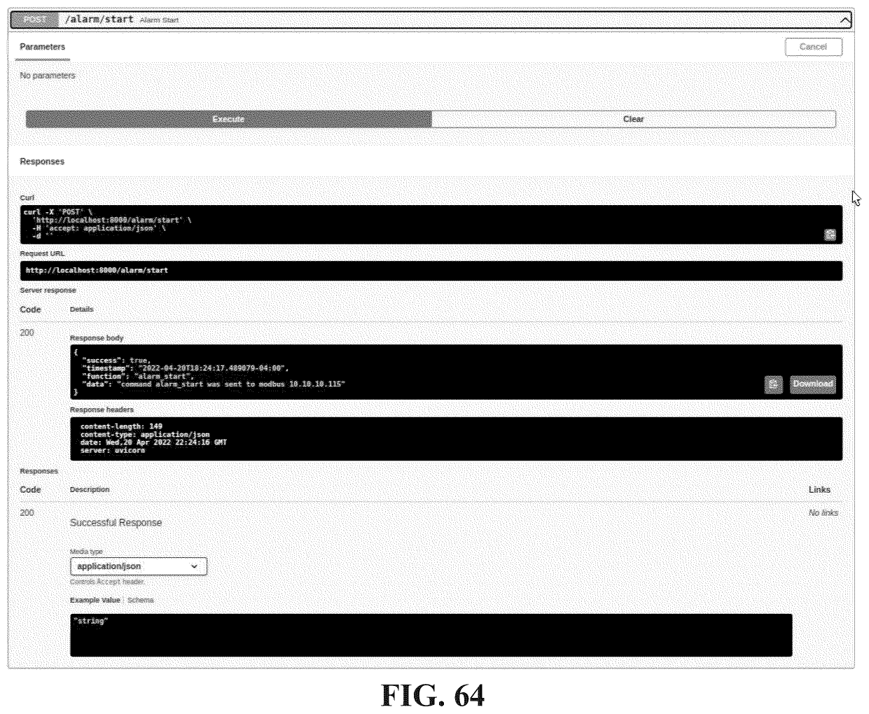

FIG. 64 shows an example GUI display for starting an alarm according to some embodiments. In some embodiments, an execute button is configured to start the alarm. In some embodiments, a response body indicates whether the execution was successful.

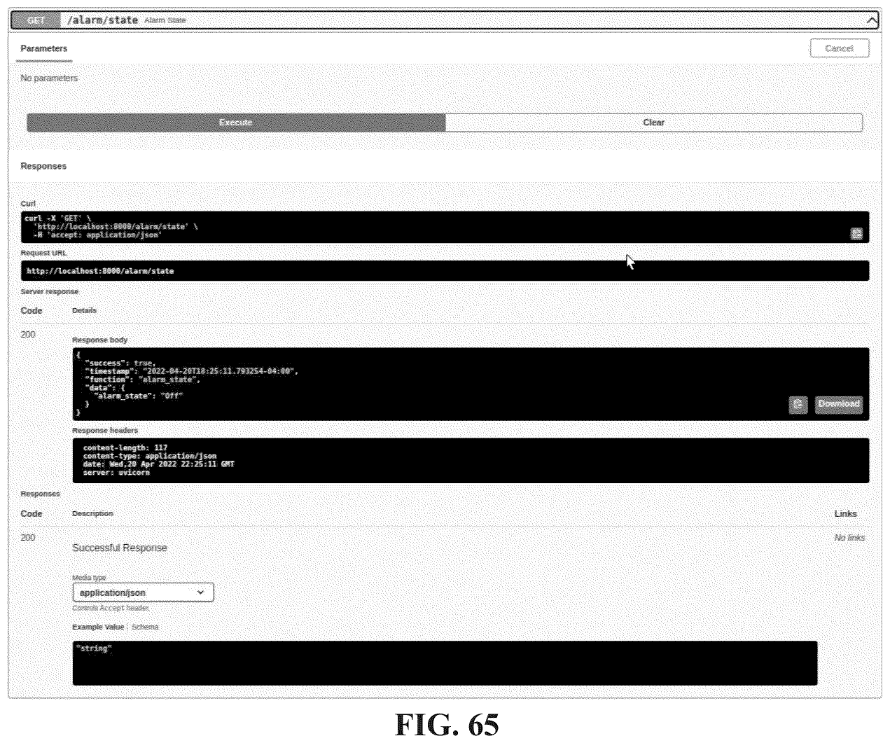

FIG. 65 demonstrates an example GUI display for checking an alarm state according to some embodiments. In some embodiments, an execute button is configured to check the alarm state. In some embodiments, a response body indicates whether the execution was successful and the current alarm state.

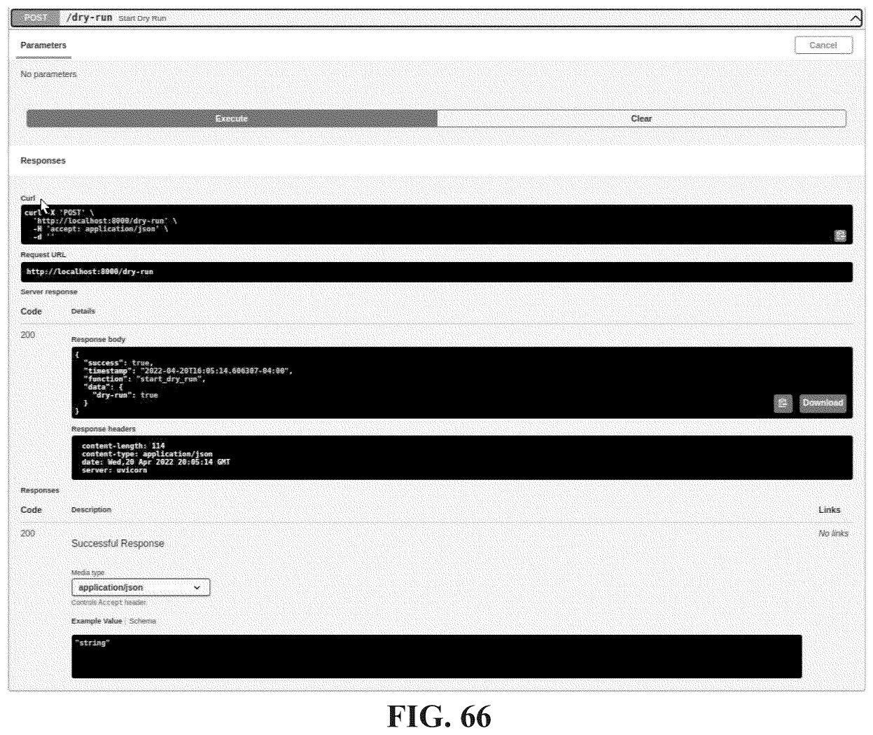

FIG. 66 portrays an example GUI display for enabling a dry-run according to some embodiments. In some embodiments, an execute button is configured to enable the dry-run. In some embodiments, a response body indicates whether the execution was successful and if the dry-run is enabled.

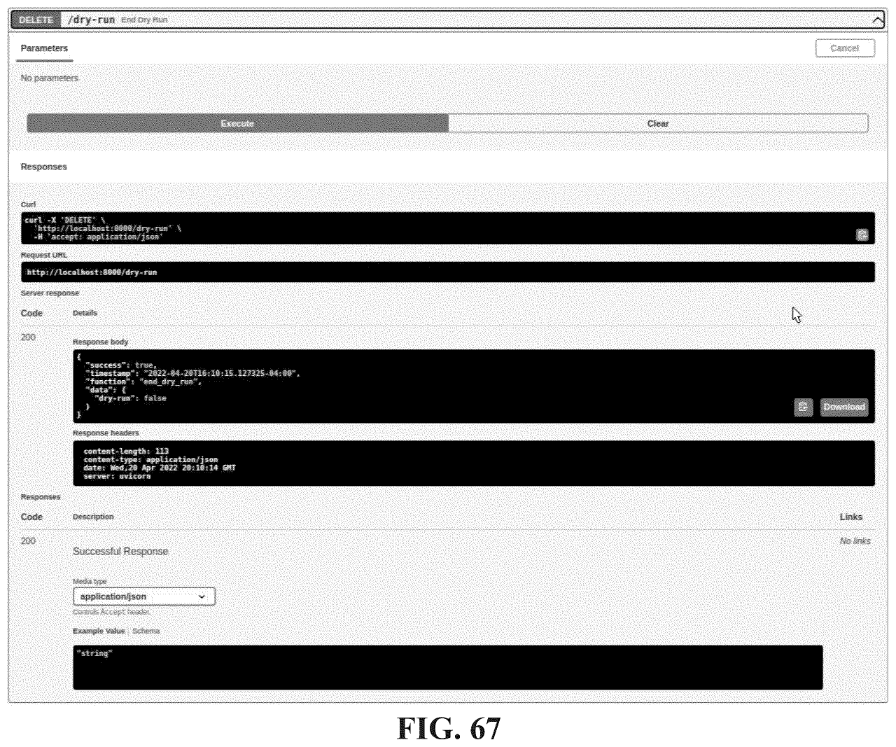

FIG. 67 depicts an example GUI display for disabling a dry-run according to some embodiments. In some embodiments, an execute button is configured to disable the dry-run. In some embodiments, a response body indicates whether the execution was successful and if the dry-run is enabled.

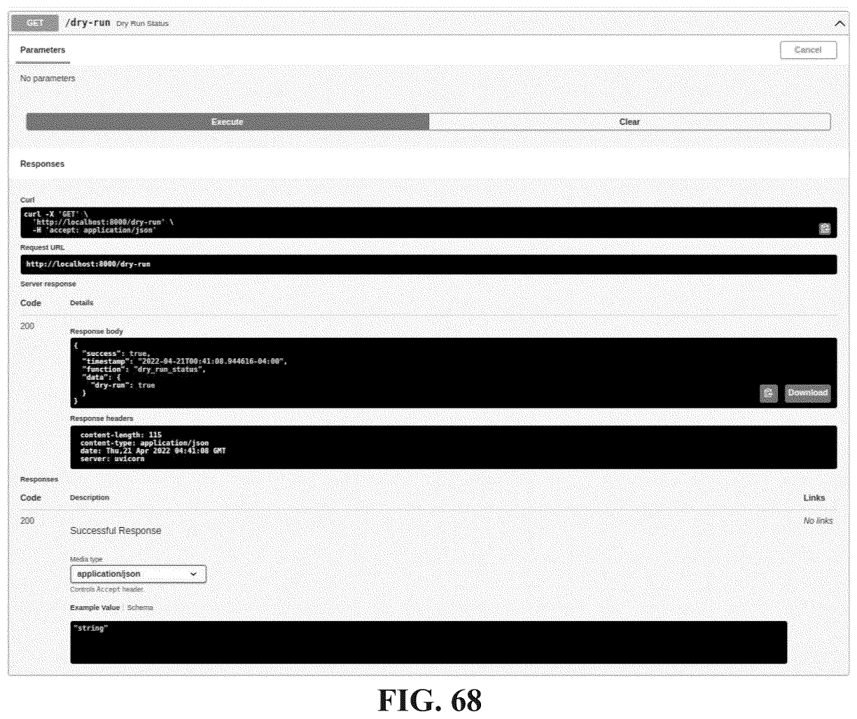

FIG. 68 exhibits an example GUI display for check a dry-run status according to some embodiments. In some embodiments, an execute button is configured to check the dry-run state. In some embodiments, a response body indicates whether the execution was successful and the dry-run state.

In some embodiments, a machine learning operations (MLOps) process is included where a user can gather new videos from vehicle wash locations, then label them for training purposes, and using the labeled data to re-train the model. In some embodiments, after the model has been trained, it can be deployed to all or select vehicle wash locations as described above. In some embodiments, Amazon Sagemaker, an Amazon service that provides a single, web-based interface where ML development and ML operations are performed, is a suitable non-limiting ML model example. In some embodiments, the system includes a service (e.g., Amazon SageMaker) that provides tools to build, train, and deploy machine learning (ML) models at scale.

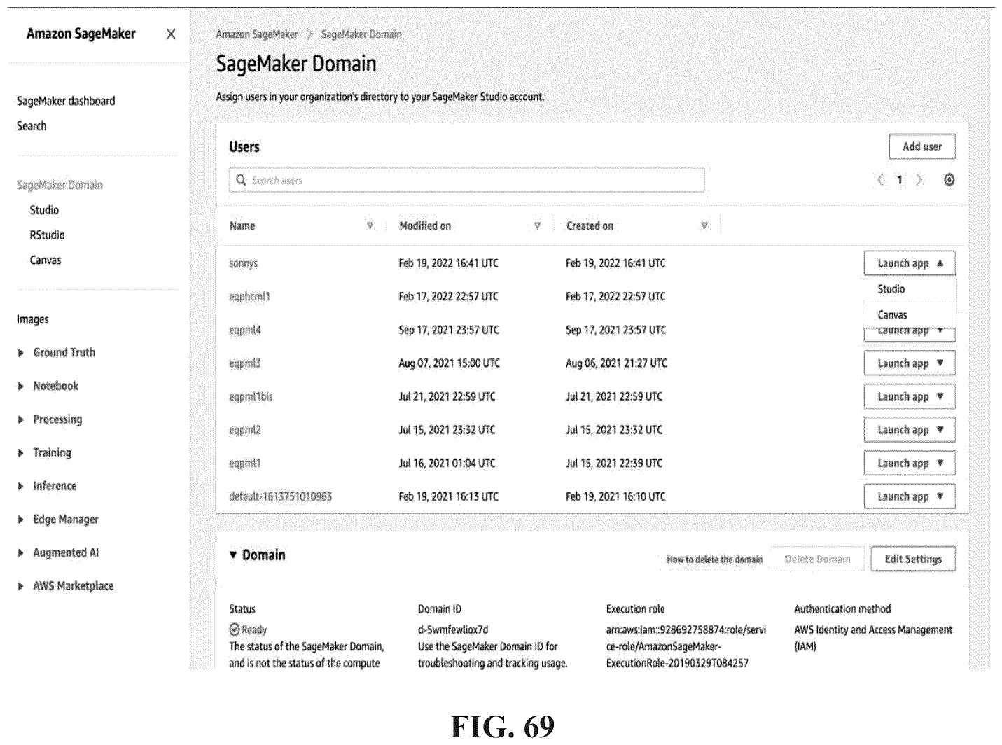

FIG. 69 displays an Amazon SageMaker Domain page according to some embodiments. In some embodiments, to access the Amazon SageMaker Studio there are a series of steps including one or more of steps 1-4. In some embodiments, step 1 includes to access an AWS Management Console (whose credentials will be provided by email). In some embodiments, step 2 includes to access the Amazon SageMaker Studio. In some embodiments, step 3 includes to look for the appropriate user under the name column on the SageMaker Domain page. In some embodiments, step 4 includes to launch studio. In some embodiments, it will take some time for the SageMaker Studio to launch as it needs to initiate a CPU instance and a GPU instance.

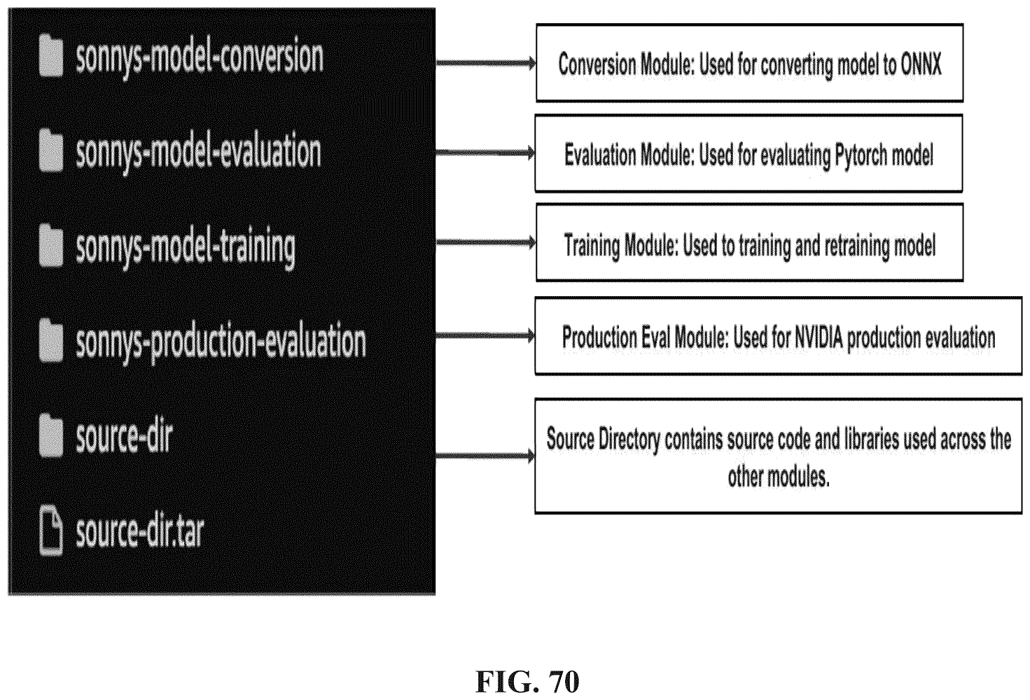

FIG. 70 illustrates one or more modules executed by the system (e.g., within a Jupyter Lab) according to some embodiments. In some embodiments, each module includes an arrow pointing to a description of the module from a file location. In some embodiments, each module corresponds to a different step of a machine learning process that form the system and methods described herein, from model training to model evaluation.

In some embodiments, before beginning a training, it is necessary to prepare the labeled data that will be used for the new training. In some embodiments, to run data-training- processing.ipynb there are a series of steps including one or more of steps. In some embodiments, step 1 includes to store the labeled date (JPEG and XMLs) folder named “labels” inside a new folder, which may be stored in pytorch-training/dataset in Amazon S3, as a non-limiting example. In some embodiments, step 2 includes to open the data-training-processing.ipynb source code and edit the prefix variable using the name of the folder created in step 1. In some embodiments, step 3 includes to run every cell, and this process creates a folder structure inside the S3 folder created in step 1. In some embodiments, this process divides the data into training, testing, and evaluation. In some embodiments, train data is labeled data to train the model, test data is labeled data to validate the training accuracy, and evaluation data is labeled data not used for training or validation to test the model inference/prediction actual accuracy. In some embodiments, step 4 includes to access Amazon S3 and check that the right structure was created. In some embodiments, a method includes using 85% of the labeled data for training, 5% for testing, and 1% for evaluation. In some embodiments, these parameters are modifiable in Cell 7 of the code.

In some embodiments, after running the data processing, the training process is run. In some embodiments, the training process is configured to create a Training Job in Amazon SageMaker, which creates checkpoints and a final outcome for the training. In some embodiments, there are a series of steps to run the training process including one or more steps. In some embodiments, step 1 includes to open a model-training.ipynb source code. In some embodiments, step 2 includes to run every cell: this process can take up to 8 hours depending on the amount of data. In some embodiments, step 3 includes seeing two outputs (Checkpoints and Trained model) after completion. In some embodiments, the model is output and provided with checkpoints. In some embodiments, a best practice for selecting a model includes to select the checkpoints that have the lower loss (the loss value is on the checkpoint name), run an evaluation for each model and based on the results, and/or pick the final model to use in production. In some embodiments, the system is configured to store all the trained models. In some embodiments, Amazon S3 stores the training set data used for training.

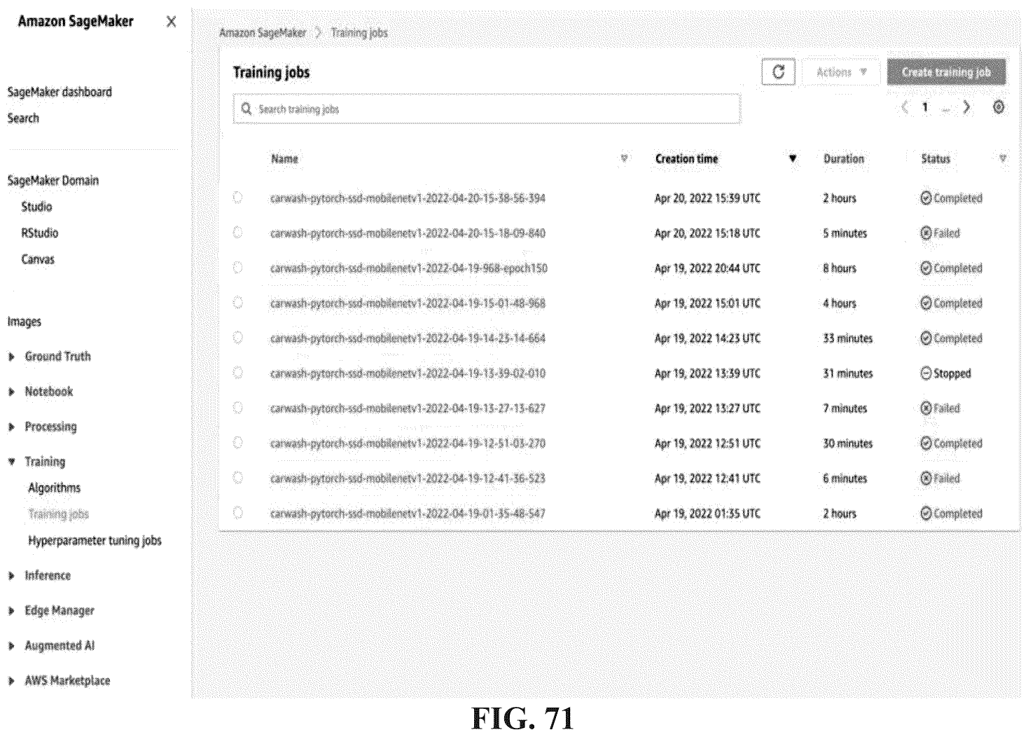

FIG. 71 shows inside a SageMaker Training Job according to some embodiments. In some embodiments, inside the SageMaker Training Job is information about a training job (including a running time, one or more of a log, a status, and one or more of an output). In some embodiments, the SageMaker training job is configured to track history and compare different training jobs.

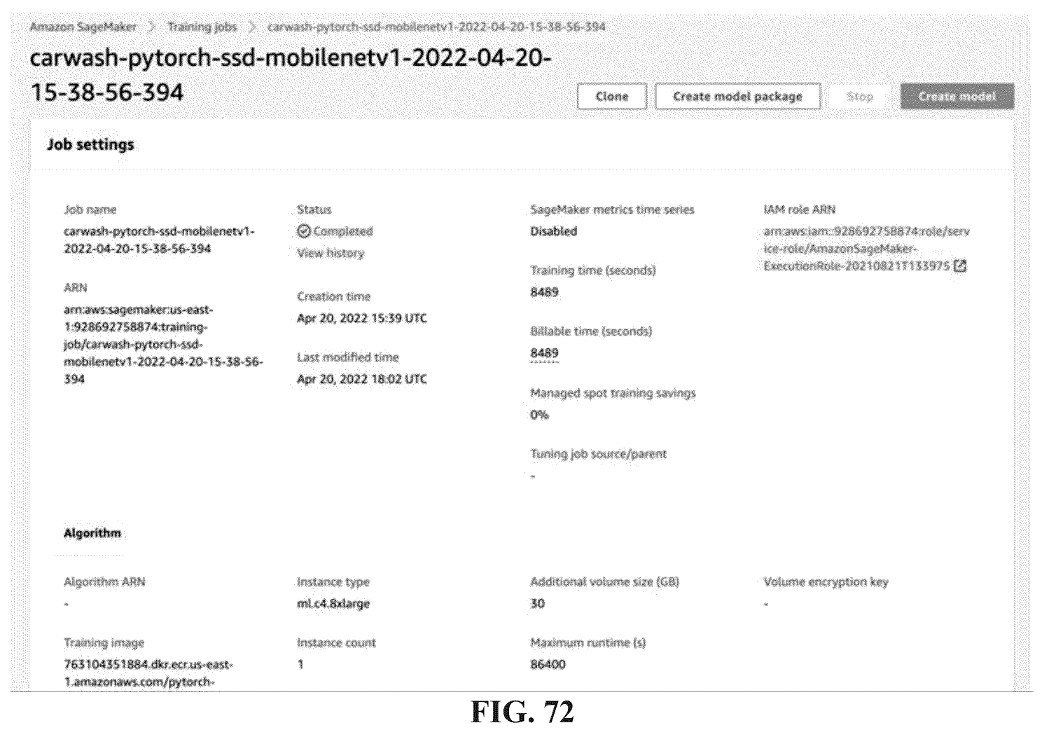

FIG. 72 demonstrates a job settings page for the first job listed in FIG. 65 according to some embodiments. In some embodiments, inside the SageMaker Training Job is information about a training job (including a running time, one or more of a log, a status, and one or more of an output). In some embodiments, an evaluation module is configured to evaluate a PyTorch model that was trained before. In some embodiments, before starting an evaluation, a set of data is prepared to use to evaluate a model. In some embodiments, a different set of labeled data from the one used for training is used otherwise the results will not be accurate. In some embodiments, there are a series of steps to run data-evaluation-processing.ipynb. In some embodiments, step 1 includes to store the labeled data (JPEG and XMLs) folder named “labels” inside a new folder stored in pytorch-training/dataset in Amazon S3. In some embodiments, step 2 includes to open a data-training-processing.ipynb source code and edit a test_data_root variable using the full path of the folder created before and a s3_model_path_prefix using the full path of the model to be evaluated. In some embodiments step 3 includes to run every cell, and this process creates a folder called data inside Jupyter with a structure including Annotations, ImageSets, JPEGImages, and labels.txt. In some embodiments, for evaluation, evaluation images reserved in the data processing for training (5% of the entire data set) are usable. In some embodiments, the images name that were reserved are stored in Amazon S3.

In some embodiments, after running the data processing, the evaluation process is run. In some embodiments the evaluation process evaluates a trained model with an evaluation data set provided in the data processing. In some embodiments, there are a series of steps to run the evaluation process. In some embodiments, step 1 includes to open a model-evaluation.ipynb source code. In some embodiments, step 2 includes to run every cell. In some embodiments, step 3 includes after completion, to see a mean Average Precision (mAP) value, which is the mean average precision for object detection. In some embodiments, mAP is used to evaluate object detection platform models. In some embodiments, the mAP compares a ground-truth bounding box to a detected box and returns a score. In some embodiments, the higher the score, the more accurate the model is in its detections.

In some embodiments, after a model is trained and selected to deploy in production, the model is converted to ONNX format. In some embodiments, there are a series of steps to convert the model to ONNX format. In some embodiments, step 1 includes to open a model-conversion.ipynb source code. In some embodiments, step 2 includes to download a desired.pth model to convert to SageMaker and store it. In some embodiments, if the last model evaluated or trained is the one being converted, the model will already be in a models folder. In some embodiments, step 3 includes to run every cell. In some embodiments, step 4 includes to check outputs.

In some embodiments, a production evaluation module is configured to evaluate an ONNX model that is deployed in production. In some embodiments, it has at least one module that runs on a Nvidia Jetson Development Environment and another that runs in SageMaker. In some embodiments, the goal of the process is to compare a set of labeled data (by humans) with the inference result produced by the model.

In some embodiments there are a series of steps to run a production evaluation in a Nvidia Jetson NJX development environment. In some embodiments step 1 includes to download a few videos inside a video_input folder. In some embodiments, step 2 includes to copy a model to evaluate inside a models folder. In some embodiments, step 3 includes to run a run.sh, which is a script that triggers the inference process. In some embodiments, the output includes a .csv with the result of the inference and images with raw frames of the video. In some embodiments, the data is used in SageMaker to evaluate the model.

In some embodiments, there are a series of steps to run a production evaluation in SageMaker. In some embodiments, step 1 includes to label a set of images for the same videos used in a production evaluation in Nvidia Jetson NJX and upload the labels to S3. In some embodiments, step 2 includes to upload the .csv on the Nvidia to a Production-inference-output folder. In some embodiments, step 3 includes to run all the cells. In some embodiments the output includes a mAP of the model.

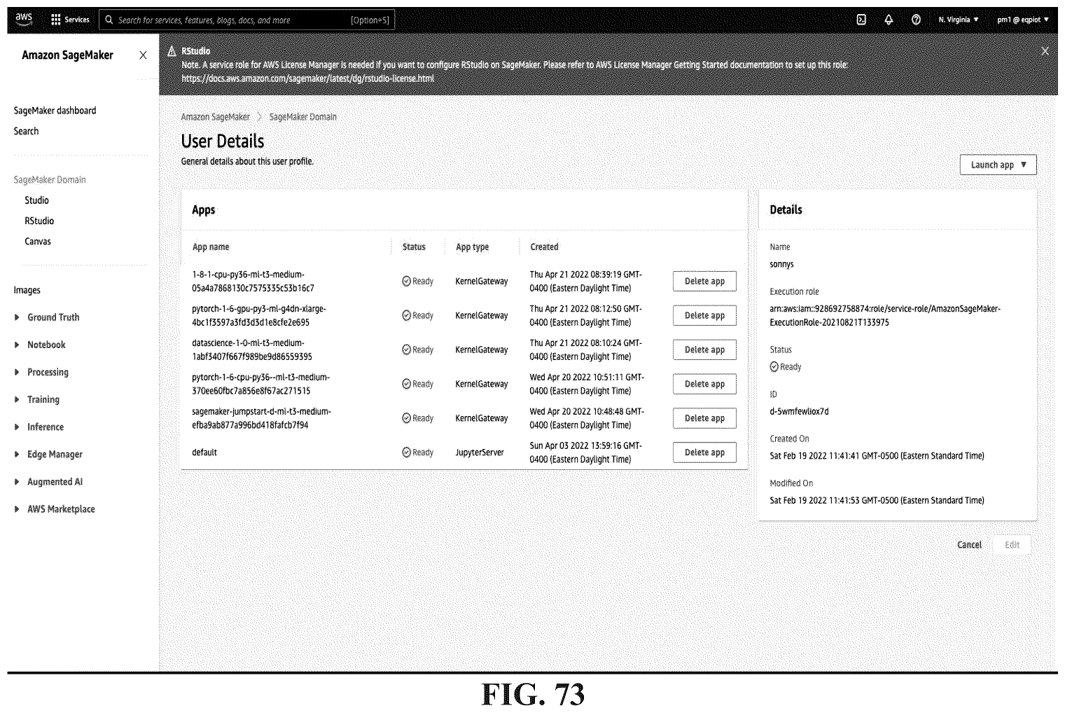

FIG. 73 portrays details about a user profile according to some embodiments.

In some embodiments, the system includes a graphical image annotation tool used to label and create bounding boxes for object detection and image classification datasets (e.g., LabelImg). In some embodiments, the recommended labeling tool includes a LabelImg tool. In some embodiments, the LabelImg tool includes an open-source tool developed in Python. In some embodiments, there are pre-requites for using LabelImg including Anaconda Distribution installation and downloading a Git repository.

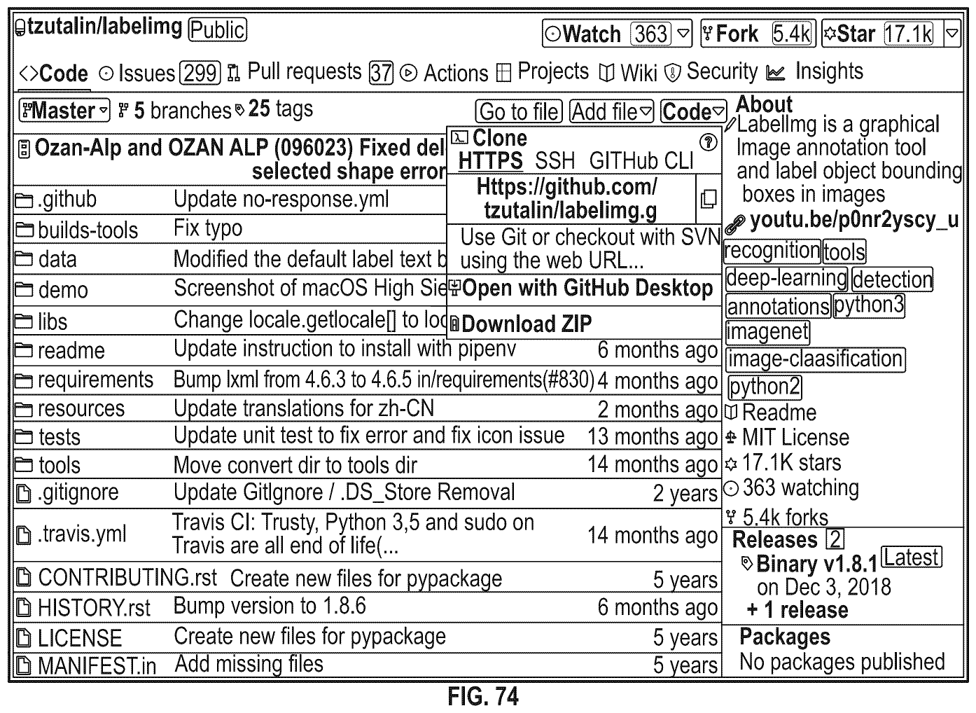

FIG. 74 depicts a GitHub repository download page according to some embodiments. In some embodiments, a LabelImg tool code is download from the GitHub repository downloading page by selecting a code button and clicking download zip.

In some embodiments, once a LabelImg tool is downloaded, it is necessary to navigate to the folder of the labelled image. In some embodiments, a command (pyrcc5) is typed to initiate a library inside the LabelImg tool. In some embodiments, run python with the python file by typing the command to execute. In some embodiments, after completed once, every following attempt to open the tool is accomplished by typing the command to execute.

In some embodiments, to start labeling, videos need to be download from a cloud-based storage (e.g., Amazon S3). In some embodiments, one or more videos are divided by cameras and are available inside Amazon S3. In some embodiments, information about a vehicle wash is used to choose videos that have many vehicles. In some embodiments, it is beneficial to select videos from different days and hours to have diverse situations to label. In some embodiments, there are a series of steps to download videos. In some embodiments, step 1 includes opening S3 and selecting the storage file. In some embodiments, step 2 includes selecting a video. In some embodiments, step 3 includes selecting a camera. In some embodiments, step 4 includes selecting a recording from the selected camera. In some embodiments, step 5 includes clicking download.

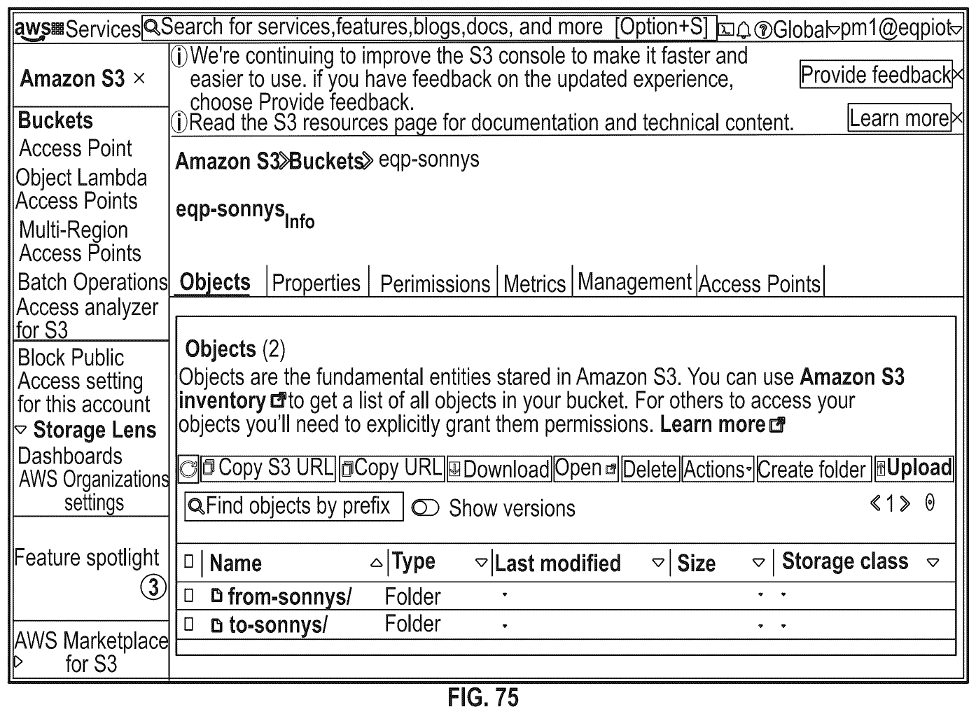

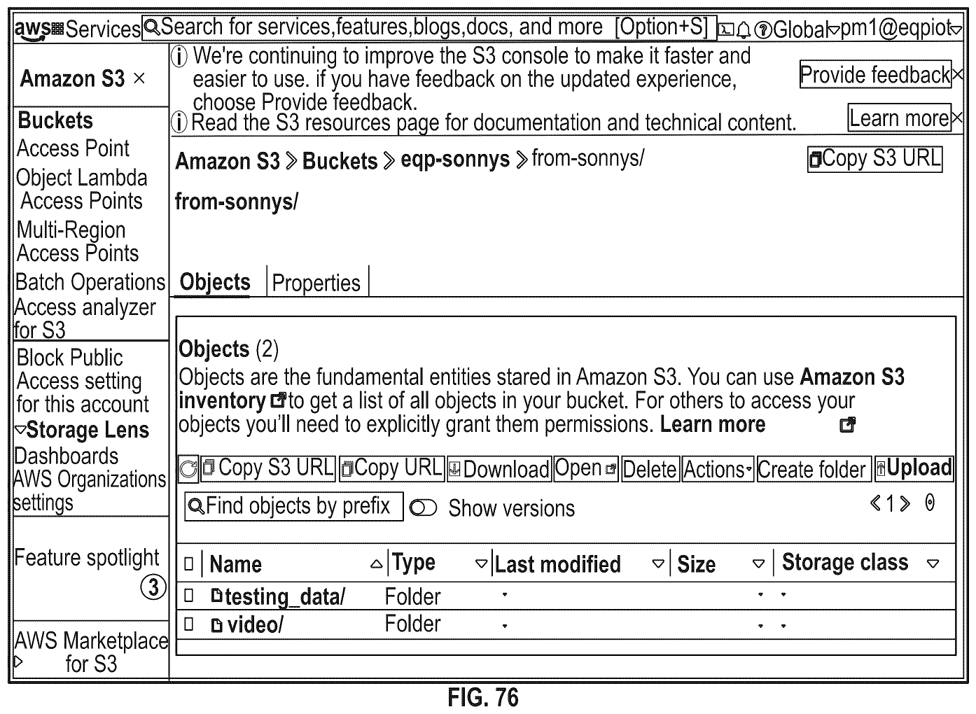

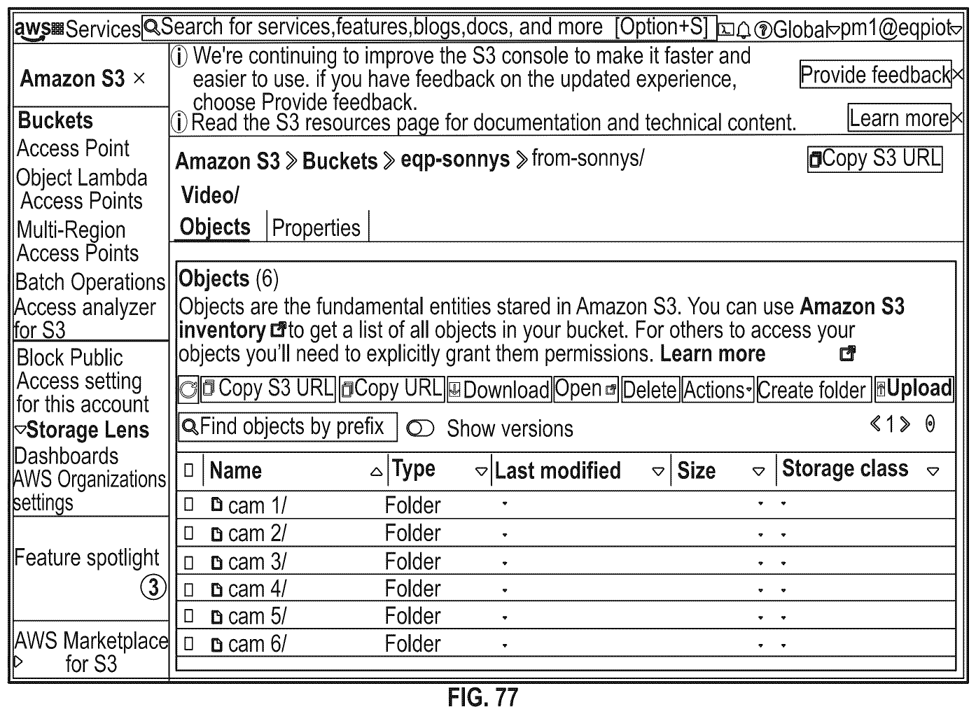

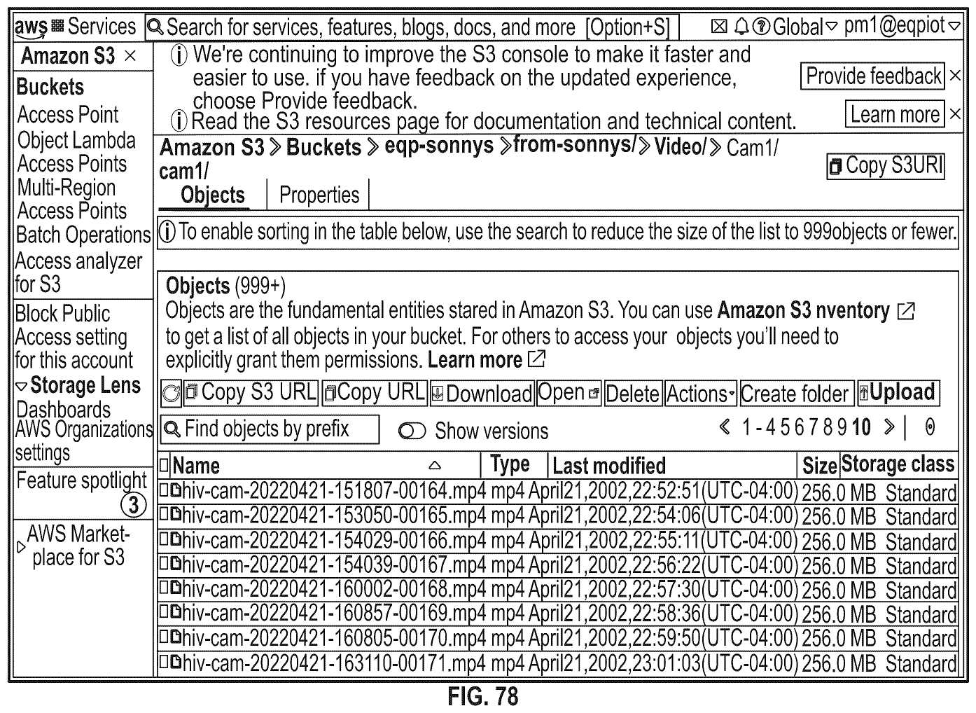

FIG. 75 exhibits step 1 of downloading a video for labelling according to some embodiments. In some embodiments, step 1 includes opening S3 and selecting the video. FIG. 76 displays step 2 of downloading a video for labelling according to some embodiments. In some embodiments, step 2 includes selecting video/. FIG. 77 illustrates step 3 of downloading a video for labelling according to some embodiments. In some embodiments, step 3 includes selecting a camera. FIG. 78 shows step 4 of downloading a video for labelling according to some embodiments. In some embodiments, step 4 includes selecting a recording from the selected camera.

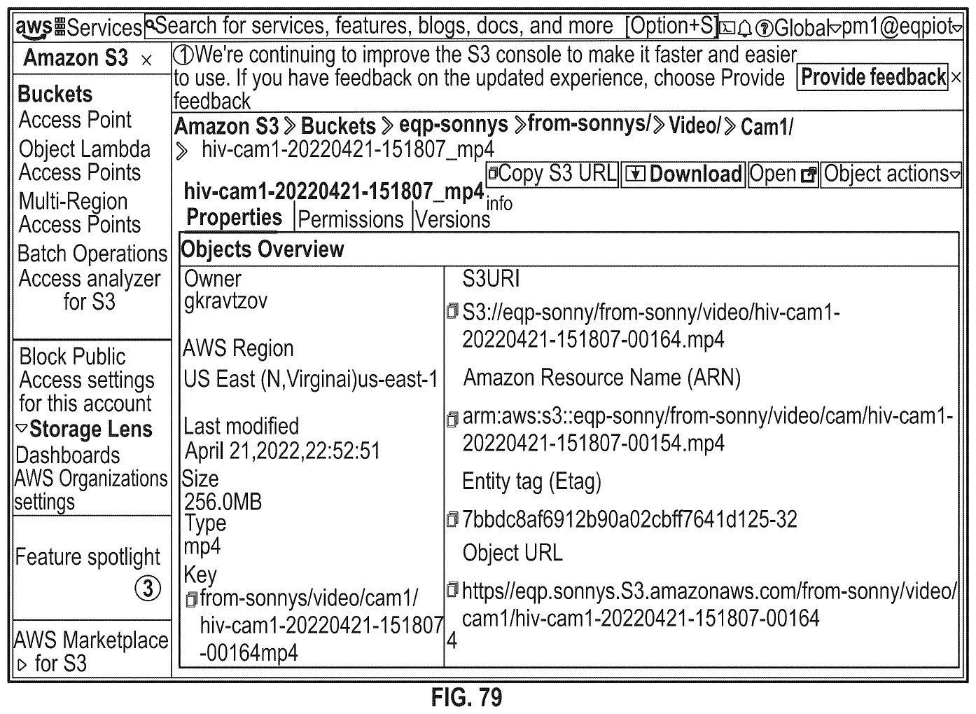

FIG. 79 demonstrates a video properties page from a video selected in FIG. 78 according to some embodiments. In some embodiments, to download the video, a user can click the download button in the top right of the screen. In some embodiments, it is recommended to copy the video to a desktop or to a folder.

In some embodiments, to label images, a video from FIG. 79 is divided in frames. In some embodiments, 1 frame per second is a suitable division to maintain image similarity. In some embodiments, the system includes a set of libraries and a command-line interface (e.g., FFMPEG) for applications that require complex media manipulation. In some embodiments, to divide the frames, a user can download FFMPEG, which is compatible with operating systems including Windows, Ubuntu, and Mac. In some embodiments, it is beneficial to create a folder for a camera from which the video was obtained and a folder for the video itself. In some embodiments, a step includes to divide the video into one frame per second. In some embodiments, the system enables viewing the sequence of frames.

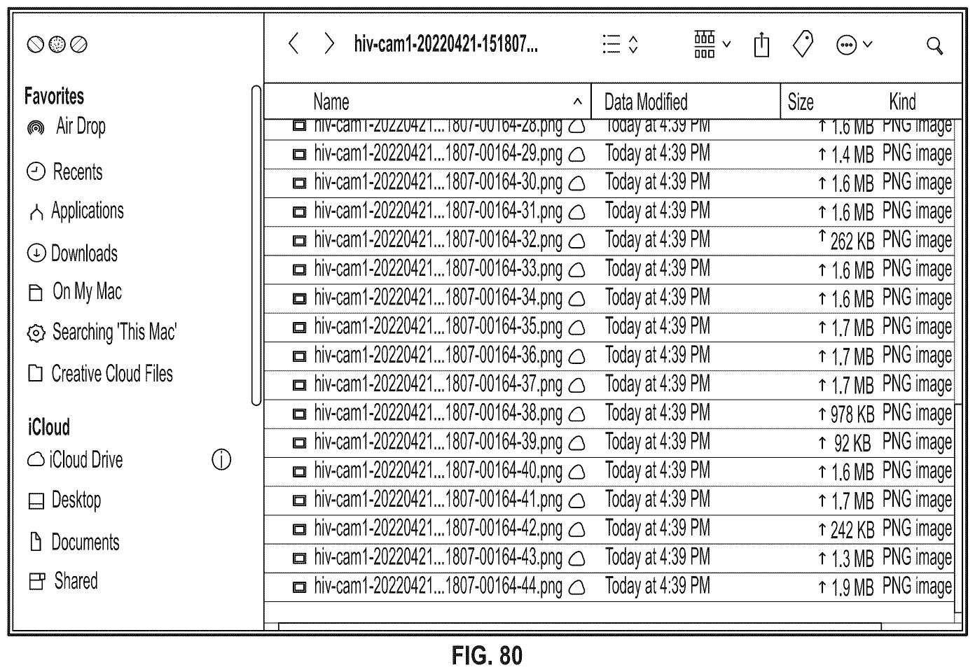

FIG. 80 portrays a folder of one or more of a frame from a video downloaded in FIG. 79 according to some embodiments. In some embodiments, each frame's name ends with a-# to indicate the number in the sequence of the video.

In some embodiments, once one or more of a frame is in a folder as indicated in FIG. 80, labeling begins. In some embodiments, there are a set of labels used including vehicle, backlight, frontlight, and/or people. In some embodiments, to open a LabelImg tool, click “Open Dir”, and select the photo frame. In some embodiments, a “Create RectBox” tool is selected, and the user drags the tool over the portion of the image it wants to label. In some embodiments, a label for the selection is typed in. In some embodiments, the limits of the selection should be as close to the actual labelled object as possible. In some embodiments, once each image has been labelled, it needs to be saved, which will create an XML. In some embodiments, similar images should not all be labelled.

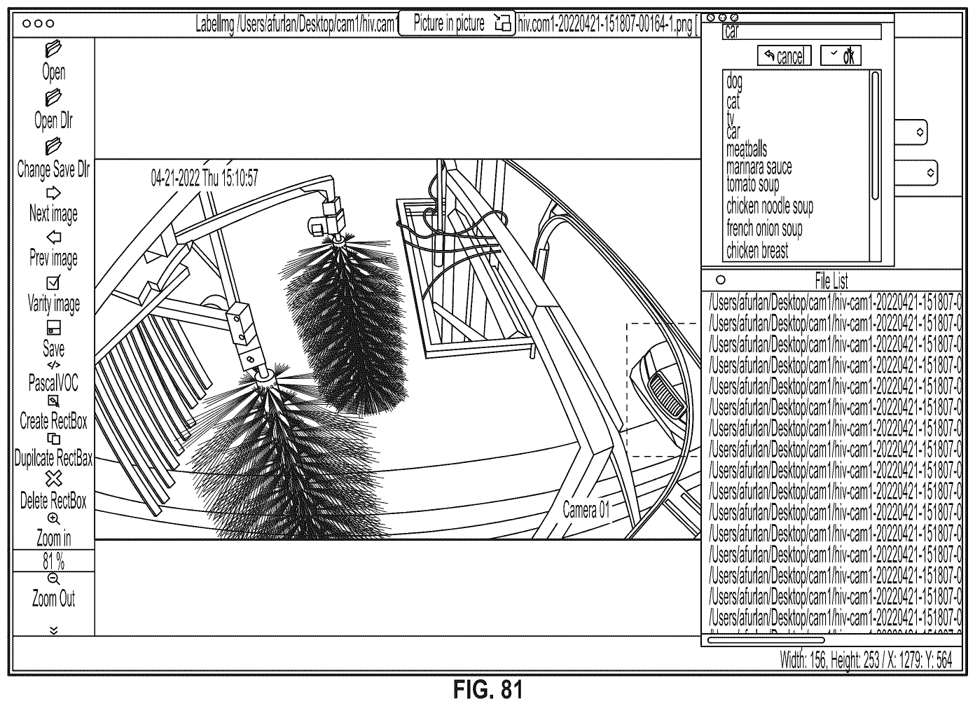

FIG. 81 depicts a selected vehicle from a frame from the folder in FIG. 80 according to some embodiments. In some embodiments, a box pops up to type in the desired label: for this selection it is a vehicle.

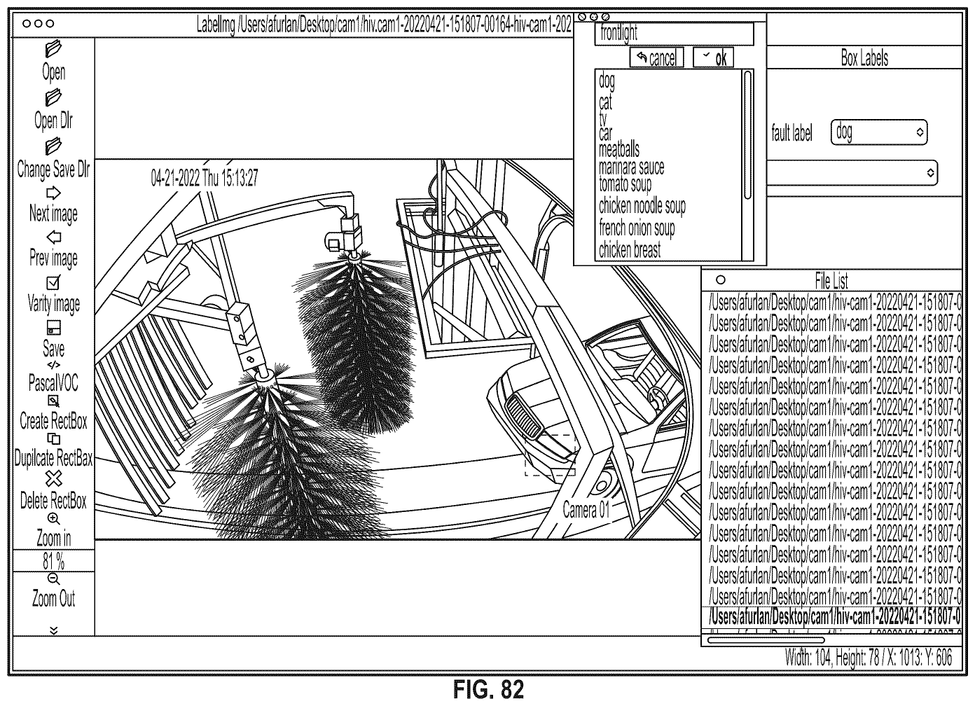

FIG. 82 exhibits a selected front light from a frame from the folder in FIG. 80 according to some embodiments.

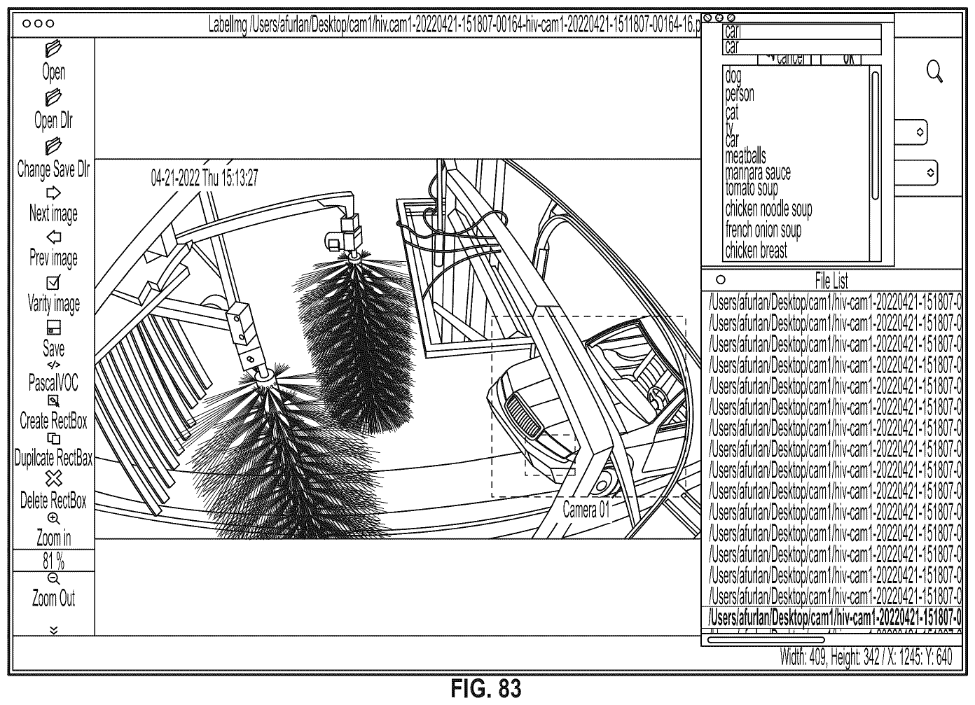

FIG. 83 displays a selected front light from FIG. 82 and a selected vehicle according to some embodiments.

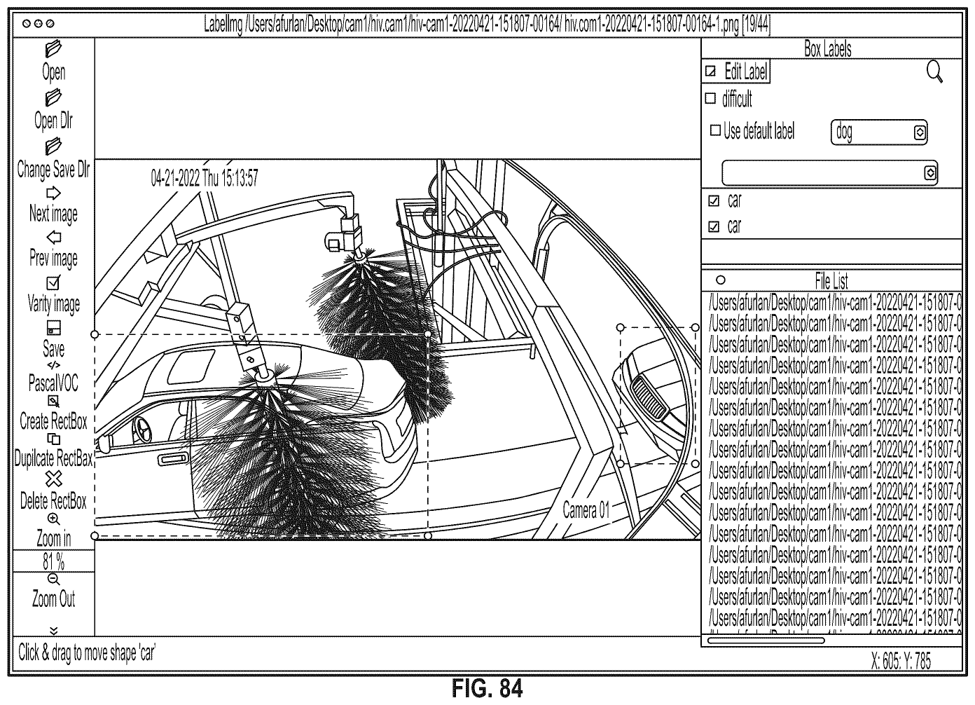

FIG. 84 illustrates a selected vehicle from a frame from the folder in FIG. 80 according to some embodiments.

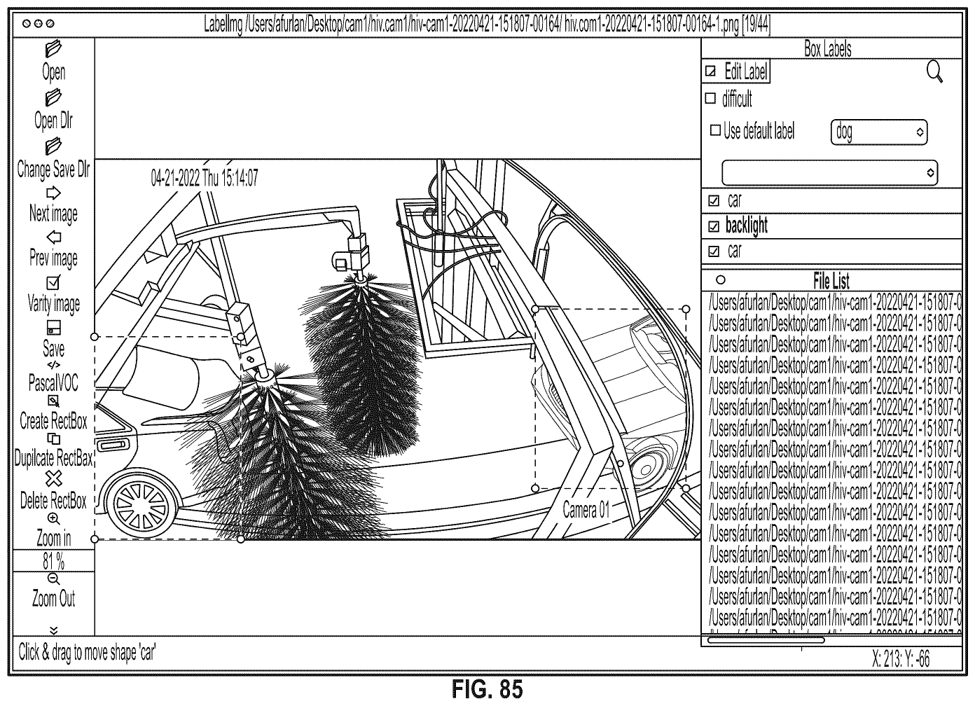

FIG. 85 shows selected vehicles and a selected back light from a frame from the folder in FIG. 80 according to some embodiments. In some embodiments, one or more of a labelled photo, when opened with TextEdit, will give the coordinates of each box and the label of said box.

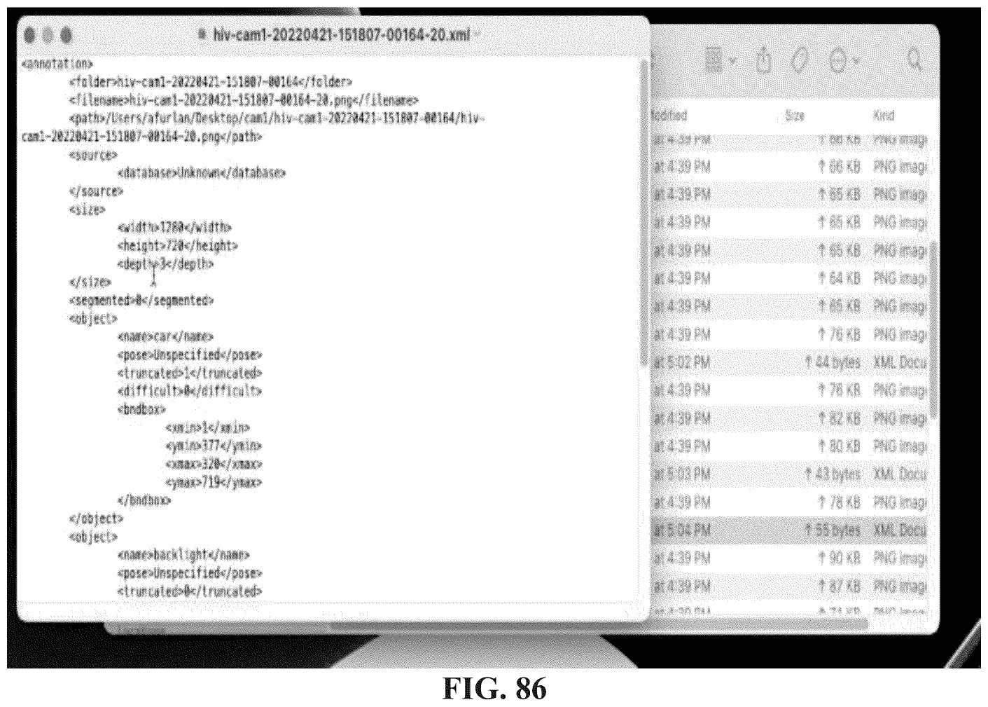

FIG. 86 demonstrates the data provided by opening a labelled photo with TextEdit according to some embodiments. In some embodiments, the opened photo will provide data including the coordinates of one or more of a box and a label for each box.

In some embodiments after all important frames are labelled, it is recommended to delete all images that don't have a corresponding labelled photo. In some embodiments, the remaining images can be uploaded to S3 through a series of steps including one or more of steps 1-6. In some embodiments, step 1 includes to enter S3 and select to-sonnys/. In some embodiments, step 2 includes to select the name of the location. In some embodiments, step 3 includes to click label-images/. In some embodiments, step 4 includes to select the camera from which the labelled photos came from. In some embodiments, there are annot#/ folders to track the uploaders. In some embodiments, step 5 includes to select an annot#/ folder. In some embodiments, step 6 includes to select upload and add the files.

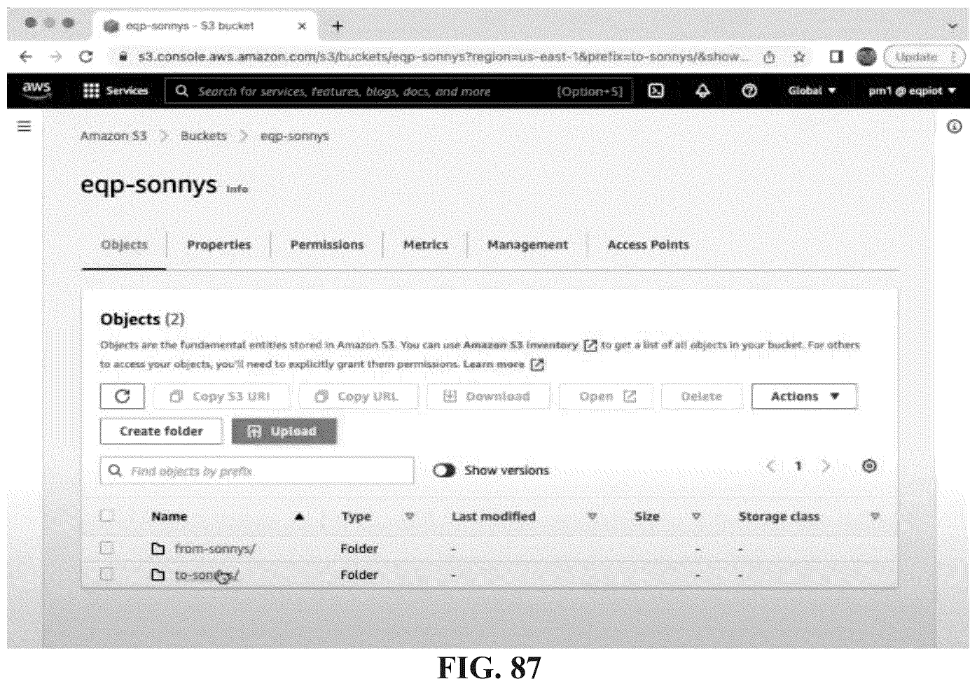

FIG. 87 portrays step 1 of uploading a labelled photo according to some embodiments. In some embodiments, step 1 includes to enter S3 and select to-sonnys/.

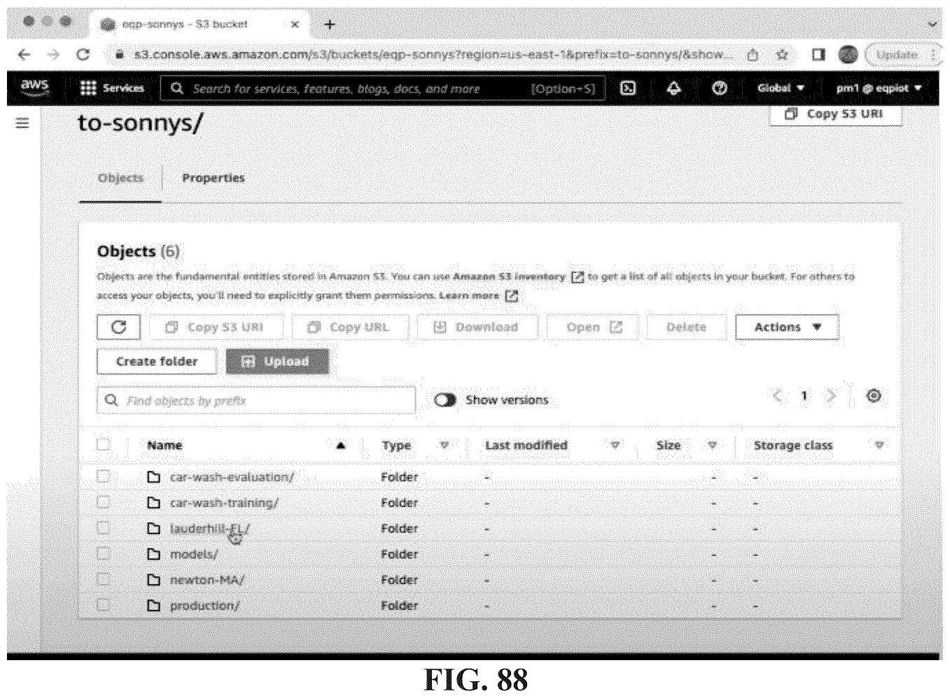

FIG. 88 depicts step 2 of uploading a labelled photo according to some embodiments. In some embodiments, step 2 includes to select the name of the location.

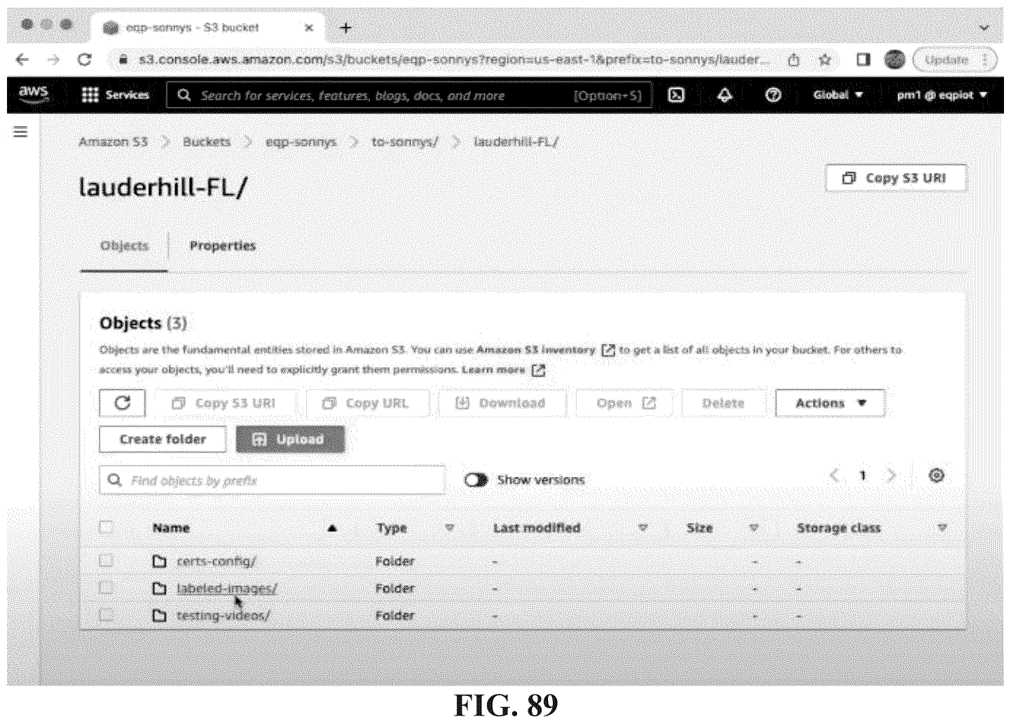

FIG. 89 exhibits step 3 of uploading a labelled photo according to some embodiments. In some embodiments, step 3 includes to click label-images/.

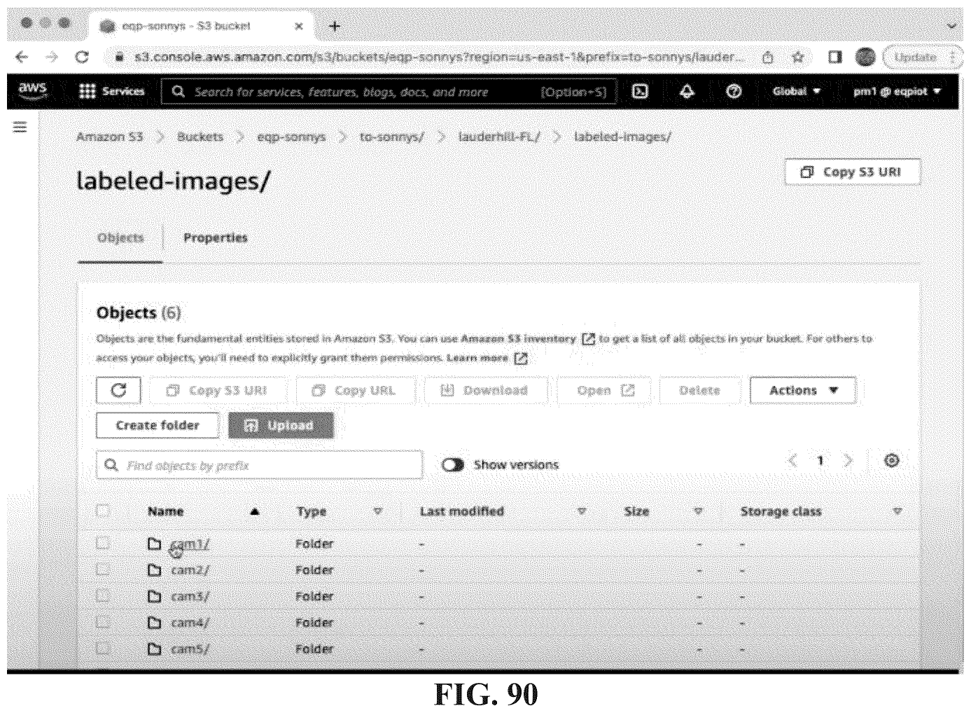

FIG. 90 displays step 4 of uploading a labelled photo according to some embodiments. In some embodiments, step 4 includes to select the camera from which the labelled photos came from. In some embodiments there are annot#/ folders to track the uploaders.

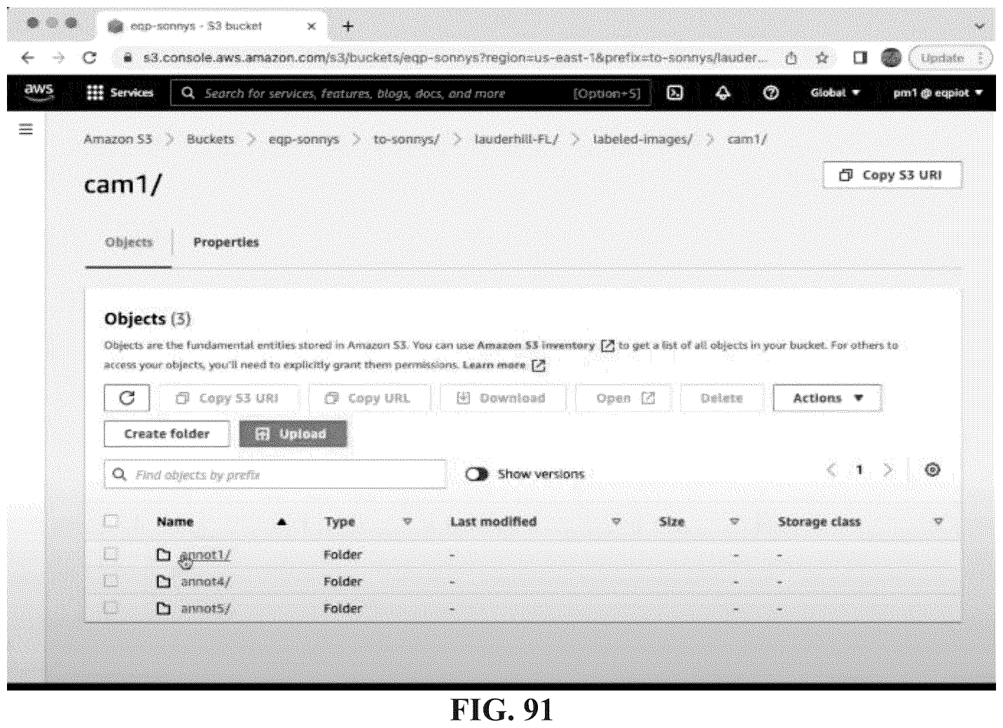

FIG. 91 illustrates step 5 of uploading a labelled photo according to some embodiments. In some embodiments step 5 includes to select an annot#/ folder.

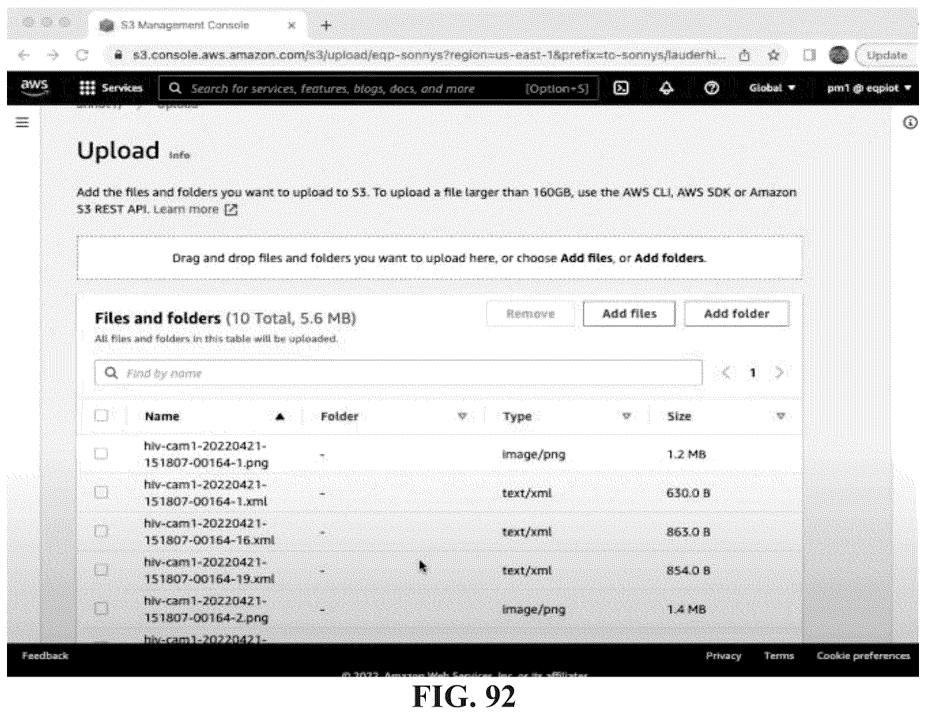

FIG. 92 shows step 6 of uploading a labelled photo according to some embodiments. In some embodiments, step 6 includes to select upload and add the files.

In some embodiments, to train a model using one or more uploaded images, a series of steps is implemented. In some embodiments, step 1 includes to select a to-sonnys/folder within S3. In some embodiments, step 2 includes to navigate through by selecting vehicle-wash-training/, then pytorch-training/, and then dataset/. In some embodiments, step 3 includes to create a new folder and name it. In some embodiments, step 4 includes to create a new folder within the folder created in step 3 and name it “labels”. In some embodiments, step 5 includes to copy one or more of the uploaded image to the folder created in step 4. In some embodiments, step 6 includes to enter data-training-processing.ipynb in SageMaker and run all the cells.

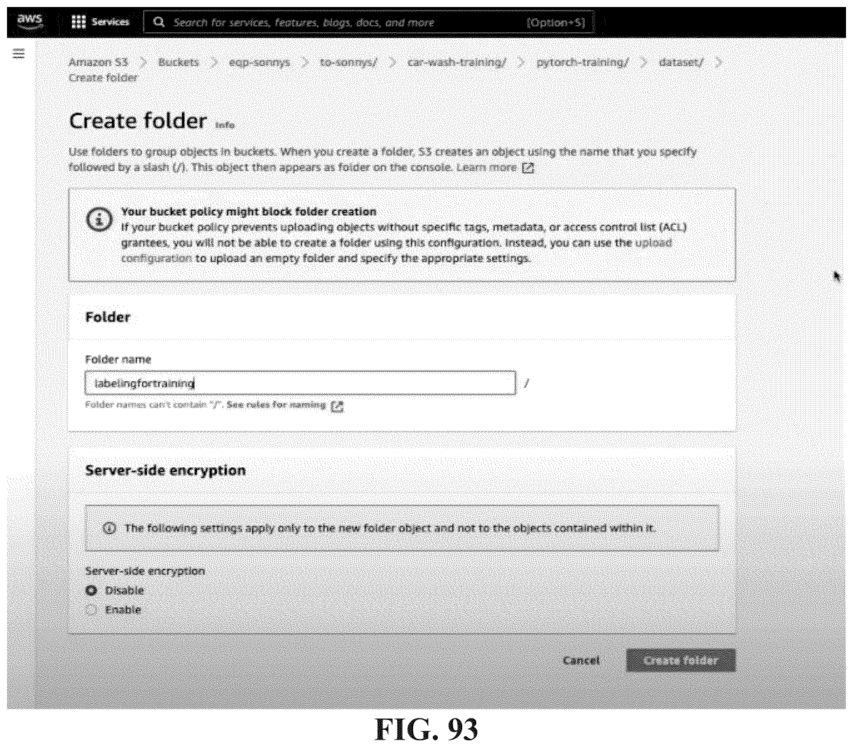

FIG. 93 demonstrates step 3 of training a model using one or more of an uploaded image according to some embodiments.

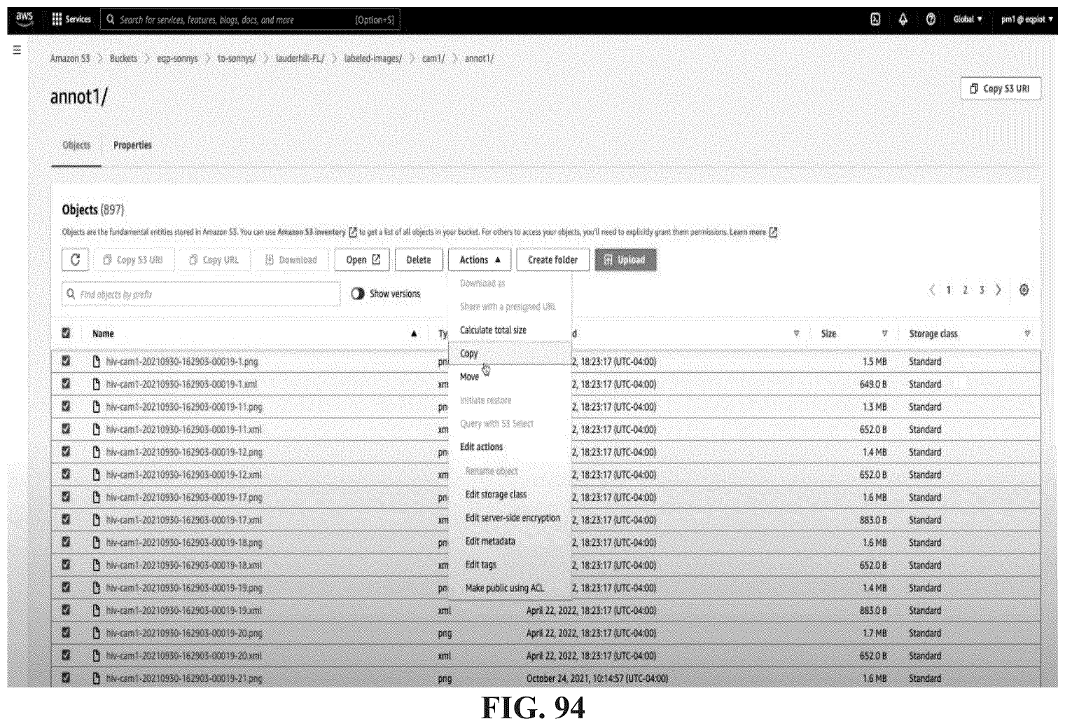

FIG. 94 portrays step 5 of training a model using one or more of an uploaded image according to some embodiments.

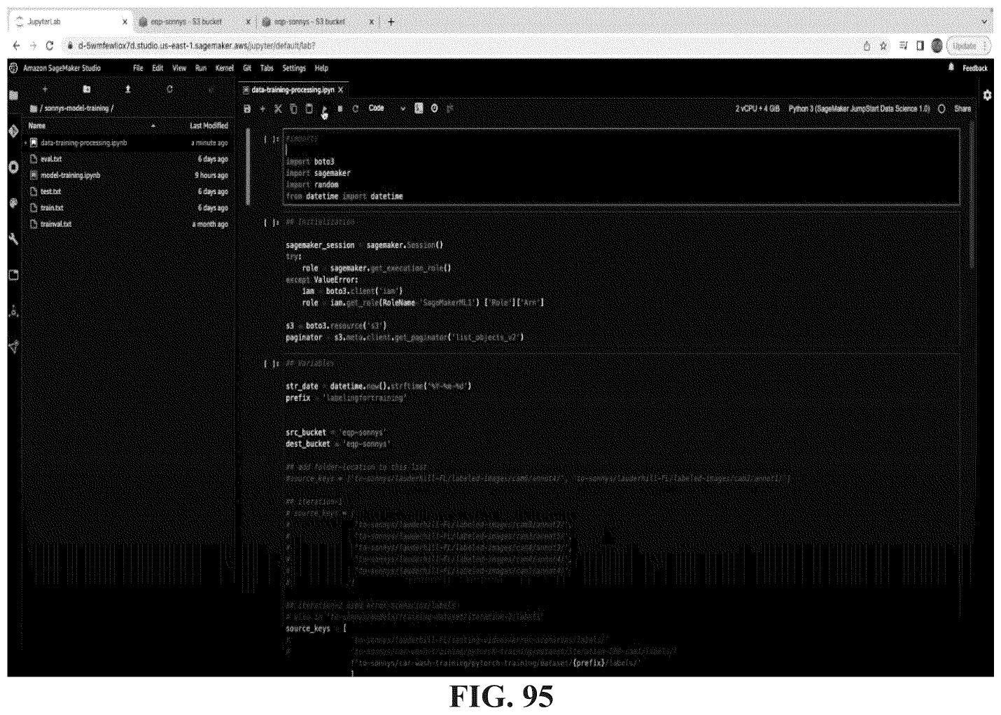

FIG. 95 depicts step 6 of training a model using one or more of an uploaded image according to some embodiments.

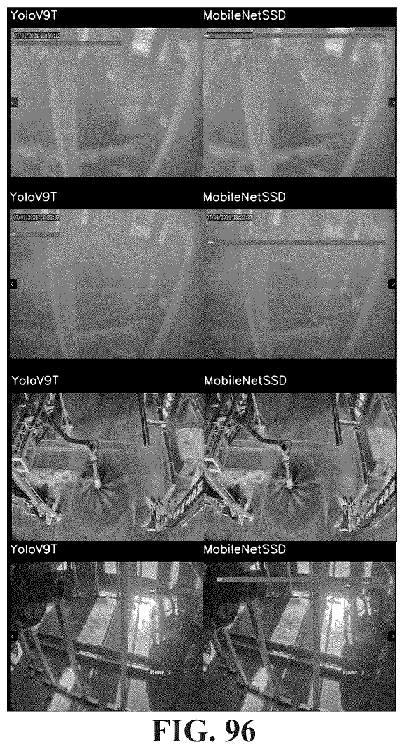

FIG. 96. shows comparison data between YOLOv9t and MobileNetSSD as described above according to some embodiments.

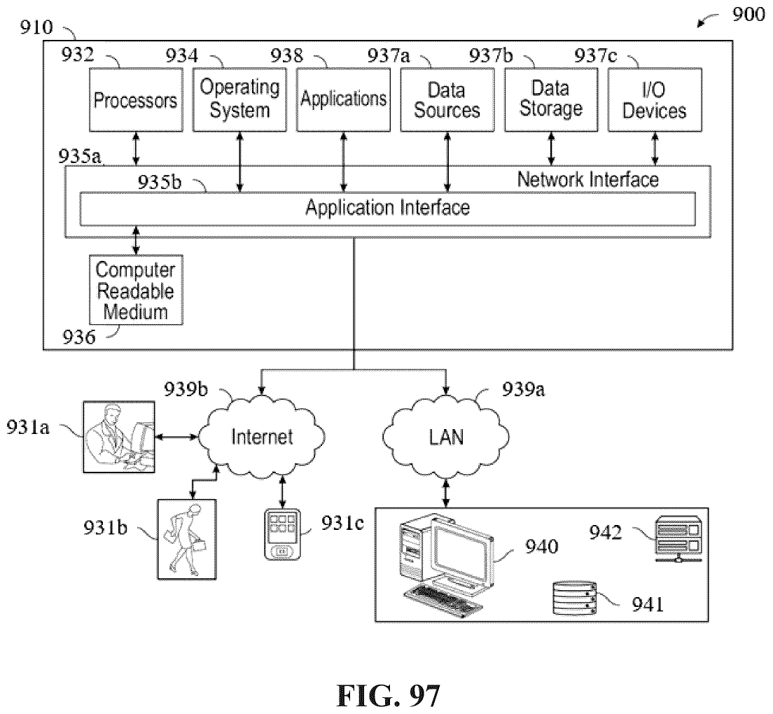

FIG. 97 illustrates a computer system 910 enabling or comprising the systems and methods in accordance with some embodiments of the system. In some embodiments, the computer system 910 can operate and/or process computer-executable code of one or more software modules of the aforementioned system and method. Further, in some embodiments, the computer system 910 can operate and/or display information within one or more graphical user interfaces (e.g., HMIs) integrated with or coupled to the system.

In some embodiments, the computer system 910 can comprise at least one processor 932. In some embodiments, the at least one processor 932 can reside in, or coupled to, one or more conventional server platforms (not shown). In some embodiments, the computer system 910 can include a network interface 935a and an application interface 935b coupled to the least one processor 932 capable of processing at least one operating system 934. Further, in some embodiments, the interfaces 935a, 935b coupled to at least one processor 932 can be configured to process one or more of the software modules (e.g., such as enterprise applications 938). In some embodiments, the software application modules 938 can include server-based software and can operate to host at least one user account and/or at least one client account and operate to transfer data between one or more of these accounts using the at least one processor 932.

With the above embodiments in mind, it is understood that the system can employ various computer-implemented operations involving data stored in computer systems. Moreover, the above-described databases and models described throughout this disclosure can store analytical models and other data on computer-readable storage media within the computer system 910 and on computer-readable storage media coupled to the computer system 910 according to various embodiments. In addition, in some embodiments, the above-described applications of the system can be stored on computer-readable storage media within the computer system 910 and on computer-readable storage media coupled to the computer system 910. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 910 can comprise at least one computer readable medium 936 coupled to at least one of at least one data source 937a, at least one data storage 937b, and/or at least one input/output 937c. In some embodiments, the computer system 910 can be embodied as computer readable code on a computer readable medium 936. In some embodiments, the computer readable medium 936 can be any data storage that can store data, which can thereafter be read by a computer (such as computer 940). In some embodiments, the computer readable medium 936 can be any physical or material medium that can be used to tangibly store the desired information or data or instructions and which can be accessed by a computer 940 or processor 932. In some embodiments, the computer readable medium 936 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 936 can transmit or vehicular instructions to a remote computer 940 and/or at least one user 931, including a router, private or public network, or other transmission or channel, both wired and wireless. In some embodiments, the software application modules 938 can be configured to send and receive data from a database (e.g., from a computer readable medium 936 including data sources 937a and data storage 937b that can comprise a database), and data can be received by the software application modules 938 from at least one other source. In some embodiments, at least one of the software application modules 938 can be configured within the computer system 910 to output data to at least one user 931 via at least one graphical user interface rendered on at least one digital display.

In some embodiments, the computer readable medium 936 can be distributed over a conventional computer network via the network interface 935a where the system embodied by the computer readable code can be stored and executed in a distributed fashion. For example, in some embodiments, one or more components of the computer system 910 can be coupled to send and/or receive data through a local area network (“LAN”) 939a and/or an internet coupled network 939b (e.g., such as a wireless internet). In some embodiments, the networks 939a, 939b can include wide area networks (“WAN”), direct connections (e.g., through a universal serial bus port), or other forms of computer-readable media 936, or any combination thereof.

In some embodiments, components of the networks 939a, 939b can include any number of personal computers 940 which include for example desktop computers, and/or laptop computers, or any fixed, generally non-mobile internet appliances coupled through the LAN 939a. For example, some embodiments include one or more of personal computers 940, databases 941, and/or servers 942 coupled through the LAN 939a that can be configured for any type of user including an administrator. Some embodiments can include one or more personal computers 940 coupled through network 939b. In some embodiments, one or more components of the computer system 910 can be coupled to send or receive data through an internet network (e.g., such as network 939b). For example, some embodiments include at least one user 931a, 931b, is coupled wirelessly and accessing one or more software modules of the system including at least one enterprise application 938 via an input and output (“I/O”) 937c. In some embodiments, the computer system 910 can enable at least one user 931a, 931b, to be coupled to access enterprise applications 938 via an I/O 937c through LAN 939a. In some embodiments, the user 931 can comprise a user 931a coupled to the computer system 910 using a desktop computer, and/or laptop computers, or any fixed, generally non-mobile internet appliances coupled through the internet 939b. In some embodiments, the user can comprise a mobile user 931b coupled to the computer system 910. In some embodiments, the user 931b can connect using any mobile computing 931c to wireless coupled to the computer system 910, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of anti-collision by incorporating artificial intelligence into novel monitoring systems. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system. Any reference to machine learning (ML) is also a broader reference to artificial intelligence (AI) to which ML is a subset, and ML can be replaced with a recitation of AI when defining the metes and bounds of the system, where AI includes various subsets as understood by those of ordinary skill.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, which can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system comprising:
one or more computers and one or more non-transitory computer readable media, the one or more non-transitory computer readable media including program instructions stored thereon that when executed cause the one or more computers to:
receive, by one or more processors, one or more images from one or more cameras within a vehicle wash location;
execute, by the one or more processors, an anomaly detection platform that includes one or more artificial intelligence (AI) models;
detect, by the anomaly detection platform, if one or more anomalies exist within the one or more images using the one or more AI models; and
execute, by the one or more processors, a control command configured to control one or more equipment components and/or one or more vehicles within the vehicle wash location based on the one or more anomalies detected within the one or more images by the one or more AI models.

2. The system of claim 1,
the one or more non-transitory computer readable media include program instructions stored thereon that when executed cause the anomaly detection platform to:
detect, by the anomaly detection platform, a first vehicle and a second vehicle within a conveying area of the vehicle wash location;
determine, by the anomaly detection platform, a first vehicle position within the conveying area;
determine, by the anomaly detection platform, a second vehicle position within the conveying area;
compare, by the anomaly detection platform, the first vehicle position and the second vehicle position; and
execute, by the one or more processors, the control command if the first vehicle position is within a predetermined distance of the second vehicle position.

3. The system of claim 2,
wherein the control command includes stopping one of the first vehicle and the second vehicle.

4. The system of claim 2,
wherein the control command includes changing a speed of the first vehicle and/or the second vehicle.

5. The system of claim 2,
wherein the control command includes controlling functions of one or more wash equipment.

6. The system of claim 1,
the one or more non-transitory computer readable media include program instructions stored thereon that when executed cause the anomaly detection platform to:
receive, by the one or more processors, a vehicle wash diagram of a vehicle wash location; and
generate, by the one or more processors, a vehicle wash model based on the vehicle wash diagram;
wherein the system is configured to enable the vehicle wash diagram to enable a user to enter approximate wash equipment location and/or wash equipment name for wash equipment within a conveying path of the vehicle wash location.

7. The system of claim 6,
wherein the wash equipment includes one or more of windows, entrances, exits, and/or cameras along a length of the conveying path.

8. The system of claim 6,
wherein the vehicle wash diagram is configured enable the user to input conveying path measurements.

9. The system of claim 8,
wherein the conveying path measurements include one or more of a length measurement, a width measurement, a height measurement, a side walls to conveyor measurement, a floor to windows measurement, and/or an obstacle distance measurement.

10. The system of claim 6,
wherein the one or more non-transitory computer readable media include program instructions stored thereon that when executed cause the anomaly detection platform to:
output, by the one or more processors, a camera map based on the vehicle wash diagram;
wherein the camera map is configured to identify a camera location and/or a camera angle for a user to set up cameras based on wash equipment location and/or the conveying path.

11. The system of claim 1,
wherein the anomaly detection platform is configured to determine a first position of a first vehicle at least partially by identifying a first vehicle headlight and/or a first vehicle taillight.

12. The system of claim 11,
wherein the anomaly detection platform is configured to determine the first position of the first vehicle at least partially by identifying the first vehicle headlight; and
wherein the anomaly detection platform is configured to determine a second position of a second vehicle at least partially by identifying a second vehicle taillight.

13. The system of claim 12,
wherein the anomaly detection platform is configured to control one or more wash equipment and/or conveying of the first vehicle and/or the second vehicle based on a relative location between the first vehicle headlight and the second vehicle taillight in the one or more images.

14. The system of claim 1,
further including the one or more cameras;
wherein the one or more cameras are not positioned directly above a conveying path.

15. The system of claim 1,
further including the vehicle wash location;
wherein the one or more cameras capturing the one or more images for analysis by the one or more AI models are each configured to capture at least a portion of a side of a vehicle traveling along a conveying path.
